(19) United States
(12) Patent Application Publication
(10) Pub. No.: US 2008/0069785 A1
(43) Pub. Date: Mar. 20, 2008

(54) PEST-CONTROL COMPOSITIONS, AND METHODS AND PRODUCTS UTILIZING SAME

(76) Inventor: Allen L. Jones, Clayton, NC (US)

Correspondence Address: INTELLECTUAL PROPERTY / TECHNOLOGY LAW, PO BOX 14329, RESEARCH TRIANGLE PARK, NC, 27709, US

(21) Appl. No.: 11/855,880

(22) Filed: Sep. 14, 2007

Related U.S. Application Data
(63) Continuation-in-part of application No. 11/722,880.
(60) Provisional application No. 60/635,840, filed on Dec. 14, 2004.

(51) Int. Cl. A01N 53/10; A01P 17/00; A61Q 17/04

(52) U.S. Cl. 424/59; 514/552

(57) ABSTRACT

Pest-combating compositions containing pest-control actives are formulated for sustained pest-combating efficacy, utilizing actives fatty acids, undecanone, and/or soy methyl ester in varying combinations. Pest-combating includes both repellency and killing of pests. In specific formulations, the pest-combating composition includes any one, two or three of the active agents soy methyl ester, fatty acid and undecanone. Fatty acids may be unmodified or may be modified by transesterification or methanolysis of the oleochemical or conversion of the fatty acids to alkyl esters. The composition may be constituted as a spray composition, lotion, paste, or other compositional form. Pests that may be usefully combated with such composition include aphids, ants, bed bugs, bees, beetles, centipedes, caterpillars, chiggers, cockroaches, crickets, cutworms, earwigs, fleas, flies, fire ants, gnats, grasshoppers, hookworms, japanese beetles, june bugs, lice, locust, maggots, mealworms, mealybugs, millipedes, mites, mosquitoes, moths, pillbugs, scorpions, silverfish, spiders, stinkbugs, termites, thrips, ticks, wasps, and white flies.

### CROSS-REFERENCE TO RELATED APPLICATIONS

This application is a continuation in part application of U.S. patent application Ser. No. 11/722,880, filed Jun. 26, 2007 under the provisions of 35 U.S.C. §371, which claims the benefit of priority of International Patent Application No. PCT/US05/045214, filed Dec. 14, 2005, which in turn claims the benefit of priority of U.S. Provisional Patent Application No. 60/635,840, filed Dec. 14, 2004, and the priority of U.S. patent application Ser. No. 11/117,271, filed Apr. 28, 2005. The disclosures of all said applications are hereby incorporated herein by reference in their respective entireties, for all purposes.

### FIELD OF THE INVENTION

The present invention relates to compositions having utility for controlling pests, and to methods and products for making and utilizing such compositions. In specific embodiments, the compositions of the invention include pest repellants, pesticides and pest attractant compositions, for control of pests, including, without limitation, mosquitoes, ticks, other arthropods, acari, and insect species, as well as rodents and lizards. The invention also contemplates volatility modification of active ingredients for use in pest control formulations.

### DESCRIPTION OF THE RELATED ART

In the field of pest control, much effort has been given to the development of compositions that are “environmentally friendly.” Accordingly, there has been a great interest in compositions that are readily biodegradable or otherwise compatible with human and animal use as formulations having little or no toxicity, as insecticides and pesticides, insect and pest repellants, and attractant compositions used for pest control.

Pest species include arthropod pests, agricultural, horticulture, and garden pests, rodent pests and reptile and amphibian pests. Arthropod pests include aphids, ants, bed bugs, bees (e.g. carpenter bees), beetles, centipedes, caterpillars, chiggers, cockroaches, crickets, cutworms, earwigs, fleas, flies (e.g., house flies, black flies, white flies, deer flies, fruit flies, horse flies, horn flies, midges, stable flies, etc.), fire ants, gnats, grasshoppers, hookworms, japanese beetles, june bugs, lice, locust, mealworms, mealybugs, millipedes, mites, mosquitoes, moths, pillbugs, scorpions, silverfish, spiders, stinkbugs, termites, thrips, ticks, and wasps. Agriculture, horticulture and garden pests include aphids, beetles, caterpillars, cutworms, maggots, mealybugs, mites (e.g. spider mites), moths, stinkbugs, thrips, and white flies. Rodent pests include chipmunks, mice, rats, squirrels and voles. Reptile and amphibian pests include lizards, snakes, and frogs. Of these pest species, mosquitoes, ticks and cockroaches are of primary interest as disease carriers, along with other arthropod species that are vectors of human disease-causing agents. Mosquitoes and ticks, for example, carry Lyme disease, encephalitis, and other diseases. Mosquitoes and ticks transmit the widest variety of pathogens out of all blood-sucking arthropods. As a result, there has been great interest in developing an insect repellant that is efficacious for control of mosquitoes and ticks, and which is more effective than repellants based on N,N-diethyl-m-toluamide (DEET). Such a composition that is alternatively, or in addition, an insecticidal or pesticidal agent would be of particular interest.

Similarly desired are compositions that are repellants and cidal agents for rodents, reptiles, and compositions for application to livestock as insect repellant and/or insecticide.

Although there has been increasing use of various natural ingredients in pest-combating compositions, such natural ingredients typically are utilized in the form of isolates or purified species, rather than being chemically processed to other ingredient forms. This self-imposed limitation on the formulation of so-called “green” products has in many cases limited the chemical efficacy of the compositions for their intended pest-combating usage.

It has been known that insect repellant active ingredients (“actives”) may be found in the form of fatty acids commonly found in vegetable, animal and petroleum oils (such as soy, coconut, castor, rapeseed, canola, paraffin), specifically within the form of the oleochemicals family (i.e., fatty acid, fatty alcohol, and fatty acid methyl esters). These actives may be either naturally or synthetically derived. However, the effectiveness of such actives is commonly a function of their volatility.

U.S. Pat. No. 5,589,181 (Bencsits) describes an insect repellent including: 1) a fatty acid alkyl ester, 2) a fatty alcohol as an active substance, and 3) at least one fatty oil as a carrier. The '181 patent does not provide for compositions without a fatty alcohol active substance. The '181 patent also does not address cidal activity against insects or other pests.

U.S. Pat. No. 5,594,029 (Bencsits) describes use of “first runnings” of coconut fatty acid as an insect repellent, in combination with another fatty oil as an active substance. The '029 patent does not describe what “first runnings” of coconut fatty acid are or how to obtain such. The '029 patent also does not address cidal activity against insects or other pests.

U.S. Pat. Nos. 6,306,415, 6,444,216, and 6,953,814 (Reifenrath) propose a natural insect and arthropod repellant made from fatty acids and a carrier. In one aspect, the carrier is described as silicone. Though these patents acknowledge the use of “first runnings” of coconut fatty acids and combination of those first runnings with other oils (“‘ . . . another active substance, an oil or fat, selected for the group consisting of rape-seed oil, sunflower oil, peanut oil/butter, . . . ’ etc.”) in U.S. Pat. No. 5,594,029, Reifenrath characterizes those descriptions as unclear. Furthermore, Reifenrath describes Bencsits as teaching away from the utility of volatile compounds. Reifenrath provides a composition including a carrier, described as providing further water repellency, preventing skin irritation, and/or soothing or conditioning skin. One such suggested carrier is silicone. However, testing by the present inventor found this combination to be ineffective as a mosquito repellent and irritating to the skin. The Reifenrath patents also do not address cidal activity against insects or other pests.

In consequence, the art continues to seek improvements in natural product formulations for combating insects and other pests. In one aspect it would be desirable to provide a composition with repellency and or cidal activities for combating insects and other pests.

### SUMMARY OF THE INVENTION

The invention provides pest-combating compositions for insect or other pest repellency and/or cidal activity against insects or other pests.

In one aspect, the invention provides a pest-combating composition including at least one transesterified or methanolyzed oleochemical having pest control character.

In another aspect the invention provides a method of combating pests, at a locus containing or susceptible to the presence of pests, where a pest combating composition including soy methyl ester and undecanone is applied to at least a portion of the locus.

In a further aspect the invention provides a pest-repellant composition consisting essentially of any one or more of the following pest control active agents: soy methyl ester, modified fatty acids, coconut oil, rue oil, soybean oil, and vegetable oil.

In still another aspect the invention provides a pest-repellant composition comprising two or more pest control active agents, wherein at least one pest control active agent is selected from the group consisting of a) modified or unmodified fatty acids, coconut oil, soy methyl ester, soybean oil, and vegetable oil, and at least one pest control active agent is selected from the group consisting of b) undecanone and rue oil.

In yet another aspect, the invention provides a pesticidal composition comprising any of the following pest control active agents: modified or unmodified fatty acids, coconut oil, soy methyl ester, soybean oil, vegetable oil, and rue oil, and wherein the composition has pest control character.

Other aspects, features and embodiments of the invention will be more fully apparent from the ensuing disclosure and appended claims.

### BRIEF DESCRIPTION OF THE DRAWINGS

FIG. 1 is an elevation view, in partial section, of a building equipped with a misting system adapted to mist the exterior environment in proximity to the building with a pest control composition of the invention.

FIG. 2 is an aerosol package for spraying or fogging a pest control composition of the invention.

FIG. 3 is a schematic perspective view of a portable fogger suitable for use in dispensing pest control compositions of the present invention.

FIGS. 4 (untreated control) and 5 (Composition D in the form of a 20 μL spray) show the results of a two-choice test on human skin, conducted with deer ticks. (Test date: Oct. 12, 2005; 9:18 AM).

FIGS. 6 (untreated control) and 7 (Composition D in the form of a 20 μL spray) show the results of a two-choice test on human skin, conducted with deer ticks (Test date: Oct. 13, 2005; 8:49 AM).

FIGS. 8 (untreated control) and 9 (Composition D in the form of a 20 μL spray) show the results of a two-choice test on human skin, conducted with deer ticks (Test date: Oct. 13, 2005; 2:25 PM).

FIG. 10 shows the results of a two-choice test on human skin, conducted with American dog ticks to assess the repellency of Composition E in the form of a 20 μL spray (Test date: May 2, 2005).

FIG. 11 shows the results of Example 19, the percent repellency of 2-Undecanone (the active ingredient of BioUD™ 4) against thirty day old cockroach nymphs after 2 hours.

FIG. 12 shows the percent repellency of Soy Methyl Ester (SME) against 10, 20, and 30 days old cockroach nymphs (Blattella germanica), as performed in Example 19.

FIG. 13 shows the percent survival of the cockroaches in Example 19 at the differing formulations and the increasing concentrations at the zero to one day mark.

FIG. 14 shows the percent survival of the cockroaches in Example 19 at the differing formulations and the increasing concentrations at the three to four day mark.

FIG. 15 shows the percent survival of the cockroaches in Example 19 at the differing formulations and the increasing concentrations at the six to seven day mark.

FIG. 16 shows the mean and standard deviation for time to kill in four insecticidal treatments on German cockroaches, as set forth in Example 19.

FIG. 17 shows the average time to death in seconds of the termites in Example 20 following application of the various formulations and also displays the standard deviation of that time period.

FIG. 18 shows the mortality of the spider mites in Example 21 over the six hour period from the first dip of the slide into the various formulations of the pesticide including the controls.

FIG. 19 shows the percentage mortality of the adult tobacco aphid in Example 22 exposed to different 2-undecanone concentrations using BioUD™ 4% with silicone.

FIGS. 20A and B show the percentage mortality of the adult tobacco aphid in Example 22 after exposure to BioUD™ 4% , BioUD™ 8% and BioUD™ 30% using silicone (FIG. 20A) and non-silicone formulations (FIG. 20B).

FIG. 21 shows the phototoxicity of the BioUD™ 4% over the course of the two weeks of measurements as set forth below in Example 24.

FIG. 22 Fresh weight (g) of two-week old bean plants treated with BioUD 4% (2-undecanone).

FIG. 23 One week growth (cm) of bean plants treated with BioUD 4% (2-undecanone).

FIG. 24 provides a graph illustrating the results of the arm in cage studies of Example 25.

### DETAILED DESCRIPTION OF THE INVENTION, AND PREFERRED EMBODIMENTS THEREOF

The disclosures of U.S. Provisional Patent Application No. 60/635,840 filed Dec. 14, 2004 in the name of Allen L. Jones, Jr. for “Increasing the Effectiveness of Insect Repellant and Pest Control Actives by Volatility Modification,” U.S. patent application Ser. No. 11/117,271 filed Apr. 28, 2005 in the name of Allen L. Jones, Jr. for “Pest-Combating Compositions Comprising Soy Methyl Ester,” U.S. Pat. No. 11/722,880 filed Jun. 26, 2007 in the name of Allen L. Jones, Jr. for “Pest-Control Compositions and Methods and Products Utilizing Same,” are hereby incorporated herein by reference, in their entireties.

“Pest control” as used herein refers to the repulsion, attraction, killing or other control of pests, such as mosquitoes, ticks, flies, thrips, aphids, mites, cockroaches, termites, bedbugs, wasps, ants, fire ants, fleas, ticks, beetles, gnats, chiggers, rodents and reptiles.

A “pest control active agent,” also referred to herein as a “pest combating active,” an “insect control active agent,” an “insect control active ingredient,” an “active agent” or simply an “active,” are active ingredients of a composition of the invention with pest control activity, such as described above.

“Cidal” as used herein refers to killing activity. Cidal agents and cidal compositions referred to herein are formulations designed to kill target pests, including insects. As such, a cidal agent or composition of the invention is alternately referred to as a pesticidal or insecticidal.

In one embodiment, the present invention relates to the use of fatty acids and esters of fatty acids in cidal compositions as insecticidal or pesticidal agents, and the enhancement of the efficacy of insecticidal or pesticidal agents by using fatty acids and esters of fatty acids.

The present invention in one embodiment contemplates that fatty acid compounds are suitable as active insecticidal or pesticidal agents and/or may be combined with additional active(s) as a synergist or adjuvant for modification of the performance characteristics of a pest control composition.

In another embodiment, fatty acid compounds suitable for pest control actives, such as insect repellant actives, are modified by transesterification or methanolysis of the oleochemical or conversion of the fatty acids to alkyl esters. Such modified fatty acids can be used as pest control actives, e.g., insect repellant actives, pest repellant actives, insecticidal actives, pesticidal actives, and/or be combined with additional active(s) as a synergist or adjuvant for modification of the performance characteristics of the pest control composition.

The process of transesterification or methanolysis is outlined in a paper entitled “Transesterification of Vegetable Oils: a Review,” J. Braz. Chem. Soc., Vol. 9, No. 1, 199-210, 1998. In addition, this process is being used within the so-called “biodiesel” industry (see world wide web address biodiesel.org/pdf_files/fuelfactsheets/Production.PDF), the disclosure of which hereby is incorporated herein by reference). Processing of a vegetable oil by transesterification is described in “Transesterification Process to Manufacture Ethyl Ester of Rape Oil,” Roger A. Korus, Dwight S. Hoffman, Narendra Bam, Charles L. Peterson, and David C. Drown, Department of Chemical Engineering, University of Idaho, Moscow, Id. 83843. Methanolysis of diethyl acetal is described in Appendix 4 of U.S. Provisional Patent Application No. 60/635,840 filed Dec. 14, 2004 in the name of Allen L. Jones, Jr. for “Increasing the Effectiveness of Insect Repellant and Pest Control Actives by Volatility Modification,” the disclosure of which hereby is incorporated herein by reference. Also noted in this respect are U.S. Pat. Nos. 5,525,126; 5,578,090; 5,713,965; 6,174,501; 6,398,707; 6,399,800; 5,389,113; 5,424,467; 6,015,440; 6,203,585; and 6,235,104, the disclosures of which are incorporated herein by reference. None of the aforementioned patents or documents suggest using such processes on insect repellant or insecticidal actives and/or formulating an insect repellant, insecticidal or other pest control composition using actives modified by the described process(es), and it is a discovery of the present inventor that such processes can be usefully employed to achieve superior test control compositions.

In one embodiment, modification of the fatty acid will enhance the volatile nature of actives. By this enhancement, the pest control character, e.g., insect repellency, cidal character, attractive character, or other property, of the actives can be controlled to achieve an optimized result.

As an optional use, the volatility of other types of insect repellant, insecticide, and pest control actives (such as those based on acetals, ketones, fatty acids, or derived from soybean, rapeseed, coconut, citronella, rue, eucalyptus, pyrethrum and chrysanthemum) can be further enhanced or controlled by administering with a fatty acid or modified fatty acid.

Further, adding a short to medium chain fatty oil, such as coconut, can stabilize the composition so that the volatility is controlled over time, resulting in an increased and optimized duration of the evaporation of the active.

In one embodiment, the effectiveness of a fatty acid active is increased by directly processing the active according to the methods discussed above or by adding an amount of the modified fatty acid to other insect repellant actives. In another embodiment, unmodified fatty acid actives are utilized as cidal actives, alone or in combination with other pest repellant or pesticidal actives, where the combination of actives has increased effectiveness, as compared to each of the actives administered alone. The resulting materials and/or compounds are then formulated into a pest control composition, e.g., an insect/pest repellant, insecticide, pesticide, insect/pest attractant, etc., in a conventional fashion.

The invention therefore contemplates in one embodiment an active agent for effective pest control, comprising an unmodified fatty acid as a cidal agent. In another embodiment the invention provides an active agent for effective pest control comprising a modified fatty acid as an insect/pest repellant and/or cidal agent. Additionally, the invention provides a composition for effective pest control comprising unmodified or modified fatty acid agents in combination with other actives, where the combination provides increased effectiveness. When the composition contains an unmodified fatty acid agent alone as the pest control agent, the composition is not used for insect repellency.

In another embodiment, the invention contemplates a method of increasing effectiveness of a pest control active by volatility modification, in which a fatty acid is supplied and subjected to transesterification or methanolysis of the oleochemical or conversion of the fatty acid to an alkyl ester to form an active with modified volatility, and the resulting active is used to form a pest control composition with modified volatility. Where such a composition is used for insect repellency, the composition does not comprise an unmodified fatty acid derived alcohol.

Pest control compositions of the invention can variously include pest repellants, pesticides, pest attractants, etc., as may be useful for pest control in a given application. Such applications may include, but are not limited to, residential, industrial, animals and livestock, agriculture, horticulture, and gardening applications. For example, the pest control composition can be employed to control pests such as arthropod pests, agricultural, horticulture, and garden pests, rodent pests and reptile and amphibian pests. Arthropod pests include, but are not limited to, aphids, ants, bed bugs, bees (e.g. carpenter bees), beetles, centipedes, caterpillars, chiggers, cockroaches, crickets, cutworms, earwigs, fleas, flies (e.g., house flies, black flies, white flies, deer flies, fruit flies, horse flies, horn flies, midges, stable flies, etc.), fire ants, gnats, grasshoppers, hookworms, japanese beetles, june bugs, lice, locust, mealworms, mealybugs, millipedes, mites, mosquitoes, moths, pillbugs, scorpions, silverfish, spiders, stinkbugs, termites, thrips, ticks, and wasps. Agriculture, horticulture and garden pests include, but are not limited to, aphids, beetles, caterpillars, cutworms, maggots, mealybugs, mites (e.g. spider mites), moths, stinkbugs, thrips, and white flies. Rodent pests include, but are not limited to, chipmunks, mice, rats, squirrels and voles. Reptile and amphibian pests include, but are not limited to, lizards, snakes, and frogs. In one preferred embodiment of the invention, the pest control composition is formulated and utilized to control insect pests.

The formulation of the pest control composition can include combining the active produced in accordance with the invention with a suitable carrier or vehicular formulation appropriate to the end-use administration of the pest control composition. For example, the pest control composition may be formulated with appropriate ingredients to provide a desired form of the composition, including, without limitation, lotions, oils, creams, gels, spray formulations, etc.

Fatty acids that can be utilized for pest control compositions of the invention include fatty acids such as those derived from vegetable, animal and petroleum oils.

As used herein, the term “fatty acids” refers to alkyl chains having a carboxylic acid substituent at one end of the alkyl chain and a methyl (CH₃) substituent at the other end of the alkyl chain. Such fatty acids may be saturated or unsaturated. The term “long chain fatty acids” as used herein refers to alkyl chains having 14 to 24 carbon atoms. Fatty acids of fewer than fourteen carbon atoms are referred to herein by their carboxylic acid name, such as hexanoic acid, heptanoic acid, octanoic acid, nonanoic acid, decanoic acid, undecanoic acid, dodecanoic acid, etc.

In one embodiment, the fatty acid includes a fatty acid selected from among soy, soybean, coconut, castor, rapeseed, canola, silicone, and paraffin fatty acids. The cidal agent used in compositions of the present invention can be of any suitable type and may, for example, include one or more compounds selected from the group consisting of hexanoic acid, heptanoic acid, octanoic acid, nonanoic acid, decanoic acid, undecanoic acid, dodecanoic acid, methyl hexanoate, methyl heptanoate, methyl octanoate, methyl nonanoate, methyl decanoate, methyl undecanoate, and methyl dodecanoate, ethyl hexanoate, ethyl heptanoate, ethyl octanoate, ethyl nonanoate, ethyl decanoate, ethyl undecanoate, and ethyl dodecanoate, propyl hexanoate, propyl heptanoate, propyl octanoate, propyl nonanoate, propyl decanoate, propyl undecanoate, and propyl dodecanoate. In various preferred embodiments, the cidal agent can be or include hexanoic acid, octanoic acid, decanoic acid, dodecanoic acid, methyl hexanoate, methyl octanoate, methyl decanoate, and/or methyl dodecanoate.

“Coconut oil,” as used herein, refers to all forms of coconut oil, including fractionated coconut oil. Fractionated coconut oil may also be referred to herein as “caprylic/capric triglyceride” or “medium-chain triglyceride (MCT) oil.” Fractionated coconut oil contains only saturated fats and is therefore more heat stable than other forms of coconut oil. Exemplary coconut oil-containing cidal compositions of the invention may include, but are not limited to combinations of fractionated coconut oil with any of: methyl ester oils, silicone oils, or vegetable oils (including, for example, rue oil). Formulations may include compositions containing from about 1000 ppm (approximately 0.0004 percent by weight) fractionated coconut oil to about 100 percent by weight. In one embodiment, coconut oil is utilized as a pest control active agent.

Pest-combating compositions according to the invention can be formulated with fatty acid agents as actives, where the fatty acid may have volatility modified appropriately to provide a desired duration of pest-combating activity, by subjecting a fatty acid to transesterification or alcoholysis (preferably methanolysis), or conversion to a corresponding alkyl ester, to provide a pest-combating active that is of appropriate volatility for the intended application, or which can be blended with active(s) to provide a synergistic effect, and enhanced duration of the pest-combating action, relative to the active(s) alone.

In one embodiment, the pest-combating composition includes an active selected from among transesterified and methanolyzed oleochemicals having pest control character. In another embodiment, the pest-combating composition includes an active selected from the group consisting of fatty acid alkyl esters having pest control character, e.g., fatty acid alkyl esters comprising fatty acid methyl esters.

The pest-control composition in another embodiment includes an active selected from the group consisting of fatty acids, fatty alcohols and fatty acid methyl esters having pest control character, wherein such fatty acids have been optionally subjected to transesterification, methanolysis, and/or conversion to fatty acid methyl esters.

Such modified or unmodified fatty acids may, for example, comprise any of the following: soybean oil, coconut oil, palm oil, cotton seed oil, wheat germ oil, olive oil, corn oil, sunflower oil, safflower oil, rapeseed oil, mustard oil, jatropha, algae, tallow, palmitate, stearate, oleate, linoleate, soybean oil methyl ester, soybean oil ethyl ester, soybean oil propyl ester, coconut oil methyl ester, coconut oil ethyl ester, coconut oil propyl ester, palm oil methyl ester, palm oil ethyl ester, palm oil propyl ester, cotton seed oil methyl ester, cotton seed oil ethyl ester, cotton seed oil propyl ester, wheat germ methyl ester, wheat germ ethyl ester, wheat germ propyl ester, olive oil methyl ester, olive oil ethyl ester, olive oil propyl ester, corn oil methyl ester, corn oil ethyl ester, corn oil propyl ester, sunflower oil methyl ester, sunflower oil ethyl ester, sunflower oil propyl ester, safflower oil methyl ester, safflower oil ethyl ester, safflower oil propyl ester, rapeseed oil methyl ester, rapeseed oil ethyl ester, rapeseed oil propyl ester, mustard oil methyl ester, mustard oil ethyl ester, mustard oil propyl ester, jatropha methyl ester, jatropha ethyl ester, jatropha propyl ester, algae methyl ester, algae ethyl ester, algae propyl ester, tallow methyl ester, tallow ethyl ester, tallow propyl ester, methyl palmitate, ethyl palmitate, propyl palmitate, methyl stearate, ethyl stearate, propyl stearate, methyl oleate, ethyl oleate, propyl oleate, methyl linoleate, ethyl linoleate, and propyl linoleate. In specific compositions, the carrier comprises material identified by Chemical Abstracts Registry Number (CAS#) 67784-80-9 or material identified by Chemical Abstracts Registry Number (CAS#) 6772-38-3.

As used herein, the term “soybean oil esters” is synonymous with the terms: soybean esters, and soy esters, and include soybean oil methyl ester, soybean methyl ester, soy biodiesel, soy methyl ester, and soybean methyl ester.

In a corresponding method for modifying an ingredient for use in a pest control composition, in which the active is selected from the group consisting of fatty acids, fatty alcohols and fatty acid alkyl esters, the method includes subjecting the active to transesterification, methanolysis, or conversion of fatty acids to alkyl esters, sufficient to produce an active of modified volatility in relation to volatility of the active prior to such transesterification, methanolysis or conversion of fatty acids to alkyl esters.

In a further embodiment, the method of modifying volatility is employed to modify the volatility of a pest control composition to produce an increased duration of evaporation of an active of the composition, by adding to the pest control composition a volatility-modifying amount of an additive selected from the group consisting of fatty acids, fatty alcohols and fatty acid methyl esters having pest control character, wherein such fatty acids have been subjected to transesterification, methanolysis, and/or conversion to fatty acid alkyl esters. The additive in such method may for example include a fatty oil such as coconut oil, or other suitable modifying additive, to produce the desired volatility character of the pest control composition.

The pest-control compositions of the invention may be in any suitable form, such as for example oil-in-water emulsions, or other emulsified forms, or in water-based formulations or in silicone or alcohol or other formulations in which the pest-control active is encapsulated in lipid vesicles or other time-release or sustained action forms, or in any other suitable carrier or vehicle formulations appropriate to the end-use of the pest control composition.

The pest-control composition may additionally contain any suitable additional ingredients, including further actives, as well as inert ingredients. For example, the composition may contain one or more additional ingredients such as fillers, dispersants, water, non-aqueous solvent media, surfactants, suspension agents, sticking agents, stabilizers, preservatives, dyes, pigments, masking agents, emollients, excipients, and post-application detection agents.

The pest-control composition may be packaged in any suitable container or source structure affording a desired supply of the composition for its intended purpose. For example, the pest-control composition may be packaged in an aerosol container, as a fogger or spray unit, for fogging, misting or spraying of the pest-control composition to a desired locus of use. The pest-control composition alternatively can be packaged in a container equipped with a hand pump dispenser unit or other applicator, administration or dispensing elements.

Pest-control compositions of the present invention may contain undecanone and/or undecanone-containing compositions as an active ingredient, in combination with other actives. In a specific embodiment the active is rue oil, an undecanone-containing oil, of which 2-undecanone is a major component.

In a specific pest control composition, comprising undecanone, the undecanone is present in a range of from about 0.0004% to 30% by weight, based on the total weight of the composition. More preferably, the undecanone has a composition concentration in a range of from about 8% to 30% by weight, based on the total weight of the composition.

In one embodiment, the pest-control composition contains soy methyl ester and undecanone. In another embodiment, the pest-control composition contains soy methyl ester, undecanone, and or one or more fatty acids. In still another embodiment, the pest-control composition additionally contains silicone oil. In an additional embodiment, the pest-control composition contains undecanone and one or more fatty acids.

In another embodiment, the present invention is based on the discovery that soy methyl esters are unexpectedly and highly effective as pest-combating active ingredients in the pest control formulations. As used herein, the term “soy methyl ester” (also referred to herein as “SME”) refers to methyl ester(s) of fatty acids or oleochemicals of soybean oil, and sometimes is referred to as soybean oil methyl ester or as soybean methyl ester. Soy methyl esters are readily produced by subjecting fatty acids and oleochemicals of soybean oil to transesterification chemical reaction, e.g., a base-catalyzed transesterification of soybean oil. Soy methyl esters of widely varying types are usefully employed in the practice of the invention. One particularly preferred soy methyl ester comprises a mixture of C₁₆-C₁₈ saturated and C₁₈ unsaturated methyl esters, identified by Chemical Abstracts Registry Number (CAS#) 67762-38-3.

Soy methyl esters usefully employed in compositions of the present invention are readily commercially available, e.g., under the brand name “Enviro-Saver” from Columbus Foods Company (Chicago, Ill.), under the brand name “Ecoline Soya Methyl Esters” from Cortec Corporation (St. Paul, Minn.), and otherwise as fatty acid methyl ester from Cargill Industrial Oils & Lubricants (Minneapolis, Minn.), as methyl soyate from Cognis Corporation (Cincinnati, Ohio), and as soy methyl esters from Vertec BioSolvents, Inc. (Downers Grove, Ill.), Lambent Technologies Corporation (Gurnee, Ill.), soy-based fatty acid esters from Chemol Company, Inc. (Greensboro, N.C.), SoyGold 1000 from Ag Environmental Products (Omaha, Neb.), and Steposol SB-D and Stepasol SB-W soy methyl esters from Stepan Company (Northfield, Ill.).

In formulating the soy methyl ester in useful formulations for combating pests such as mosquitoes and ticks, the soy methyl ester is advantageously formulated as an emulsified base to which are added carrier, adjuvant and other ingredients of the composition. For example, the additional ingredients may include fillers, dispersants, water or other solvent medium or media, surfactants, suspension agents, sticking agents, stabilizers, preservatives, dyes, pigments, masking agents, emollients, excipients, post-application detection agents, and additional active ingredients. Such additional active ingredients may include, for example, additional pest-combating ingredients, such as repellants or cidal agents. By way of example, the soy methyl ester emulsion may be formulated with an insect repellant ingredient such as 2-undecanone. As another example, the soy methyl ester emulsion may be formulated with a sunscreen formulation.

A particularly advantageous composition in accordance with the present invention includes soy methyl ester in combination with 2-undecanone. Such composition has been found to provide superior repellency against mosquitoes and ticks. Due to the volatility of 2-undecanone, it is desirable to formulate the composition containing such ingredient with a sticking agent, so that the 2-undecanone in the composition persists at the point of application, to extend the duration of active repellency of the composition. Compositions containing 2-undecanone, in addition to mosquitoes and ticks, exhibit high repellency and insecticidal effects against other arthropods such as cockroaches, thrips, deer fly, gnats, aphids, and the like.

Compositions in accordance with the present invention may be formulated in any suitable manner appropriate to the ingredients involved. The soy methyl ester preferably is utilized as an emulsified base for the composition.

The soy methyl ester can be used at any suitable concentration in the compositions of the invention. In one embodiment, the soy methyl ester has a concentration in the composition of from about 0.0004% to about 100% by weight, based on the total weight of the composition. Preferably, the soy methyl ester has a composition concentration in a range of from about 2% to about 15% by weight. More preferably, the soy methyl ester has a composition concentration in a range of from about 2.4% to about 12% by weight, based on total weight of the composition. Most preferably, the soy methyl ester has a concentration in the composition in a range of from about 3 to about 10% by weight, based on total weight of the composition. In one embodiment a composition of the invention comprises 100% soy methyl ester. In another preferred formulation, the soy methyl ester has a composition concentration in a range of from about 50% to about 100%.

In various embodiments, the invention provides a composition with pest repellent activity with active agents consisting essentially of any of the following combinations of ingredients: 1) soy methyl ester; 2) modified fatty acid(s); 3) soy methyl ester and modified or unmodified fatty acid(s); 4) soy methyl ester and undecanone; 5) modified or unmodified fatty acid(s) and undecanone; 6) soy methyl ester and modified or unmodified fatty acid(s) and undecanone; 7) Coconut oil; 8) soy methyl ester and coconut oil; 9) Coconut oil and undecanone; 10) soy methyl ester and coconut oil and undecanone; 11) Rue oil; 12) soy methyl ester and rue oil; 13) modified or unmodified fatty acid(s) and rue oil; 14) soy methyl ester and modified or unmodified fatty acid(s) and rue oil; 15) soybean oil; 16) vegetable oil; 17) soybean oil and modified or unmodified fatty acid(s); 18) vegetable oil and fatty acids; 19) soybean oil and undecanone; 20) vegetable oil and undecanone; 21) soybean oil and modified or unmodified fatty acid(s) and undecanone; 22) vegetable oil and modified or unmodified fatty acid(s) and undecanone. In another embodiment the composition includes a modified modified or unmodified fatty acid(s) to enhance the repellency activity of the active(s). In still another embodiment, the composition includes silicone oil to improve activity at high temperatures, as an emulsifier and/or as an emollient. Silicone as an emollient helps produce a less greasy feeling repellent on the skin.

In various embodiments, the invention provides a composition with pesticidal activity with active agents selected from any of the following: soy methyl ester, modified or unmodified fatty acids, coconut oil, rue oil, soybean oil, and vegetable oil. In another embodiment, the composition further comprises undecanone. A cidal composition of the invention may have one, two, three, four, five, six, seven, or more active agents.

The compositions of the invention are preferably free of DEET and pyrethrum as well as pyrethroids generally. However, one or more actives of the present invention may be added to a composition containing DEET and/or pyrethroids as active ingredients, in order to increase pest repellency or cidal activity of the resulting composition, as compared to a composition not containing an active of the present invention.

In one embodiment the invention relates to a composition comprising:

Mix at no heat (phase I):

30% 2-Undecanone (Methyl Nonyl Ketone)

20% Soybean Oil (methyl Ester)

Mix separately under heat (phase II):

6% Coconut Oil Capric/Capryllic Triglyceride

4% Isopropyl Palmitate (IPP) (or glycerin can be substituted)

4% Peg40 Castor Oil

3% Lauric Acid

then mix the following separately with no heat (phase III):

12% Coconut Oil (LC-810) Fatty Acids

3% Citric Acid

0.5% Sodium Bicarbonate

0.2% Benzoic Acid

1% Cedarwood Oil

20% Cyclomethicone (DC 345)

add Phase III to Phase II, then add Phase I after cooling below 90° F.

Percents are by weight. Such composition may be referred to herein as BioUD™ 30 Silicone Anhydrous. This formula is phytotoxic. In one embodiment the composition may be used as an insecticide and/or repellent against arthropod pests, agricultural, horticulture, and garden pests, and may be used as a repellent against rodent pests and reptile and amphibian pests. This pest composition is useful in residential, industrial, animals and livestock, agriculture, horticulture, and gardening applications to control pests.

In another embodiment, the invention relates to a composition comprising:

3% Glycerine or Isopropyl Palmitate

3% Coconut Oil Capric/Capryllic Triglyceride

2% Lauric Acid

3% Cetearyl Alcohol

1% Cetyl Alcohol

3% Castor Oil Peg 40 Hydrog.

1% Lecithin

8% Coconut Oil (LC-810) Fatty Acids

6% Geraniol or Palmarosa Oil

3% Castor Oil Pale Pressed or paraffin oil

0.% Wintergreen Oil (Methyl Salicylate)

1% Citral or Lemon Grass Oil

1% Cedarwood Oil,

0.5% Benzoic Acid

48% Purified Water

1% Sodium Bicarbonate

2% Citric Acid

8% 2-Undecanone (Methyl Nonyl Ketone)

5% Soy Methyl Ester

Percents are by weight. Such composition may be referred to herein as BioUD™8 oil in water. This composition is phytotoxic. This composition may be further diluted with water. In one embodiment the composition may be used as an insecticide and/or repellent against arthropod pests, agricultural, horticulture, and garden pests, and may be used as a repellent against rodent pests and reptile and amphibian pests. This pest composition is useful in residential, industrial, animals and livestock, agriculture, horticulture, and gardening applications to control pests.

In another embodiment, the invention relates to a composition comprising:

oil phase:
4.00% Coconut Oil Capric/Capryllic Triglyceride
2.00% Glycerin
1.00% Peg40 Castor Oil
8.00% Cyclomethicone
0.50% Cetyl Alcohol
4.00% Soybean Oil
0.25% Benzoic Acid
4.00% Undecanone

water phase:
75.00% Water
1.00% sodium bicarbonate
0.25% Citric Acid
   For a total of 100% by weight. Such composition may be referred to herein as BioUD™4 silicone oil in water. This composition is non-phytotoxic. This composition may be further diluted with water. In one embodiment the composition may be used as an insecticide and/or repellent against agricultural, horticulture, and garden pests. This pest composition is useful in agriculture, horticulture, and gardening applications to control pests.

In another embodiment, the invention relates to a composition comprising:

oil phase:
4.00% Coconut Oil Capric/Capryllic Triglyceride
2.00% Glycerin
1.00% Peg40 Castor Oil
8.00% Cyclomethicone or other silicone oil
0.50% Cetyl Alcohol or stearic acid
4.00% Soybean Oil
0.25% Benzoic Acid
0.50% Citral
0.25% Lemongrass Oil
8.00% Undecanone

water phase:
70.00% Water
1.00% sodium bicarbonate
0.50% Citric Acid
   For a total of 100.00% by weight. Such composition may be referred to herein as BioUD™8 silicone oil in water. This composition is non-phytotoxic. This composition may be further diluted with water. In one embodiment the composition may be used as an insecticide and/or repellent against arthropods, agricultural, horticulture, and garden pests. This pest composition is useful in residential, industrial, animals and livestock, agriculture, horticulture, and gardening applications to control pests.

In another embodiment, the invention relates to a composition comprising:

oil phase:
15.00% Coconut Oil Capric/Capryllic Triglyceride
4.00% Glycerin or Isopropyl Palmitate
4.00% Peg40 Castor Oil
5.00% Lecithin (ALC)
6.00% Lauric Acid
20.00% Coconut Oil LC-810 Fatty Acids
0.20% Vanillin
0.50% Wintergreen Oil
0.50% Cedarwood Oil
0.50% LemonGrass Oil
8.00% Geraniol or Palmarosa Oil
7.00% Citral
4.00% Citric Acid
20.00% Soy Methyl Ester
5.00% Undecanone
0.30% Benzoic Acid
   Percents are by weight. Such composition may be referred to herein as BioUD™5 Anhydrous Insecticide Concentrate. This composition is phytotoxic. It is made to be hydrophilic and can be diluted with water or other diluent. It can be made non-phytoxic by water dilution above 1:1000. In one embodiment the composition may be used as an insecticide and/or repellent against arthropod pests, agricultural, horticulture, and garden pests, and may be used as a repellent against rodent pests and reptile and amphibian pests. This pest composition is useful in residential, industrial, animals and livestock, agriculture, horticulture, and gardening applications to control pests.

In yet another embodiment, the invention relates to a composition comprising:

oil phase:
5.00% Coconut Oil Capric/Capryllic Triglyceride
4.00% Cyclomethicone (DC-345) or other silicone oil or paraffin oil
3.00% Peg40 Castor Oil
3.00% Cetearyl Alcohol
0.75% Cetyl Alcohol
4.00% Lecithin
5.00% Lauric Acid
16.00% Coconut Oil LC-810 Fatty Acids
16.00% Soy Methyl Ester
0.75% Cedarwood Oil
6.00% Geraniol or Palmarosa Oil
2.00% citral

water phase:
30.00% Purified Water
3.00% Citric Acid
1.00% Sodium Bicarbonate
0.50% Benzoic Acid
   Percents are by weight. Such composition comprises a combination of soy methyl ester (SME) and fatty acids also known as Bio Block Concentrate. This composition is phytotoxic; however, it can be made non-phytotoxic with water dilutions greater than 1:1000. In one embodiment the composition may be used as an insecticide against arthropod pests, agricultural, horticulture, and garden pests, and may be used as a repellent against rodent pests and reptile and amphibian pests. This pest composition is useful in residential, industrial, animals and livestock, agriculture, horticulture, and gardening applications to control pests.

In yet another embodiment, the invention relates to a composition comprising:

oil phase:
2.00% Glycerin
1.00% Peg40 Castor Oil
3.00% Cyclomethicone or other silicone oil or paraffin oil
5.00% Coconut Oil (Fractionated)
12.00% Soy Methyl Ester (SME) or Soybean Oil
0.50% Wintergreen Oil
0.50% Ascetic Acid
0.50% LemonGrass Oil
0.50% Cedarwood Oil
2.50% Geraniol or Palmarosa Oil
0.50% Benzoic Acid

water phase:
66.00% Water
2.00% Sodium Bicarbonate
4.00% Citric Acid
   Percents are by weight. Such composition comprises a combination of soy (or Soy methyl ester) and fractionated coconut oil and Ascetic Acid (also known as Bio Block™ Pest Control) and can be used as an insecticide. In one embodiment the composition may be used as an insecticide against arthropod pests, agricultural, horticulture, and garden pests, and may be used as a repellent against rodent pests and reptile and amphibian pests. This pest composition is useful in residential, industrial, animals and livestock, agriculture, horticulture, and gardening applications to control pests.

In another embodiment, the invention relates to a composition comprising:

20% Coconut Oil (LC-810) Fatty Acids

20% Soy Methyl Ester

2% Lauric Acid

4% Peg 40 Castor Oil

4% Glycerin or Isopropyl Palmitate

15% Cyclomethicone or other silicone oil or Paraffin Oil

0.5% Cedarwood Oil

4% Citric Acid

30% Water

0.5% Benzoic Acid

Percents are by weight. Such composition comprises a combination of SME and fatty acids and may be referred to herein as a Bio Block™ Wood Pest Treatment Concentrate. The composition may be used as a wood pre or post-treatment insecticide. This formula is phytotoxic. In one embodiment the composition may be used as an insecticide and/or repellent against arthropod pests, agricultural, horticulture, and garden pests, and may be used as a repellent against rodent pests and reptile and amphibian pests. This pest composition is useful in residential, industrial, agriculture, horticulture, and gardening applications to control pests.

In yet another embodiment, the invention relates to a composition comprising one hundred percent soy methyl ester (SME). Such composition can be used as an insecticidal agent for control of the Japanese beetle and the Green June Beetle.

Where coconut oil (LC-810) is used in the above embodiments, it is understood that any of the following may be used in place of, or in addition to, LC-810:

| | | | Fractionated | | | |
|---|---|---|---|---|---|---|
| | LC-810 | LC-810L* | LC-895 | LC-898 | LC-899 | LC-1095 |
| Chemical Properties | | | | | | |
| Saponification Value | 370 Max. | 366 Max. | 395 Max. | 395 Max. | 386-390 | 331 Max. |
| | (365) | | (386) | | | (324) |
| Acid Value | 358-368 | 345-365 | 380-394 | 380-394 | 385-389 | 320-330 |
| | (364) | (357) | (386) | | | (324) |
| Iodine Value | 0.5 Max. | 0.5 Max. | 0.2 Max. | 0.2 Max. | 0.2 Max. | 0.5 Max. |
| | (0.2) | (0.2) | (0.1) | | | (0.3) |
| Moisture (% KF) | 0.2 Max. | 0.2 Max. | 0.2 Max. | 0.2 Max. | 0.2 Max. | 0.2 Max. |
| | (0.04) | (0.06) | (0.03) | | | (0.03) |
| Physical Properties | | | | | | |
| Titer, (C) | (3) | (3) | (14) | | (14) | (30) |
| Ave. Molecular Weight | (154) | (157) | (145) | | (144) | (173) |
| Color, Lovibond Yellow/ | 3/0.8 Max. | 3/1.0 Max | 3/0.8 Max. | 3/0.8 | 10/1 | 3/0.8 |
| Red 5¼″ cell | (1.1/0.1) | (1.0/0.0) | (1.2/0.2) | Max. | Max. | Max. |
| | | | | | | (1.4/0.3) |
| Approximate | | | | | | |
| Composition | | | | | | |
| C6 Caproic | 6 Max. | 0.50 Max. | 2.0 Max. | 1.0 Max. | 0.6 Max. | |
| | (4) | (0.2) | (0.4) | | | |
| C8 Caprylic | 53-60 | 53-63 | 95.0 Min. | 98.0 Min. | 99.0 Min. | (0.9) |
| | (55) | (57) | (97.5) | | | |
| C10 Capric | 34-42 | 37-47 | (1.5) | 1.0 Max. | 0.6 Max. | 95.0 Min. |
| | (39) | (41) | | | | (96.9) |
| C12 Lauric | 2 Max. | 1.5 Max. | 0.5 Max. | | 0.1 Max. | (1.4) |
| | (0.4) | (0.6) | (0.0) | | | |
| CAS Number | 67762-36-1 | 67762-36-1 | 124-07-02 | 124-07- | 124-07- | 334-48-5 |
| | | | | 02 | 02 | |

*Non Inventoried Item
Specification
(Typical value)

In another embodiment, the invention relates to a composition comprising:

21.50% Coconut Oil Capric/Capryllic Triglyceride (Fractionated Coconut Oil)

15.00% Silicone Oil or Paraffin Oil

4.00% Hydrogenated Castor Oil

4.00% Glycerin

20.00% Soybean Oil

1.00% Cedarwood Oil (fragrance)

4.00% Citric Acid

30.00% Purified Water

0.5% Benzoic Acid

Percents are by weight. Such composition may be referred to herein as soy plus fractionated coconut oil concentrate (also known as Eco-Shield™) and can be used for an insecticide treatment for lawns and gardens. This formulation is non-phototoxic for lawns and gardens. In one embodiment the composition may be used as an insecticide against arthropod pests, agricultural, horticulture, and garden pests. This pest composition is useful in residential, industrial, agriculture, horticulture, and gardening applications to control pests.

In another embodiment, the invention relates to a composition comprising:

oil phase:
10.00% Soy Methyl Ester
10.00% Undecanone
10.00% Coconut Oil Capric/Capryllic Triglyceride
4.00% Glycerin or Isopropyl Palmitate
5.00% Peg40 Castor Oil
2.00% Lecithin (ALC)
3.00% Lauric Acid
3.00% Cetearyl Alcohol
0.50% Cetyl Alcohol
10.00% Coconut Oil LC-810 Fatty Acids
0.20% Vanillin (fragrance)
0.50% Wintergreen Oil or Menthol (fragrance)
0.50% Cedarwood Oil (fragrance)
0.50% LemonGrass Oil or Citral (fragrance)
8.00% Geraniol or Palmarosa Oil (emulisifier and fragrance)

water phase:
30.00% Water
1.00% Sodium Bicarbonate
1.50% Citric Acid
0.30% Benzoic Acid
   Percents are by weight. Such composition may be referred to herein as BioUD™10 Concentrate. This composition is phytotoxic. It is made to be hydrophilic and can be diluted with water. It can be made non-phytoxic by further water dilution above 1:1000 for direct spray application and is very useful in fogging/aerating applications above 1:40 water dilution with no phytotoxic results. In one embodiment the composition may be used as an insecticide and/or repellent against arthropod pests, agricultural, horticulture, and garden pests, and may be used as a repellent against rodent pests and reptile and amphibian pests. This pest composition is useful in residential, industrial, animals and livestock, agriculture, horticulture, and gardening applications to control pests.

The compositions of the invention may be administered to combat pests, at a locus containing or susceptible to the presence of same, by applying to at least a portion of said locus a pest-combating composition, by any suitable administration technique, device or applicator, such as a fogging system, volumizer, nebulizer, aerosolizer, disperser, drip application system, etc. In one embodiment, a pest control system, e.g., for control of pests such as mosquitoes, ticks, cockroaches, thrips, deer fly, gnats, beetles and aphids, is provided as including one or more spray heads and a source of a pest-control composition of the invention, e.g., comprising at least one of soy methyl ester, undecanone, and a fatty acid, wherein such source is coupled in pest-control composition supply relationship to the aforementioned one or more spray heads.

The pest-control system in one embodiment is adapted for mounting of the spray heads to portions of a building.

The invention further contemplates articles incorporating the pest-control compositions of the invention. Such articles may be of any suitable type that have present or potential benefit from having a pest-controlling character imparted thereto, and include, without limitation, apparel articles, industrial equipment, recreational equipment, vehicles, building structures and assemblies and components thereof, food articles and packaging, communications equipment and devices, packaging per se, computational devices, lighting products, books and other articles and media including paper or other cellulosic or materials susceptible to adverse effect from pests.

By way of example, apparel articles may incorporate the pest-combating compositions of the invention, in any suitable manner, including, for example, compositions applied as surface coatings, impregnated formulations, etc. In one embodiment, the pest-combating composition is applied for the treatment of the apparel articles in a formulation including a silicone carrier medium, e.g., containing cyclomethicone, and the apparel article in connection with such treatment can be plasma-treated to enhance the affiliation or loading of the formulation or pest-controlling active thereof on or in the apparel article. Cyclomethicone is a preferred thermal protectant when the pest-control composition is applied to an article, location or organism involving elevated temperature treatment.

In a specific embodiment, the apparel article incorporating the pest-control composition may include a fabric formed from natural or synthetic fibers, such as cotton or nylon. Example 19, under the heading “Cloth Treatment Toxicity Test” set forth below illustrates cytotoxicity (specific results are set forth in Table 25) of a cotton cloth treated with BioUD™30 against cockroach nymphs. Example 27 utilizes a wrist band with a BioUD™8-treated cloth strip attached to it, which demonstrates mosquito repellency.

The pest-controlling compositions of the invention as packaged can include an oleochemical that has been subjected to transesterification, methanolysis or conversion of the fatty acids to alkyl esters. The package may include and aerosol dispensing container, or other reservoir or vessel, coupled or provided with applicator or dispensing members, as appropriate to the specific end-user application involved. The composition may include at least one of soy methyl ester and undecanone and other actives, e.g., citronella, p-menthane 3,8-diol (PMD) and/or picaridin (also called Bayrepel; see world wide web address picaridin.com).

In one embodiment of the invention, the composition is formulated as a spray composition for administration to the skin of a user. Such composition may contain 2% by weight of soy methyl ester, in a carrier base including, as inert ingredients, purified water, coconut oil, glycerin, geranium oil, citric acid, lecithin, sodium bicarbonate and vanillin.

In another embodiment of the invention, the composition is formulated as a lotion composition for administration to the skin of user. Such composition may also contain, as inert ingredients, purified water, coconut oil, glycerin, geranium oil, citric acid, lecithin, sodium bicarbonate and vanillin.

In yet another embodiment of the invention, the composition is formulated as a spray composition for administration to skin or fur of pets. Such composition may contain 2% by weight of soy methyl ester, purified water, coconut oil, glycerin, geranium oil, castor oil, lecithin and vanillin.

Other compositions of the invention may be formulated as sunblock compositions, containing, in addition to soy methyl ester, zinc oxide, titanium dioxide, and/or small amounts of other sunscreen agents, as well as ingredients such as coconut oil, purified water, glycerin, geranium oil, citric acid, lecithin, sodium bicarbonate, and vanillin.

In addition to compositions of the invention that are formulated for application to body surfaces of users, compositions may be formulated for application or administration to any locus in which it is desired to repel pests against which the compositions of the invention are repellantly effective. Such loci may contain or include apparel, furniture, personal accessories, plastic articles or products, cloth articles or products, camping equipment, automotive and vehicular interiors, and the like. For indoor or outdoor usage, the compositions of the invention may be formulated for broadcasting by misting systems or other distribution equipment.

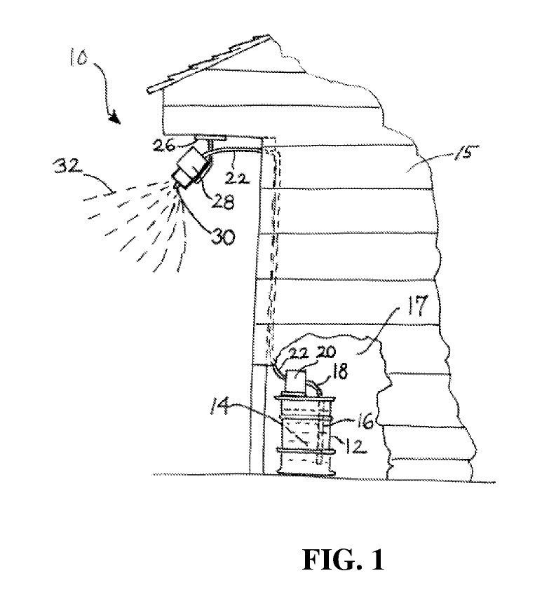

Referring now to the drawings, FIG. 1 is an elevation view, in partial section, of a building 15 equipped with a misting system 10 adapted to mist the exterior environment in proximity to the building with a pest control composition of the invention.

As illustrated, the misting system 10 includes a supply container 12 holding a quantity of a pest control composition 14 according to the present invention. The supply container is disposed in an interior space 17 of the building, and may be of any suitable size, such as for example a 55 gallon drum containing the pest control composition.

The container 12 is equipped with a dip tube 16 joined by supply conduit 18 to the pump and electronic control module 20, which is coupled to a pest control composition feed tube 22. The feed tube 22 in turn is joined to the mister head 28, which includes mister nozzle 30. The mister head 28 is mounted on the building 15, by means of a bracket 26 or other mounting element or structure, so that the mister nozzle 30 is oriented properly for misting an area exterior of the building and in proximity thereto, for control of pests, e.g., mosquitoes, ticks, etc., in the immediate environment of the building.

The pump and electronic control module 20 may be suitably powered by connection to a 110 V electrical service of the building 15, by means of a power cord or other connector (not shown in FIG. 1). The pump and electronic control module 20 incorporates a pump that is effective to deliver pest control composition 14 from the container 12 through the dip tube 16, supply conduit 18 and feed tube 22 to the mister head 28 for generation of a mist 32 of the pest control composition that is dispersed to the local environment of the building 15.

The pump and electronic control module 20 can include a digital control unit or other processor or controller elements or assembly, to actuate the pump in the module when the module is powered and operating. The digital control unit in the module can be programmably arranged, to provide misting action according to a predetermined cycle time program. For example, the misting system can be programmably arranged to mist automatically to four times a day at dawn and dusk, for 20-60 seconds each time.

Additionally, or alternatively, the misting system can be arranged with a remote controller or connection to a wired or wireless network, for selective actuation by a building owner or operational attendant, in addition to or in lieu of a predetermined cycle time program of automatic misting operation.

As a further embodiment, the misting system can be operatively coupled to a pest-sensing system (not shown in FIG. 1), so that the misting system is actuated for dispensing of the pest control composition, in response to detection of pests or a predetermined magnitude of pest infestation by the pest-sensing system.

For example, the pest-sensing system can comprise a bag or other collection container with which is associated a pest attractant, wherein the weight of the collection container is sensed to determine weight gain attributable to collected pests, whereby weight increase of a predetermined magnitude actuates the pump electronic control module 22 initiate misting operation by the misting system. The pest-sensing system can for example be adapted for sensing of mosquito infestation, utilizing carbon dioxide as an attractant to mosquitoes, so that they are collected in a bag to which is operatively coupled a weight sensor, so that a predetermined weight gain of the bag is employed to generate a control signal to the pump electronic control module 22.

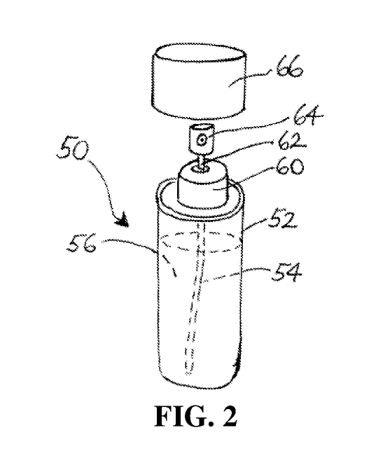

FIG. 2 is an aerosol package 50 for spraying or fogging a pest control composition of the invention. The aerosol package 50 includes a container 52 holding a pest control composition 56 according to the invention. Container 52 includes an upper head portion 60 which may include a cylindrical boss structure of conventional type, by which an aerosol delivery tube 54 is interconnected with a dispensing tube 62 joined in turn to manually actuatable nozzle 64. The pest control composition 56 in the container 52 is suitably mixed with aerosolizing propellant. The aerosol package includes a 66 that is matably engageable with the head portion 60 of the container 52, so that the manually actuatable nozzle 64 is not accidentally actuated.

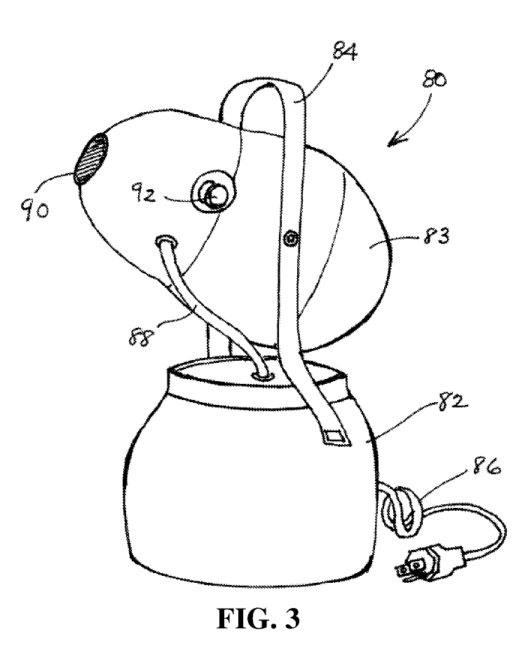

FIG. 3 is a schematic perspective view of a portable fogger 80 suitable for use in dispensing pest control compositions of the present invention.

The portable fogger 80 includes a reservoir 82 adapted to contain a predetermined quantity of a pest control composition of the present invention. The reservoir 82 is joined in liquid feed relationship to a head assembly 83, by means of liquid feed conduit 88, extending downwardly at one end into the reservoir interior volume, and serving to deliver liquid pest control composition into the head assembly 83 for aerosolization of the liquid therein to generate a fog or mist of desired character. Such fog our list is dispensed from the head assembly by discharge through the distal louvered dispensing plate element 90 mounted on the head assembly housing.

The head assembly can be constructed to include a pump and aspirator apparatus inside the housing, which serves to draw liquid from the reservoir 82, and subject same to entrainment by an airstream flowed through the housing by operation of a blower or fan that is internally disposed in the housing of the head assembly. The airflow rate and character of fog or mist generation is selectively adjustable by means of manually adjustable knob 92.

The head assembly 83 is connected with the reservoir 82, by means of the strap handle connector 84, to form a manually portable fogger assembly. The portable fogger 80 of FIG. 3 may be powered by attachment of the plug at the end of power cord 86 to a suitable 110 V power circuit or other power supply.

A portable fogging device of the type shown in FIG. 3 can also be drum-mounted on a drum containing a supply of the pest-control composition, so as to fog a localized area.

A portable fogging device of such type has been employed in connection with pest-control compositions formulated with soy methyl ester and undecanone, and demonstrated to repel mosquitoes, ticks and beetles such as Japanese beetles.

Portable fogging devices of the above-described type are commercially available, e.g., the Fogmaster Micro Jet ULV Fogger 7401 adapted to produce particle size in a range of from 7 μm diameter to 30 μm diameter, and to cover 2-4000 ft.³ per minute, with a 10-turn precision needle valve to control liquid output and droplet size, accommodating liquid flow rate of 0-300 mL per minute, when processing water-based or oil-based solutions. The tank capacity of such product is 4 L and its weight is 6 kg.

The advantages and features of the invention are further illustrated with reference to the following examples, which are not to be construed as in any way limiting the scope of the invention but rather as illustrative of embodiments of the invention in specific applications thereof.

### EXAMPLE 1

In this example, various compositions were formulated for comparative testing. The test compositions included: a 1.6% soybean methyl ester emulsion formulated with a commercial sunscreen (Composition A); a 2.4% soybean methyl ester emulsion formulated with a commercial tropical oil (Composition B); a 2.4% soybean methyl ester emulsion formulated with a commercial sunscreen formulation providing an SPF factor of 20 (Composition C); a 4% soybean methyl ester emulsion formulated with 8% undecanone, in a water-based composition (Composition D); and an 8% soybean methyl ester emulsion formulated with 30% undecanone (Composition E). All concentrations are by weight, based on the total weight of the composition. The various compositions A-E were tested for mosquito repellency see as well as tick repellency.

The results are set out in Table 1 below.

TABLE 1

| Composition A | Composition B | Composition C | Composition D | Composition E |
|---|---|---|---|---|
| 1.6% Soybean | 2.4% Soybean | 2.4% Soybean | 4% Soybean | 8% Soybean Methyl Ester |
| Methyl Ester | Methyl Ester | Methyl Ester | Methyl Ester | emulsion with 30% |
| emulsion | emulsion | emulsion with SPF | emulsion with 8% | Undecanone |
| | | 20 | Undecanone | |
| Mosquito: <2 hr | Mosquito: >4 hr | Mosquito: >4.5 hr | Mosquito: >4.5 hr | Mosquito: equivalent to |
| | | | | 30% DEET |
| Ticks: Not tested | Ticks: <10 min | Ticks: Not Tested | Ticks: >2 hours | Ticks: >2 hours |

The data in Table 1 show that the compositions containing 2.4% and higher concentrations of soy methyl ester demonstrated superior mosquito repellency, and that compositions containing at least 4% soy methyl ester in combination with 2-undecanone demonstrated superior tick repellency, with Composition E yielding performance generally equivalent to that of a permethrin formulation and to a 30% DEET formulation.

### EXAMPLE 2

In this comparative test, a composition containing 8% soy methyl ester emulsion with 30% undecanone, the same composition as tested in Example 1 (Composition E), was evaluated for tick repellency, against an untreated control. A 0.5% permethrin composition also was assessed for tick repellency, against an untreated control.

All tests were carried out on paper media, to which native ticks (American dog ticks) were introduced.

The test arena was a 10 cm diameter plastic petri plate (78.5 cm² bottom surface area). The inside bottom surface was covered with two half circles of white copy paper, separated by a 3 mm void at the centerline. An amount of 537 μL of Composition E sample was applied to the left half of the arena. Ticks, which were unfed males/females of the American dog tick, Dermacenter variabilis, were added to the arena less than five minutes after treatment with Composition E. The assay was conducted in a dimly lit room, at room temperature. One tick on the treated side was judged to be intoxicated at the two-hour reading.

The results of the test are shown in Table 2 below.

TABLE 2

| Time | Treated (L) | Untreated (R) |
|---|---|---|
| Immediate | 2 | 3 |
| 30 min | 1 | 4 |
| 45 | 2 | 3 |
| 60 | 3 | 2 |
| 1 h:30 min | 1 | 4 |
| 2 h:00 min | 1 | 4 |

As shown by the foregoing data, the number of ticks on the treated half circle generally remained smaller than the number of ticks on the untreated half circle, throughout the period of the test. Further, the data show that Composition E maintained its tick repellant character over the two-hour period of the test.

### EXAMPLE 3

A corresponding test to that of Example 2 was carried out for a 0.5% permethrin composition. It appeared that the ticks were dead at the 60 minute and 2 hour readings. The test data are shown in Table 3 below.

TABLE 3

| Time | Treated (L) | Untreated (R) |
|---|---|---|
| Immediate | 3 | 2 |
| 30 min | 4 | 1 |
| 45 | 4 | 1 |
| 60 | 4 | 1 |
| 1 h:30 min | 3 | 2 |
| 2 h:00 min | 3 | 2 |

Comparison of the data in Table 2 and Table 3 showed that Composition E was more effective than the 0.5% permethrin composition throughout the time-frame of the respective tests.

### EXAMPLE 4

In this test, the tick repellency of a composition containing 2.4% soybean methyl ester emulsion, Composition B of Example 1, and the composition containing 4% soybean methyl ester emulsion with 8% undecanone, Composition D of Example 1, were assessed.

In the test of Composition B, as evaluated against an untreated control, the test arena was 4 cm in diameter (12.56 cm²) on the back of the left hand of the human male subject. As a control, the left and right halves of the arena were untreated.

To evaluate Composition B, 100 μL of such repellant were applied to the right half of the arena. Ticks, unfed males of the American dog tick, Dermacenter variabilis, were added to the arena three minutes after treatment with Composition B.

The times listed in Table 4 below represent minutes after the application of ticks.

The test apparatus was a petri plate top with the opening covered with aluminum screening.

The assay was conducted in light, at room temperature, with the control being conducted first.

The data generated in this evaluation are set out in Table 4 below.

TABLE 4

| | |
|---|---|
| Control | Composition B |

| Time | | L | R | Untreated (L) | Treated (R) |
|---|---|---|---|---|---|
| 1 | min | 3 | 2 | 5 | 0 ticks |
| 2 | | 3 | 2 | 3 | 2 |
| 3 | | 4 | 1 | 5 | 0 |
| 4 | | 0 | 5 | 5 | 0 |
| 5 | | 0 | 5 | 2 | 3 |
| 6 | | 4 | 1 | 4 | 1 |
| 7 | | 3 | 2 | 3 | 2 |
| 8 | | 1 | 4 | 3 | 2 |
| 9 | | 3 | 2 | 4 | 1 |
| 10 | | 2 | 3 | 4 | 1 |
| 11 | | 2 | 3 | 2 | 3 |
| 12 | | 2 | 3 | 3 | 2 |
| 13 | | 2 | 3 | 2 | 3 |
| 14 | | 1 | 4 | 2 | 3 |
| 15 | | 1 | 4 | 2 | 3 |

The data in Table 4 show that Composition B was effective as a tick repellant for a period of approximately 10 minutes.

### EXAMPLE 5

A corresponding test to that carried out to generate the data of Table 4 in Example 4 was conducted to assess the efficacy of DEET versus untreated human skin, against the American dog tick. The DEET composition contained 10% DEET in absolute ethanol. The test conditions were the same as those employed for evaluation of Composition B in Example 4. The arena was 4 cm in diameter (12.56 cm²) on the undersurface of the left forearm of the human male subjects. The results are shown in Table 5 below, wherein the time is set out in minutes after the application of ticks.

TABLE 5

| | |
|---|---|
| Control | 10% DEET |

| Time | | L | R | Untreated (L) | Treated (R) |
|---|---|---|---|---|---|
| 0 | min | 3 | 2 | 2 | 3 ticks |
| 1 | | 4 | 1 | 2 | 3 |
| 2 | | 4 | 1 | 3 | 2 |
| 3 | | 4 | 1 | 4 | 1 |
| 4 | | 4 | 1 | 3 | 2 |
| 5 | | 4 | 1 | 4 | 1 |
| 6 | | 3 | 2 | 3 | 2 |
| 7 | | 3 | 2 | — | — |
| 8 | | 1 | 4 | 4 | 1 |
| 9 | | 3 | 2 | 5 | 0 |
| 10 | | 2 | 3 | 5 | 0 |
| 11 | | 3 | 2 | 3 | 2 |
| 12 | | 3 | 2 | 2 | 3 |
| 13 | | 2 | 3 | 4 | 1 |
| 14 | | 2 | 3 | 4 | 1 |
| 15 | | 2 | 3 | 4 | 1 |

These data illustrate the efficacy of the 10% DEET composition.

### EXAMPLE 6

In this example, Composition D was evaluated versus untreated human skin, against the American dog tick. The test arena was 4 cm in diameter (12.56 cm²) on the left inner thigh of the human male subject, just proximal to the kneecap. 100 μL of Composition D were applied to the top half of the arena. Ticks, males of the American dog tick, Dermacenter variabilis, were added to the arena two minutes after treatment with Composition D. As a control, the top and bottom halves of the arena were not treated. The test apparatus was a petri plate top with the opening covered with aluminum screening. The assay was conducted in light at room temperature. The control assay was conducted first. The data are set out in Table 6 below, with times in minutes after application of ticks.

TABLE 6

| | |
|---|---|
| Control | Composition D |

| Time | | T | B | Treated (T) | Untreated (B) |
|---|---|---|---|---|---|
| 0 | min | | | 5 | 0 ticks |
| 1 | | 4 | 1 | 2 | 3 |
| 2 | | 4 | 1 | 1 | 4 |
| 3 | | 4 | 1 | 0 | 5 |
| 4 | | 2 | 3 | 0 | 5 |
| 5 | | 3 | 2 | 0 | 5 |
| 6 | | 3 | 2 | 0 | 5 |
| 7 | | 3 | 2 | 0 | 5 |
| 8 | | 4 | 1 | 0 | 5 |
| 9 | | 4 | 1 | 0 | 5 |
| 10 | | 4 | 1 | 0 | 5 |
| 11 | | 4 | 1 | 0 | 5 |
| 12 | | 4 | 1 | 0 | 5 |
| 13 | | 3 | 2 | 0 | 5 |
| 14 | | 3 | 2 | 0 | 5 |
| 15 | | 3 | 2 | 0 | 5 |
| 30 | | | | 0 | 5 |
| 40 | | | | 0 | 5 |
| 50 | | | | 0 | 5 |
| 60 | | | | 0 | 5 |
| 75 | | | | 0 | 5 |
| 90 | | | | 1 | 4 |
| 92 | | | | 0 | 5 |
| 93 | | | | 0 | 5 |
| 94 | | | | 1 | 5 |
| 95 | | | | 0 | 5 |
| 96 | | | | 1 | 4 |
| 97 | | | | 0 | 5 |
| 98 | | | | 0 | 5 |
| 99 | | | | 0 | 5 |
| 100 | | | | 0 | 5 |
| 105 | | | | 0 | 5 |
| 110 | | | | 0 | 5 |
| 115 | | | | 0 | 5 |
| 120 | | | | 0 | 5 |
| 135 | | | | 0 | 5 |
| 150 | | | | 0 | 5 |

The data shown in Table 6 evidence superior efficacy of Composition D in repelling ticks.

### EXAMPLE 7

In this example, Composition D was evaluated versus untreated human skin, against the American dog tick. The test arena was 4 cm in diameter (12.56 cm²) on the left inner thigh of the human male subject, just proximal to the kneecap. 100 μL of Composition D were applied to the left half of the arena. Ticks, unfed males/females of the American dog tick, Dermacenter variabilis, were added to the arena 30 seconds after treatment with Composition D. As a control, the right and left halves of the arena were not treated. The test apparatus was a petri plate top with the opening covered with aluminum screening. The assay was conducted in light at room temperature. The control assay was conducted first. The data are set out in Table 7 below, with times in minutes after application of ticks.

TABLE 7

| | |
|---|---|
| Control | Composition D |

| | | | | |
|---|---|---|---|---|
| Time | L | R | Treated (L) | Untreated (R) |

Group of 5 ticks

| | | | | | |
|---|---|---|---|---|---|
| 1 | min | 2 | 3 | 1 | 4 |
| 2 | | 5 | 0 | 3 | 2 |
| 3 | | 3 | 2 | 2 | 3 |
| 4 | | 5 | 0 | 3 | 2 |
| 5 | | 5 | 0 | 2 | 3 |
| 6 | | 4 | 1 | 3 | 2 |
| 7 | | 4 | 1 | 1 | 4 |
| 8 | | 3 | 2 | 0 | 5 |
| 9 | | 3 | 2 | 0 | 5 |
| 10 | | 4 | 1 | 0 | 5 |
| 11 | | | | 3 | 2 |
| 12 | | | | 2 | 3 |
| 13 | | | | 0 | 5 |
| 14 | | | | 2 | 3 |
| 15 | | | | 2 | 3 |
| 16 | | | | 0 | 5 |
| 17 | | | | 0 | 5 |
| 18 | | | | 0 | 5 |
| 19 | | | | 2 | 3 |
| 20 | | | | 1 | 4 |
| 21 | | | | 0 | 5 |
| 22 | | | | 0 | 5 |
| 23 | | | | 0 | 5 |
| 24 | | | | 1 | 4 |
| 25 | | | | 1 | 4 |
| 26 | | | | 2 | 3 |
| 27 | | | | 0 | 5 |
| 28 | | | | 0 | 5 |
| 29 | | | | 0 | 5 |
| 30 | | | | 0 | 5 |

The data in Table 7 evidence the efficacy of a Composition D for repellency of the American dog tick.

### EXAMPLE 8

In this example, Composition D was evaluated versus untreated human skin, against the American dog tick. The test arena was 4 cm in diameter (12.56 cm²) on the right inner thigh of the human male subject, just proximal to the kneecap. 100 μL of Composition D were applied to the left half of the arena. Ticks, unfed males/females of the American dog tick, Dermacenter variabilis, were added to the arena 30 seconds after treatment with Composition D. As a control, the right and left halves of the arena were not treated. The test apparatus was a petri plate top with the opening covered with aluminum screening. The assay was conducted in light at room temperature. The control assay was conducted first. The data are set out in Table 8 below, with times in minutes after application of ticks.

TABLE 8

| | |
|---|---|
| Control | Composition D |

| | | | | |
|---|---|---|---|---|
| Time | L | R | Treated (L) | Untreated (R) |

Group of 5 ticks

| | | | | | |
|---|---|---|---|---|---|
| 0 | min | | | 5 | 0 |
| 1 | | 0 | 5 | 1 | 4 |
| 2 | | 0 | 5 | 3 | 2 |
| 3 | | 1 | 4 | 1 | 4 |
| 4 | | 2 | 3 | 0 | 5 |
| 5 | | 1 | 4 | 0 | 5 |
| 6 | | 1 | 4 | 1 | 4 |
| 7 | | 1 | 4 | | |
| 8 | | 2 | 3 | 2 | 3 |
| 9 | | 4 | 1 | 1 | 4 |
| 10 | | 4 | 1 | | |
| 11 | | 4 | 1 | 1 | 4 |
| 12 | | 3 | 2 | | |
| 13 | | 3 | 2 | | |
| 14 | | 3 | 2 | | |
| 15 | | 5 | 0 | | |
| 16 | | 4 | 1 | | |
| 17 | | 4 | 1 | | |
| 18 | | 4 | 1 | | |
| 19 | | 5 | 0 | | |
| 20 | | 5 | 0 | | |

### EXAMPLE 9

In this example, Composition D was evaluated versus untreated human skin, against the American dog tick. The test arena was 4 cm in diameter (12.56 cm²) on the left inner thigh of the human male subject, just proximal to the kneecap. 100 μL of Composition D were applied to the left half of the arena. Ticks, unfed males/females of the American dog tick, Dermacenter variabilis, were added to the arena in less than two minutes after treatment with Composition D. As a control, the right and left halves of the arena were not treated. The test apparatus was a petri plate top with the opening covered with aluminum screening. The assay was conducted in darkness at room temperature. The control assay was conducted first. The data are set out in Table 9 below, with times in minutes after application of ticks.

TABLE 9

| | |
|---|---|
| Control | Composition D |

| | | | | |
|---|---|---|---|---|
| Time | L | R | Treated (L) | Untreated (R) |

Group of 5 ticks

| | | | | | |
|---|---|---|---|---|---|
| 0 | min | | | 4 | 1 |
| 5 | | 5 | 0 | | |
| 10 | | 2 | 3 | | |
| 15 | | 4 | 1 | 1*** | 4 |
| 20 | | 3 | 2 | | |
| 25 | | 2 | 3 | | |
| 30 | | 3 | 2 | 1 | 4 |
| 45 | | 2 | 3 | 0 | 5 |
| 60 | | 1 | 4 | 1 | 4 |

***This tick appeared intoxicated by the repellant. At 30 minutes, the tick was still his back.

At 30 minutes, the human subject used a blunt probe to place the tick right side up. At 45 minutes, the tick had moved to the untreated skin. This intoxication effect resulting in immobilization may have occurred in earlier experiments of Examples 4-8.

### EXAMPLE 10

In this example, Composition D was evaluated versus untreated human skin, against the American dog tick. The test arena was 4 cm in diameter (12.56 cm²) on the right inner thigh of the human male subject, just proximal to the kneecap. 100 μL of Composition D were applied to the left half of the arena. Ticks, unfed males/females of the American dog tick, Dermacenter variabilis, were added to the arena in less than two minutes after treatment with Composition D. As a control, the right and left halves of the arena were not treated. The test apparatus was a petri plate top with the opening covered with aluminum screening. The assay was conducted in darkness at room temperature. The control assay was conducted first. The data are set out in Table 10 below, with times in minutes after application of ticks.

TABLE 10

| | |
|---|---|
| Control | Composition D |

| Time | Rep | L | R | Treated (L) | Untreated (R) |
|---|---|---|---|---|---|
| 0 min | 1 | | | 4 | 1 |
| | 2 | | | 5 | 0 |
| 10 | 1 | 4 | 1 | 2 | 3 |
| | 2 | 2 | 3 | 2 | 3 |
| 20 | 1 | 2 | 3 | 1 | 4 |
| | 2 | 3 | 2 | 1 | 4 |
| 30 | 1 | 3 | 2 | 1 | 4 |
| | 2 | 0 | 5 | 3 | 2 |
| 40 | 1 | 3 | 2 | 1 | 4 |
| | 2 | 3 | 2 | 1 | 4 |
| 50 | 1 | 2 | 3 | 3 | 2 |
| | 2 | 3 | 2 | 1 | 4 |
| 60 | 1 | 3 | 2 | 3 | 2 |
| | 2 | 3 | 2 | 2 | 3 |

### EXAMPLE 11

In this example, the test arena was a 10 cm diameter plastic petri plate (78.5 cm² bottom surface area). The inside bottom of the plate was covered with two half circles of white copy paper, separated by a 3 mm void at the centerline. Composition D was applied to the left half of the arena in the amount of 537 μL. Ticks, unfed males/females of the American dog tick, Dermacenter variabilis, were added to the arena less than two minutes after application of composition D. The assay was conducted in darkness at room temperature. The data are set forth in Table 11 below, with times given in minutes after application of ticks. It was not determined whether ticks were still alive at the 9 hours 43 minutes reading.

TABLE 11

Composition D

| Time | Treated (L) | Untreated (R) |
|---|---|---|
| 30 min | 1 | 4 |
| 45 | 0 | 5 |
| 60 | 0 | 5 |
| 1 h:30 min | 0 | 5 |
| 9 h:43 min | 0 | 5 |

### EXAMPLE 12

In this example, the test arena was 4 cm in diameter (12.56 cm²) on the left inner thigh of the human male subject, just proximal to the kneecap. As a control, the left and right halves of the arena were untreated. A 7% DEET composition was applied to the left half of the arena in the amount of 100 μL. Ticks, unfed males/females of the American dog tick, Dermacenter variabilis, were added to the arena 1 minute 45 seconds after application of the 7% DEET composition. The assay was conducted in darkness at room temperature. The test apparatus was a petri plate top with the opening covered with aluminum screening. The base for the 7% DEET composition was mostly alcohol; it was not apparent, whether the one minute 45 second waiting period was sufficient for all of the alcohol to evaporate from the skin. The data are set forth in Table 12 below, with times given in minutes after application of ticks.

TABLE 12

| | |
|---|---|
| Control | 7% DEET Composition |

| Time | L | R | Treated (L) | Untreated (R) |
|---|---|---|---|---|
| 0 min | 2 | 3 | 5 | 0 |
| 5 | 2 | 3 | 5 | 0 |
| 10 | 3 | 2 | 5 | 0 |
| 15 | 2 | 3 | 4 | 1 |
| 20 | 1 | 4 | 4 | 1 |
| 25 | 1 | 4 | 4 | 1 |
| 30 | 0 | 5 | 4 | 1*** |
| 35 | 3 | 2 | | |
| 40 | 2 | 3 | | |
| 45 | 3 | 2 | | |
| 50 | 3 | 2 | | |
| 55 | 3 | 2 | | |
| 60 | 3 | 2 | | |

***Only one tick moved since the beginning of the experiment, such movement occurring between 10 and 15 minutes. The experiment was stopped at 30 minutes, and that this time, all ticks appeared to be alive, i.e., they moved when touched with a blunt probe.

### EXAMPLE 13

In this example, the test arena was a 10 cm diameter plastic petri plate (78.5 cm² bottom surface area). The inside bottom was covered with two half circles of white copy paper separated by a 3 mm void at the centerline. As a control, the left and right halves of the arena were untreated. A 7% DEET composition was applied to the left half of the arena in the amount of 537 μL. Ticks, unfed males/females of the American dog tick, Dermacenter variabilis, were added to the arena after the 7% DEET composition was no longer visible. The assay was conducted in darkness at room temperature. The data are set forth in Table 13 below, with times given in minutes after application of ticks.

TABLE 13

7% DEET Composition

| Time | Treated (L) | Untreated (R) |
|---|---|---|
| 1 min | 2 | 3 |
| 10 | 1 | 4 |
| 20 | 1 | 4 |
| 30 | 1 | 4 |
| 40 | 2 | 3 |
| 50 | 2 | 3 |
| 60 | 1 | 4 |
| 1 h:10 min | 1 | 4 |
| 1:20 | 1 | 4 |
| 2:00 | 2 | 3 |
| 3:30 | 2 | 3 |
| 4:30 | 2 | 3*** |

***All ticks moved when touched with a blunt probe at four hours, 30 minutes.

### EXAMPLE 14

The objective of this experiment was to evaluate mosquito repellency of compositions of the present invention under natural field conditions.

All tests were conducted with wild populations on a nature trail at Howell Woods Environmental Education Center, Bentonville, N.C. Two specific study locations were selected: a three meter wide trail through a heavily wooded area, (forest) and on a 1.2 m wide plank bridge, approximately 0.6 m above the surface of a heavily wooded pond.

Two repellant compositions were tested: a 2.4% soybean emulsion formulated with a sunscreen formulation having an SPF 20 factor (Composition F); and a 4% soybean methyl ester emulsion formulated with 8% undecanone (Composition G).

The experimental protocol was based on the EPA Product Performance Test Guidelines OPPTS 810.3700 Insect Repellants for Human Skin and Outdoor Premises and PMRA requirements (Canada). For this experiment, the test area was the surface of the arm just distal to the elbow to the most distal end of the hand. The following test applications were used: (a) control (no treatment); (b) 2.0 mL of Composition F; and (c) 1.5 mL of Composition G. Composition F was a viscous cream. The application of the repellant to all subjects was conducted within a 10 minute time period. Landing counts in the field were conducted at 2, 3, 4 and 4.5 hours after application of the repellant, with the 4.5 hour assay conducted at dusk. The repellant volume to be applied was measured with a P5000 Gilson Pippetmann, and applied directly to the subject's skin. The applied repellant was spread with a free hand to cover the entire area to be treated. Subjects were requested to remain in the reception area until about one hour prior to the first field test (the two-hour post-treatment test). Each replicate was one person (control, one male and one female; Composition F (2 mL), two males and one female; Composition G (1.5 mL), two males and one female), and the same person was tested at each time (total number of human subjects=eight). At approximately 1 hour before the field test, all subjects traveled by car for about 40 minutes to the parking lot of the visitor center at Howell Woods.

All subjects were dressed in their personal clothing of choice, with only the treated or control area of their forearm, their hands, and their head exposed. Each subject were at least two shirts. The head of each subject was covered with hat and mosquito net, and the hand on the subject's untreated arm was covered with a latex disposable glove. The only exposed skin for mosquito landings was the control or treated surface of the forearm and hand of one arm. The pants for both legs was either taped tight against the ankles or inserted into the subjects' socks. Each subject was provided with a pencil and data form to record landing counts, and all test subjects then walked together about 0.25 mile to the test location.

Two distinctly different test locations, forest and bridge, were used, as previously described. Each test location covered a linear area of the 37 m. Two to three test measurements were made at a different site in the same test location (forest or bridge). At each time (2-4.5 hours post-treatment of the repellant). Changes in the site within a location were achieved by asking subjects to randomly exchange positions with other subjects. After each test time (2, 3 and 4 hours), the subjects all returned together to the parking lot of the Howell Woods Visitor's Center. Between the four and 4.5 hours reading, the subjects remained in the forest location. Subjects were asked to count the number of mosquito landings over a given observation, which was initiated and ended by voice communication from one of the control subjects. Landings were defined as a mosquito on the subject's forearm or hand for at least two seconds and/or after observing probing. The subjects were asked to physically remove the mosquito from their arm with their free hand using at least a brushing motion to prevent mosquito bites. The estimated skin surface area for the control and treatments was 900 cm² each. All landing count measurements were taken simultaneously across reps at each location, and at different sites within a location.

Results are set out below in Table 14.

TABLE 14
Mosquito landing counts on the surface of arm from just distal to the elbow
to the most distal end of hand.^{a}

| Parameter | | Control | | Composition F | | | Composition G | | |
|---|---|---|---|---|---|---|---|---|---|
| Time | Location | Rep 1 | Rep 2 | Rep 1 | Rep 2 | Rep 3 | Rep 1 | Rep 2 | Rep 3 |
| 2 hrs | Forest | 4.60/min | 2.40 | 0 | 0 | 0 | 0 | 0 | 0 |
| 2 hrs | Bridge | 8.40 | 19.20 | 0 | 0 | 0 | 0 | 0 | 0.33^{b} |
| 2 hrs | Bridge | 9.67 | 16.67 | 0 | 0 | 0 | 0 | 0 | 0 |
| 3 hrs | Forest | 7.33 | 9.00 | 0.33^{b} | 0 | 0.33 | 0 | 0 | 0 |
| 3 hrs | Bridge | 12.67 | 22.00 | 0 | 0 | 1.00 | 0 | 0 | 0 |
| 3 hrs | Bridge | 11.33 | 16.00 | 0 | 0 | 0.67 | 0.33 | 0 | 0 |
| 4 hrs | Forest | 13.00 | 15.00 | 0 | 1.00 | 1.33 | 0.33 | 0 | 0.33 |
| 4 hrs | Bridge | 5.33 | 11.00 | 0 | 0 | 2.33 | 0 | 0 | 1.33 |
| 4 hrs | Bridge | 17.33 | 15.00 | 0 | 0 | 0.67 | 0.67 | 0 | 1.00 |
| 4.5 hrs | Bridge | 14.33 | 21.00 | 0 | 0 | 0.33 | 0 | 0 | 0.33 |
| 4.5 hrs | Forest | 18.67 | 7.67 | 0 | 1.33 | 0.33 | 0.33 | 0 | 0.33 |

^{a}Time = elapsed time after application of repellant.
^{b}Mosquito landing on fingernail.

The percent repellency based on the Table 14 results is set out in Table 15 below.

TABLE 15
Percent repellency on the surface of arm from just distal to the elbow
to the most distal end of hand.^{a}

| Parameter | | Control | Composition F | | | Composition G | | |
|---|---|---|---|---|---|---|---|---|
| Time | Location | mean landings/min | Rep 1 | Rep 2 | Rep 3 | Rep 1 | Rep 2 | Rep 3 |
| 2 hrs | Forest | 3.50 | 100 | 100 | 100 | 100 | 100 | 100 |
| 2 hrs | Bridge | 13.80 | 100 | 100 | 100 | 100 | 100 | 97.61^{b} |
| 2 hrs | Bridge | 13.17 | 100 | 100 | 100 | 100 | 100 | 100 |
| 3 hrs | Forest | 16.33 | 97.98^{b} | 100 | 97.98 | 100 | 100 | 100 |
| 3 hrs | Bridge | 17.34 | 100 | 100 | 94.23 | 100 | 100 | 100 |
| 3 hrs | Bridge | 13.66 | 100 | 100 | 95.10 | 97.58 | 100 | 100 |
| 4 hrs | Forest | 14.00 | 100 | 92.86 | 90.50 | 97.64 | 100 | 97.64 |
| 4 hrs | Bridge | 8.16 | 100 | 100 | 71.45 | 100 | 100 | 83.70 |
| 4 hrs | Bridge | 16.16 | 100 | 100 | 95.85 | 95.85 | 100 | 93.81 |
| 4.5 hrs | Bridge | 17.66 | 100 | 100 | 98.13 | 100 | 100 | 98.13 |
| 4.5 hrs | Forest | 13.17 | 100 | 89.90 | 97.49 | 97.49 | 100 | 97.49 |

^{a}Time = elapsed time after application of repellant.
^{b}Mosquito landing on fingernail.

In generating the data of Table 14 and Table 15, the assay time for the Rep 1 control was typically three minutes, but some of the earlier measurements were made at five minutes. Due to the high landing counts for the Rep 2 control at two hours, this subject was provided an option to stop their counts at one minute. The assay time for the treated subjects was the same as for the Rep 1 control. Table 14 shows the landing counts per minute, for the controls and treatments. Accept for the two-hour Forest assay for Reps 1 and 2 and one of the bridge measurements for Rep 1 at four hours, the landing counts exceeded seven per minute, which was greater than the minimum activity level acceptable for conducting data analyses.

Table 15 shows the mean control landings per minute for each test. And percent repellency for each Rep at each location and site within a location for each of the compositions F and G. Percent repellency for each Rep was calculated based on its control as follows: [(mean landing counts per minute for control)-(landing counts per minute for Rep)/mean landing counts per minute for control]×100%. The repellency data shown in Table 15 evidence high effectiveness of both Compositions F and G. The study was concluded at 4.5 hours because of lack of natural light, as needed to observe mosquito landings.

Mosquitoes were collected from the subjects at the end of the assays. The mosquitoes collected were identified as follows: 12 Ochlerotatus anlanticus/tormentus, 4 Psorophora ferox and 1 Psorophora columbiae.

### EXAMPLE 15

Testing was performed to demonstrate the different efficacy of a known insect repellant active. The test results are set out in Tables 16 and 17 below.

TABLE 16
Substance 1
Mean Number (± one standard duration) and percent
reduction of mosquitoes biting subjects

| | Hours post- | | |
|---|---|---|---|
| | application (duration | Mean number of | Percent |
| Treatment | time) | mosquitoes per 3.5 min | reduction |
| Control | — | 6.51 ± 5.48 | — |
| Herbal Spray | 1 | 0.05 ± 0.21 | 99.3 |
| | 2 | 0.55 ± 0.92 | 91.6 |
| | 3 | 0.70 ± 1.18 | 89.2 |
| | 4 | 2.46 ± 3.04 | 62.3 |

TABLE 17
Substance 2: Field Study
A proprietary botanical repellant containing soybean
(methyl ester) as the active Method: Field test using
multiple subjects according to EPA guideline “Product
Performance Test Guidelines, OPPTS 810.3700 Insect
Repellants for Human Skin and Outdoor Premises” Draft,
December 1999
Percent Repellency

| | | Mean Control | (% repellency) | | |
|---|---|---|---|---|---|
| Time | Location | Landings/min | Rep 1 | Rep 2 | Rep 3 |
| 2 h | forest | 3.5 | 100 | 100 | 100 |
| | bridge | 13.8 | 100 | 100 | 100 |
| | bridge | 13.17 | 100 | 100 | 100 |
| 3 h | forest | 16.33 | 97.98^{b} | 100 | 97.98 |
| | bridge | 17.34 | 100 | 100 | 94.23 |
| | bridge | 13.66 | 100 | 100 | 95.1 |
| 4 h | forest | 14 | 100 | 92.86 | 90.5 |
| | bridge | 8.16 | 100 | 100 | 71.45 |
| | bridge | 16.16 | 100 | 100 | 95.85 |
| 4.5 h | bridge | 17.66 | 100 | 100 | 98.13 |
| | forest | 13.17 | 100 | 89.9 | 97.49 |

Test results for Substance 1 demonstrate two hours efficacy, where efficacy is defined as 95% reduction of mosquito bites. Substance 1 is a commercially available insect repellant, using soybean oil as the active, commercially available from HOMS, LLC in Clayton, N.C. Substance 2 is the same as Substance 1, but with the actives processed by the present method. Substance 2 shows an improvement in efficacy to more than four hours.

### EXAMPLE 16

A study was carried out in southern Ontario, Canada, to compare a 30% DEET pest repellant formulation with a 30% undecanone formulation containing soy methyl ester (Composition HS). The purpose of this study was to assess, under field conditions, the efficacy of Composition HS in protecting human subjects for 8 hours post-application against various mosquito species in southern Ontario. Protection was compared to that provided by Deep Woods OFF! Containing 30% DEET (Composition DT).

### Materials and Methods

Site

The study was conducted in an area bordering a mixed deciduous/coniferous woodlot (including maples, poplars, birch, tamarack, white cedar, and white pine as predominant species) with secondary growth under the canopy in a rural area four km south of the southern city limit of Guelph, Ontario. Subjects stood in a goldenrod meadow bordering the woodlot. Adjacent to the study area was a cattail marsh (>four hectares) which was a source of Aedes, Anopheles and Ochlerotatus mosquito species and the mosquito Coquillettidia perturbans. Previous unpublished studies have shown the site to provide sufficient numbers of adult mosquitoes for repellant evaluations.

The study took place on the evenings of Aug. 17, 18, and 22, 2005.

Repellency Evaluation

Six subjects and a supervisor were used in this evaluation. To adjust for size differences among subjects, the surface area of the forearms (wrist to elbow) of each subject was measured and surface area was calculated. The product was applied evenly to the forearms of each subject using latex gloves at a rate of 1.0 ml per 600 cm² of forearm.

During each day of the evaluation, four subjects applied one of the products 7.5 hours before the start of the 30 minute evaluation (two subjects per product). Each night two subjects were non-treated and served as controls. Biting counts were performed over a 30 minute period and therefore the duration of protection that was evaluated was 8 hours. During the three-evening study both products were worn by each subject at least once. The total number of replications equalled six.

Subjects dressed in identical green overalls, head nets and white cotton gloves. The six subjects were randomly assigned to one of six positions on a grid located within the study site. All grid positions were at least 10 m from each other. Biting counts were initiated just prior to dusk (≈20:10 h) to correspond with peak mosquito biting activity and consisted of 6, 4.5-minute biting counts. During each biting count, subjects aspirated all mosquitoes landing and probing on two exposed forearms. Mosquitoes were aspirated into 150 ml clear plastic vials. Following the biting count, the subjects recorded the number of mosquitoes captured. Subjects then rotated to the next position on the grid within 36 seconds when the next 4.5-minute biting count began. In this manner, each subject was at each grid position once each night and the duration of exposure was 30 minutes.

Ambient air temperature, relative humidity, wind speed, and barometric pressure within the study site were measured at the start and end of the biting counts each evening. Biting counts were not conducted on evenings when air temperature was below 10° C. or when strong winds (>25 kph) or rain occurred because these conditions limit mosquito host-seeking activity.

Data Analysis

Percent repellency provided by the product was calculated using the formula: ((mean number of mosquitoes biting non-treated subjects−number biting treated subjects)/mean number biting non-treated subjects)×100%. Mean percent repellency was calculated for the complete 30 minute exposure period.

The mean number of mosquitoes biting non-treated subjects and treated subjects was compared using analysis of variance. Protection provided by both products was analyzed using a Duncan's Multiple Range Test. The analyses were completed using Statistical Analysis Systems version 6.12 (SAS Institute Inc., Cary, N.C.).

Results

The results are summarized in Table 18. Composition HS provided 70.1% mean reduction of mosquitoes landing and biting over the 30 minute evaluation period. Composition DT provided 83.9% mean reduction of mosquitoes landing and biting over the 30 minute evaluation period. The mean number of mosquitoes landing and biting treated subjects was statistically lower (P<0.05) than the mean number of mosquitoes landing and biting control subjects. The protection provided by each product was not statistically different (P>0.05).

The mean air temperature during the three evening study was 17.3° C. (range=12.8, 19.6), the mean relative humidity was 89.8% (range=82.5, 94.5), the mean wind speed was 2.4 kph (range=0.0, 7.1), and the mean barometric pressure was 985.0 mb (range=980.8, 990.5).

TABLE 18
Mean number^{1,2} (± one standard deviation) and percent
reduction of mosquitoes biting human subjects³ during 30 minute
mosquito biting counts in field tests conducted near Guelph,
Ontario, 2005.

| | Duration (hours) | Number of mosquitoes | Percent |
|---|---|---|---|
| Treatment | post-application | Per 4.5 minutes | reduction⁴ |
| Control | — | 3.64 ± 2.97 a | — |
| Composition HS | 8 | 1.17 ± 1.26 b | 70.1 |
| Composition DT | 8 | 0.67 ± 0.96 b | 83.9 |

¹Values followed by different letters in the same column are significantly different (P < 0.05).
²Number of repetitions equaled five for Composition HS and six for Composition DT. One of the Composition HS replicates was dropped because one subject engaged in an activity after product application which resulted in loss of treatment due to excessive perspiration.
³Mean biting pressure over three nights equaled 24.3 mosquitoes per 30 minutes.
⁴Calculated from nightly repellency results, not from means in column 3.

Conclusions

Composition HS lotion mosquito repellant provided >70% protection from blood-seeking mosquitoes for 8 hours post-application in a field test using human subjects. The level of protection provided was statistically significant. Although Composition DT provided greater protection, the difference between products was not statistically significant.

### EXAMPLE 17

Deer Tick Test on Human Skin

The objective of this test was to evaluate the tick repellency of an 8% undecanone in soy methyl ester composition (Composition D) against the deer tick, Ixodes scapularis.

All tests were conducted in the laboratory at ambient room temperature, humidity and light conditions (a combination of sun and incandescent light). The ticks in the test arena prior to the application to the human subject and during the choice assay on human skin were covered with a dark cloth. The ticks were exposed to light only during the 5 seconds needed to determine the tick distribution.

All tests on human skin were conducted with the same male subject using the left leg just above the knee. Tests were conducted with unfed female adults of the deer tick, Ixodes scapularis.

### Test Arenas

Tests on Human Skin

The apparatus used for these tests was a plastic Petri plate top (4 cm in diameter, 6.28 square cm in area) with the opening covered with common aluminum window screening. The aluminum screening was fixed over the opening of the plastic Petri plate top using a soldering iron applied to the screening, which welded the screening to the plastic. Two layers of cheese cloth cut to exactly fit into the plastic Petri plate top were positioned between the Petri dish top and the screen (confined inside of the apparatus). The cloth under this configuration arrests the normal escape behavior of ticks. Ticks in the apparatus are found between the screen and cloth and between the cloth and plastic Petri dish but never between the two layers of cloth. A small un-welded area of the screen was retained until ticks were added to the apparatus. After ticks were added to the device, the un-welded area was sealed with care given not to expose the live ticks to the high heat needed for soldering. After the final sealing of the screen to the plastic plate, in all cases the ticks were observed actively walking inside of the apparatus. The test arena containing ticks was set-up approximately 5 min prior to the beginning of the test. No test device was ever used more than once except for control and treatment tests that were conducted consecutively. No device used for a treatment was re-used for another treatment. No ticks used were ever re-used except when a control and treatment test was conducted on the same day.

The exact location (circle) marking the outside circumference where the device was to be applied to human skin was marked with an ink pin. A straight line was marked on the skin across the circle so that the area of the circle was divided into equal halves. For control experiments, neither half circle received an application. The screen-side of the device was applied to the skin surface at time 0 min. The screen side was in the down position and rested horizontal on the skin surface.

For treatments, the half circle nearest to the left side of the subject was covered with the repellant to be tested. The repellant to be tested (20 microliters) was applied to the half circle with a P200 (Gilson) pipetman. Small droplets were applied throughout the area to be treated and then spread with the pipetman tip to evenly cover the surface area to be treated.

At a minimum of 2 h after treatment, the screen-side of the device containing ticks was applied to the skin surface. The exact times of observations before treatment and 2 h after the application of the repellant is provided in the tables that follow along with the number of ticks tested per experiment. At each observation period, the number of ticks on the left (treated) and right (untreated) side was recorded and the location of the ticks within the arena mapped (see Tables that follow). The tests were conducted in the dark (under 3-4 layers of a dark cloth). This cloth was moved for about 5 sec to observe the position of the ticks.

Test Rationale

The rationale of the test is that the ticks have a choice between two different halves of the test arena. In the absence of the repellant, the distribution of ticks on the two halves should be random. If the material to be tested is a repellant, more ticks would be found on the untreated surface than the treated surface. The assay arena on the subject's leg was held horizontal and the tests were conducted in the dark to eliminate any possible external cues, which might affect the position of the tick in the arena. When the ticks were first positioned on the treated/untreated skin, to the extent possible the orientation of the apparatus was chosen that placed as many as possible of the ticks on the treated surface.

Test Considerations

The test format used was a two-choice test. All tests were conducted with the deer tick. It was noted that the two-choice test and the position of ticks on the treated versus the untreated surface could be affected by toxic effects of the repellant on tick motor and sensory activities at any time during the course of the assay; however, no toxic effects were noted and all ticks were alive and mobile at the conclusion of each test. The ticks in this test were separated from the skin surface by at least the thickness of the aluminum screen and sometimes by the screen and cheese cloth. The movement of the ticks on the screen could be felt by the subject. The ticks did not blood feed on the human through the screen.

Test Conclusions

When 20 μL of Composition D was applied to human skin, the product was highly repellant to the deer tick unfed female adults for at least 2-2.5 h after the application of the repellant.

Test Results

Summarizing the test procedure, the test area was 4 cm in diameter (6.28 square cm) on the left leg just above knee of human (male) subject. Control test was conducted 30 min prior to the application of repellant. The treatment involved application of 20 microliters of Composition D to the left half of the test area. Ticks (unfed female adults of the deer tick, Ixodes scapularis) were added to test apparatus just prior to the control test and same ticks/apparatus used for repellant tests. The apparatus was a plastic Petri plate top with the opening covered with aluminum screening and inside between plate and screen containing two layers of cheese cloth. The assay was conducted at room temperature with apparatus on the test subject skin and then covered with dark cloth. Ticks with apparatus were applied to skin 2 h:0 min after application of the repellant.

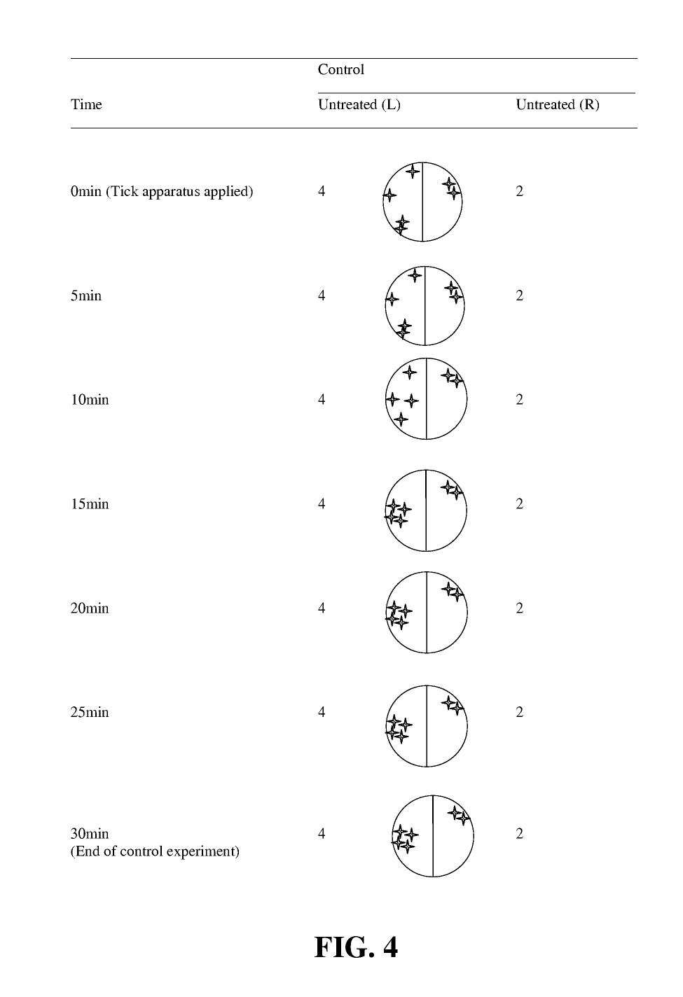

FIGS. 4 (untreated control) and 5 (Composition D in the form of a 20 μL spray) show the results of a two-choice test on human skin, conducted with deer ticks (Test date: Oct. 12, 2005; 9:18 AM).

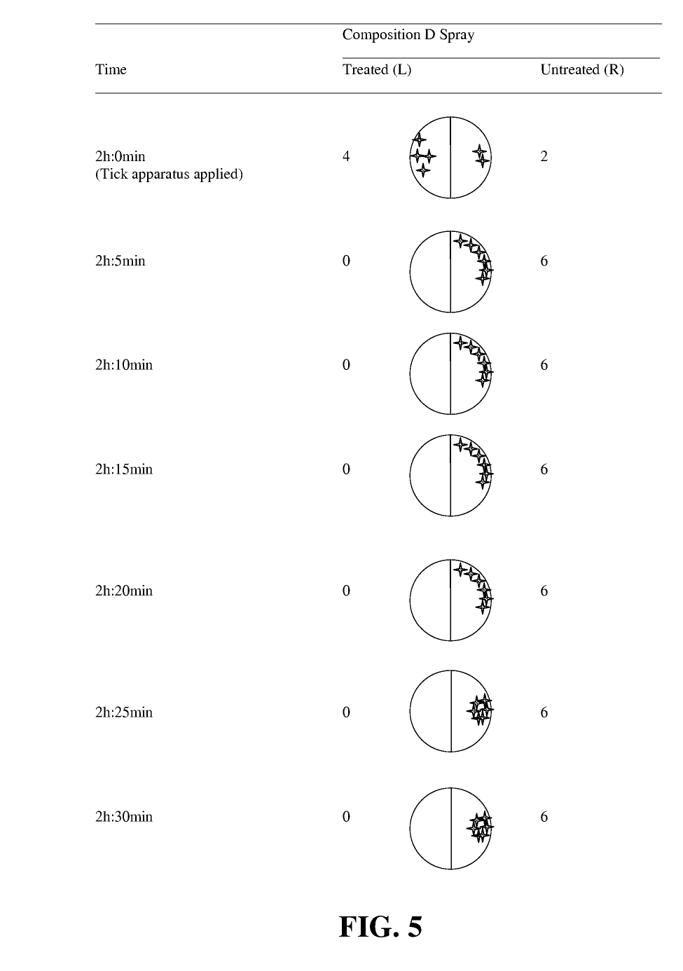

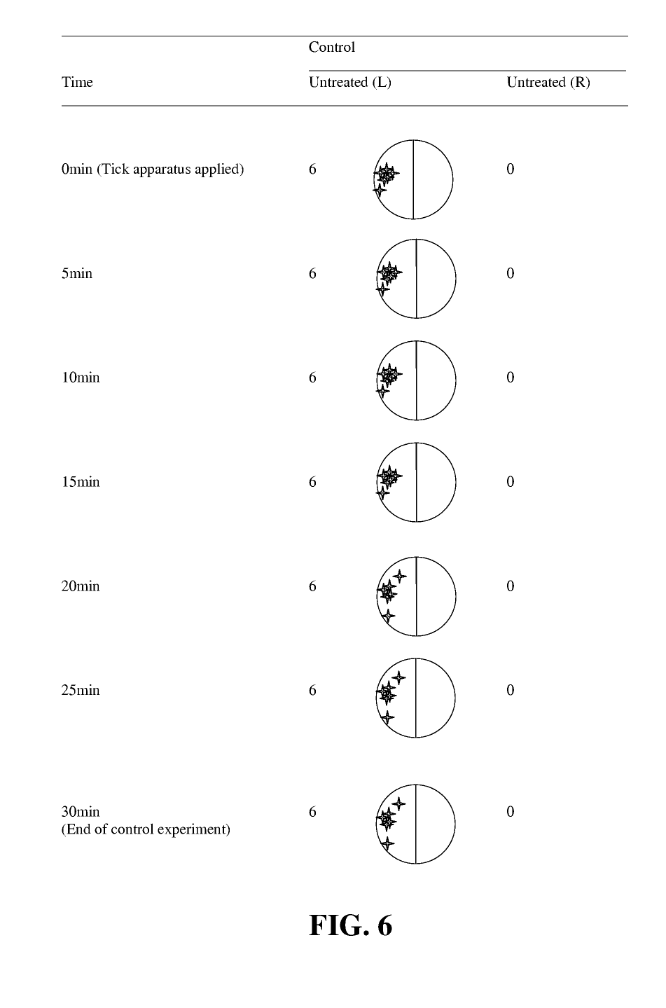

FIGS. 6 (untreated control) and 7 (Composition D in the form of a 20 μL spray) show the results of a two-choice test on human skin, conducted with deer ticks (Test date: Oct. 13, 2005; 8:49 AM).

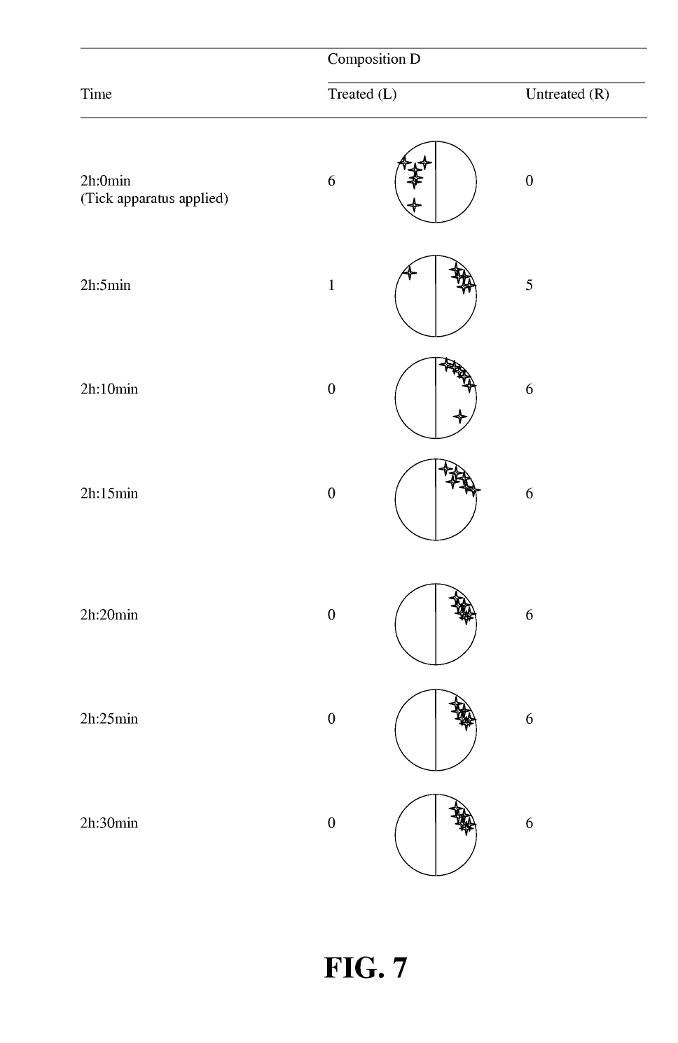

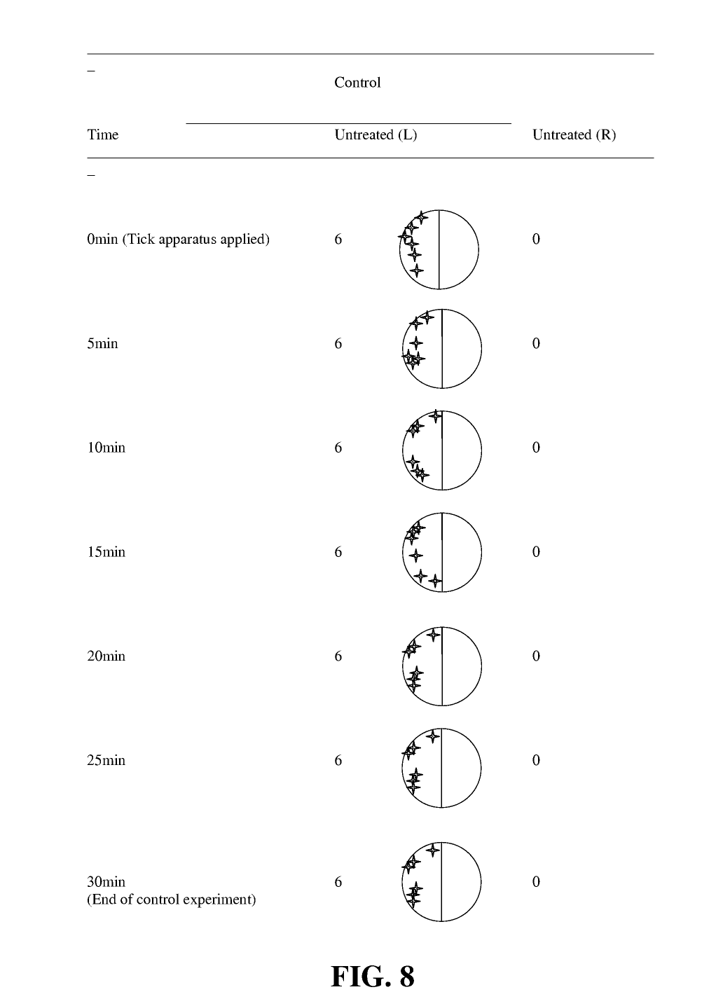

FIGS. 8 (untreated control) and 9 (Composition D in the form of a 20 μL spray) show the results of a two-choice test on human skin, conducted with deer ticks (Test date: Oct. 13, 2005; 2:25 PM).

### EXAMPLE 18

American Dog Tick Test

The test procedure of Example 17 was repeated using unfed mixed sexes of the American dog tick, Dermacenter variabilis, and a 30% undecanone and soy methyl ester formulation of Composition E.

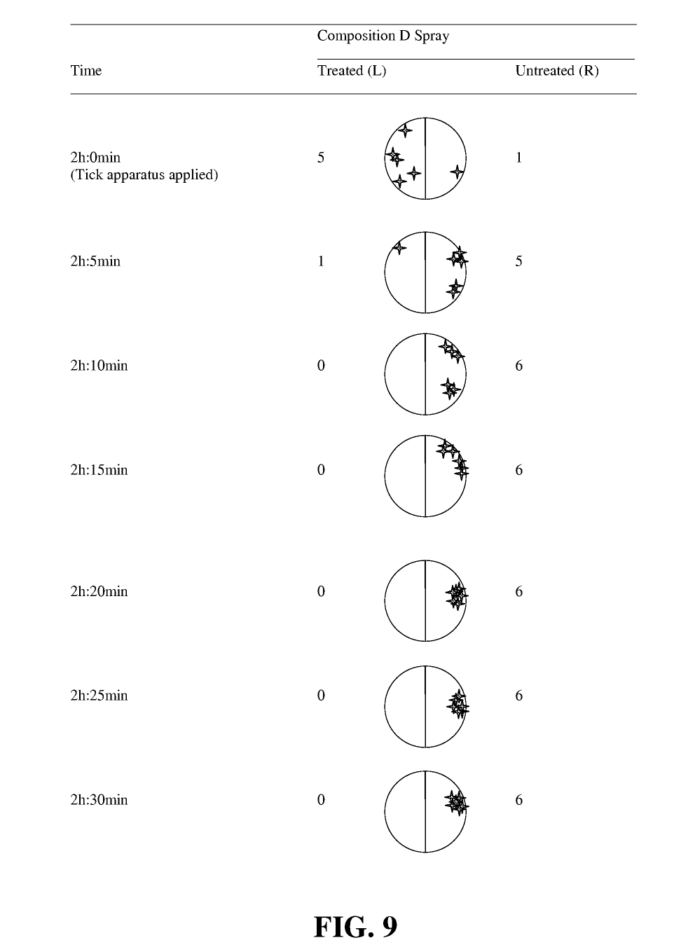

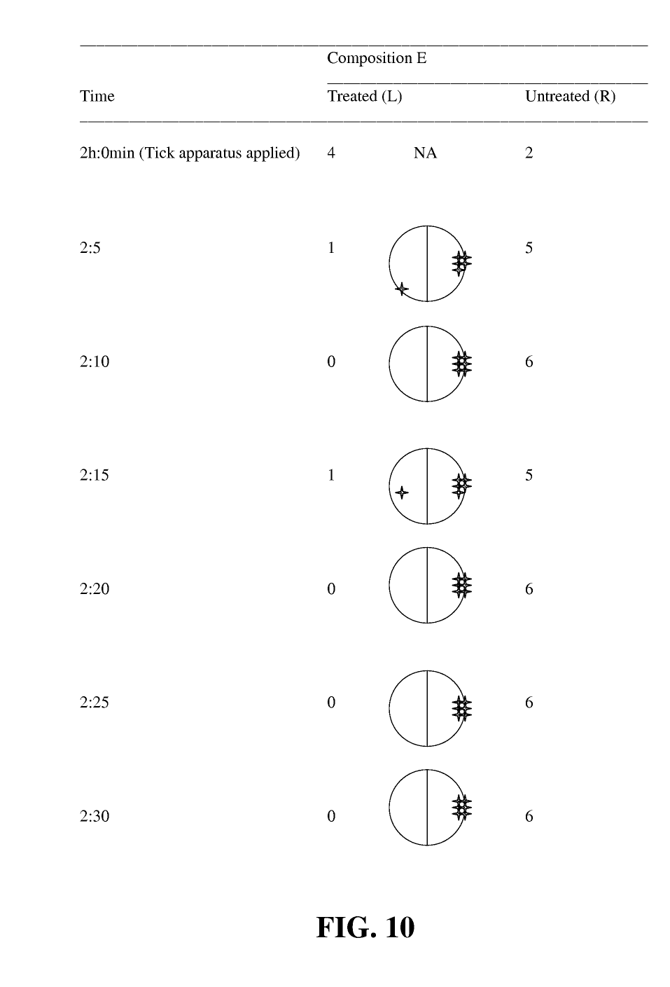

FIG. 10 shows the results of a two-choice test on human skin, conducted with American dog ticks to assess the repellency of Composition E in the form of a 20 μL spray (Test date: May 2, 2005).

### EXAMPLE 19

### Cockroach (Blattella germanica) Repellency and Toxicity Tests of 2-Undecanone and Soy Methyl Ester (Hereinafter SME) and Formulations Thereof

The toxicity tests were performed via treatment of a surface area on which the cockroaches were placed and/or via direct application of the formulations to the cockroaches. One of the surface area tests involved treating the ground on which the cockroaches were placed, while the other involved the efficacy of the formulations after drying on cloth. All of the toxicity tests were performed to determine the time period until mortality of the insect in regard to the method of application.

Cockroach Repellency Test Method

In this test, the cockroaches have a choice between two different halves of the test arena. In the absence of the repellant, the distribution of the insects on the two halves should be random. If the material to be tested is a repellant, more insects would be found on the untreated surface than the treated surface. The tests were performed in polypropylene plastic cups with a bottom diameter of 82 mm and a height of 80 mm. The bottom of a cup was divided into two parts with a marker pen. The sides of a cup were covered with Fluon®AD1 in order to prevent escaping of insects. One of the two marked halves of each bottom of a cup was treated with 5 μL of the formulation. Five cockroaches were placed into each cup, and their positions were recorded for up to 4 hours. The experiment was replicated three times with different cockroaches in separate cups. A random distribution in a cup assumes a 50% chance of each cockroach to be in either half of the cup, while repelled cockroaches will be found in the untreated half. Percent repellency is therefore calculated as number of cockroaches found in the untreated half of a cup divided by the total number of cockroaches. The cockroaches used in the tests were 10, 20, and 30 day old nymphs (Blattella germanica).

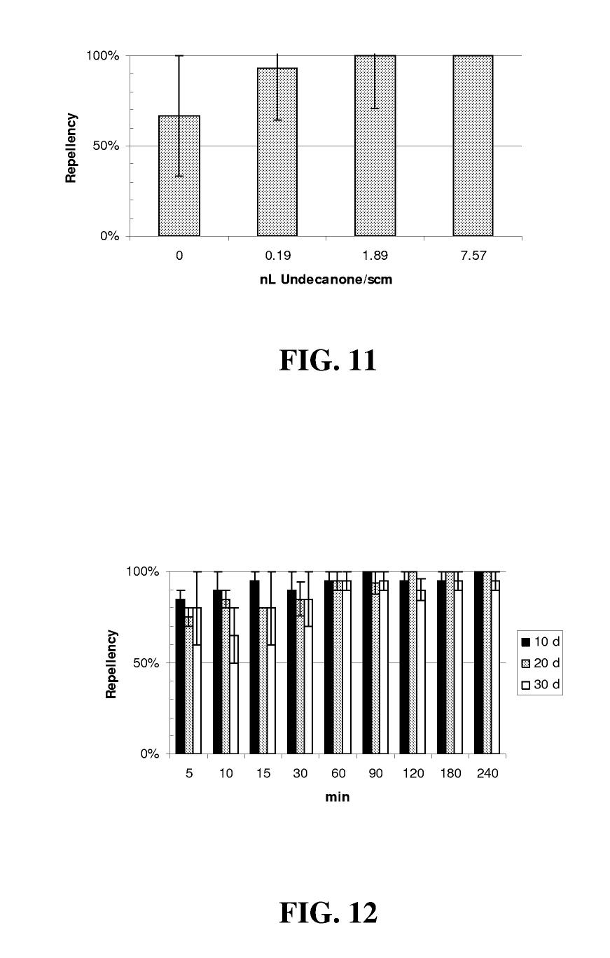

FIG. 11 shows the percent repellency of 2-Undecanone (the active ingredient of BioUD™4), in water against thirty day old cockroach nymphs after 2 hours. FIG. 12 shows the percent repellency of Soy Methyl Ester (SME) against 10, 20, and 30 days old cockroach nymphs (Blattella germanica).

### Cockroach Toxicity Tests

Weeklong Surface Area Toxicity Test Method

In order determine the toxicity of the formulation to the insect after application to a surface over a period of time, the following test was performed. Varying concentrations of the different formulations were applied to the bottom of a number of identical cups, each with a surface area of almost fifty three square centimeters (52.81 cm²), and then five cockroaches were placed in the various cups. Cockroaches were placed in the cups on the first day following the application of the formulations, on the third day following the application of the formulations, and on the sixth day following the application of the formulations in order to monitor the toxicity of the formulations after a period of time had elapsed. The mortality of the cockroaches was then recorded at the time intervals noted. The five cockroaches placed in each cup were one week old cockroaches (Blattella germanica) which had been reared at twenty seven degrees centigrade, at sixty five percent relative humidity, and on a twelve hour light to dark photoperiod. Each of the cups had Fluon®AD1 treated sides to prevent the escape of the cockroaches. The bottoms of the cups were treated with varying concentrations of the formulations varying from 0.02 microliter per centimeter squared to 0.95 microliter per centimeter squared.

The results for the zero to one day treatment are summarized in Table 19 below.

TABLE 19

| 0-1 days | | min | | | | | | | | | | | | | | |
|---|---|---|---|---|---|---|---|---|---|---|---|---|---|---|---|---|
| μL/cm² | μL | 5 | 10 | 15 | 30 | 60 | 90 | 2 h | 4 h | 17.5 h | 18 h | 21 h | 24 h | 27.5 h | 29 h | 30 h |

BioUD ™ 4

| | | | | | | | | | | | | | | | | |
|---|---|---|---|---|---|---|---|---|---|---|---|---|---|---|---|---|
| 0.02 | 1 | 5 | 5 | 5 | 5 | 5 | 5 | 5 | 5 | 5 | 5 | 5 | 5 | 5 | 5 | 5 |
| 0.09 | 5 | 5 | 5 | 5 | 5 | 5 | 5 | 5 | 4 | 4 | 4 | 4 | 4 | 3 | 3 | 3 |
| 0.19 | 10 | 5 | 5 | 5 | 5 | 4 | 4 | 4 | 2 | 1 | 1 | 1 | 1 | 1 | 1 | 1 |
| 0.95 | 50 | 4 | 3 | 2 | 1 | 0 | 0 | 0 | 0 | 0 | 0 | 0 | 0 | 0 | 0 | 0 |

BioUD ™ 5

| | | | | | | | | | | | | | | | | |
|---|---|---|---|---|---|---|---|---|---|---|---|---|---|---|---|---|
| 0.02 | 1 | 5 | 5 | 5 | 5 | 5 | 5 | 5 | 5 | 5 | 5 | 5 | 5 | 5 | 5 | 5 |
| 0.09 | 5 | 5 | 5 | 5 | 5 | 5 | 5 | 5 | 5 | 4 | 4 | 4 | 4 | 4 | 4 | 4 |
| 0.19 | 10 | 5 | 3 | 3 | 3 | 2 | 2 | 2 | 0 | 0 | 0 | 0 | 0 | 0 | 0 | 0 |
| 0.95 | 50 | 1 | 1 | 0 | 0 | 0 | 0 | 0 | 0 | 0 | 0 | 0 | 0 | 0 | 0 | 0 |

Undecanone

| | | | | | | | | | | | | | | | | |
|---|---|---|---|---|---|---|---|---|---|---|---|---|---|---|---|---|
| 0.02 | 1 | 5 | 5 | 5 | 5 | 5 | 5 | 5 | 5 | 5 | 5 | 5 | 5 | 5 | 5 | 5 |
| 0.09 | 5 | 5 | 5 | 4 | 4 | 4 | 4 | 4 | 4 | 4 | 4 | 4 | 4 | 3 | 3 | 3 |
| 0.19 | 10 | 5 | 5 | 5 | 2 | 0 | 0 | 0 | 0 | 0 | 0 | 0 | 0 | 0 | 0 | 0 |
| 0.95 | 50 | 0 | 0 | 0 | 0 | 0 | 0 | 0 | 0 | 0 | 0 | 0 | 0 | 0 | 0 | 0 |

SME

| | | | | | | | | | | | | | | | | |
|---|---|---|---|---|---|---|---|---|---|---|---|---|---|---|---|---|
| 0.02 | 1 | 5 | 5 | 5 | 5 | 5 | 5 | 5 | 5 | 5 | 5 | 5 | 5 | 5 | 5 | 5 |
| 0.09 | 5 | 5 | 5 | 5 | 5 | 5 | 5 | 5 | 5 | 5 | 5 | 5 | 5 | 5 | 5 | 5 |
| 0.19 | 10 | 5 | 5 | 5 | 5 | 4 | 1 | 1 | 0 | 0 | 0 | 0 | 0 | 0 | 0 | 0 |
| 0.95 | 50 | 5 | 4 | 3 | 3 | 0 | 0 | 0 | 0 | 0 | 0 | 0 | 0 | 0 | 0 | 0 |

control

| | | | | | | | | | | | | | | | | |
|---|---|---|---|---|---|---|---|---|---|---|---|---|---|---|---|---|
| 0 | 0 | 5 | 5 | 5 | 5 | 5 | 5 | 5 | 5 | 5 | 5 | 5 | 5 | 5 | 5 | 5 |

The results for the three to four day treatment are summarized in Table 20 below.

TABLE 20

| 3-4 days | | min | | | | | | | | | | | |
|---|---|---|---|---|---|---|---|---|---|---|---|---|---|
| μL/cm² | μL | 5 | 10 | 15 | 30 | 60 | 90 | 2 h | 4 h | 23 h | 24 h | 27 h | 30 h |

BioUD ™ 4

| | | | | | | | | | | | | | |
|---|---|---|---|---|---|---|---|---|---|---|---|---|---|
| 0.02 | 1 | 5 | 5 | 5 | 5 | 5 | 5 | 5 | 5 | 5 | 5 | 5 | 5 |
| 0.09 | 5 | 5 | 5 | 5 | 5 | 5 | 5 | 5 | 5 | 5 | 5 | 5 | 5 |
| 0.19 | 10 | 5 | 5 | 5 | 5 | 5 | 5 | 5 | 5 | 5 | 5 | 5 | 5 |
| 0.95 | 50 | 5 | 5 | 5 | 4 | 0 | 0 | 0 | 0 | 0 | 0 | 0 | 0 |

BioUD ™ 5

| | | | | | | | | | | | | | |
|---|---|---|---|---|---|---|---|---|---|---|---|---|---|
| 0.02 | 1 | 5 | 5 | 5 | 5 | 5 | 5 | 5 | 5 | 5 | 5 | 5 | 5 |
| 0.09 | 5 | 5 | 5 | 5 | 5 | 5 | 5 | 5 | 5 | 4 | 4 | 4 | 4 |
| 0.19 | 10 | 5 | 5 | 5 | 5 | 5 | 5 | 3 | 3 | 3 | 3 | 3 | 3 |
| 0.95 | 50 | 5 | 4 | 4 | 2 | 0 | 0 | 0 | 0 | 0 | 0 | 0 | 0 |

Undecanone

| | | | | | | | | | | | | | |
|---|---|---|---|---|---|---|---|---|---|---|---|---|---|
| 0.02 | 1 | 5 | 5 | 5 | 5 | 5 | 5 | 5 | 5 | 5 | 5 | 5 | 5 |
| 0.09 | 5 | 5 | 5 | 5 | 5 | 5 | 5 | 5 | 5 | 5 | 5 | 5 | 5 |
| 0.19 | 10 | 5 | 5 | 5 | 5 | 5 | 5 | 5 | 5 | 5 | 5 | 5 | 5 |
| 0.95 | 50 | 5 | 5 | 5 | 5 | 5 | 5 | 3 | 2 | 1 | 1 | 0 | 0 |

SME

| | | | | | | | | | | | | | |
|---|---|---|---|---|---|---|---|---|---|---|---|---|---|
| 0.02 | 1 | 5 | 5 | 5 | 5 | 5 | 5 | 5 | 5 | 5 | 5 | 5 | 5 |
| 0.09 | 5 | 5 | 5 | 5 | 5 | 5 | 5 | 5 | 5 | 5 | 5 | 5 | 5 |
| 0.19 | 10 | 5 | 5 | 5 | 5 | 5 | 5 | 5 | 5 | 5 | 5 | 5 | 5 |
| 0.95 | 50 | 5 | 5 | 4 | 1 | 0 | 0 | 0 | 0 | 0 | 0 | 0 | 0 |

control

| | | | | | | | | | | | | | |
|---|---|---|---|---|---|---|---|---|---|---|---|---|---|
| 0 | 0 | 5 | 5 | 5 | 5 | 5 | 5 | 5 | 5 | 5 | 5 | 5 | 5 |

The results for the six to seven day treatment are summarized in Table 21 below.

TABLE 21

| 6-7 days | | min | | | | | | | | | | | | | | | |
|---|---|---|---|---|---|---|---|---|---|---|---|---|---|---|---|---|---|
| μL/cm² | μL | 5 | 10 | 15 | 30 | 60 | 90 | 2 h | 4 h | 21.5 h | 22 h | 23 h | 24 h | 27 h | 29 h | 30 h | 31 h |

BioUD ™ 4

| | | | | | | | | | | | | | | | | | |
|---|---|---|---|---|---|---|---|---|---|---|---|---|---|---|---|---|---|
| 0.02 | 1 | 5 | 5 | 5 | 5 | 5 | 5 | 5 | 5 | 5 | 5 | 5 | 5 | 5 | 5 | 5 | 5 |
| 0.09 | 5 | 5 | 5 | 5 | 5 | 5 | 5 | 5 | 5 | 5 | 5 | 5 | 5 | 5 | 5 | 5 | 5 |
| 0.19 | 10 | 5 | 5 | 5 | 5 | 5 | 5 | 5 | 5 | 5 | 5 | 5 | 5 | 5 | 4 | 3 | 3 |
| 0.95 | 50 | 5 | 4 | 4 | 1 | 0 | 0 | 0 | 0 | 0 | 0 | 0 | 0 | 0 | 0 | 0 | 0 |

BioUD ™ 5

| | | | | | | | | | | | | | | | | | |
|---|---|---|---|---|---|---|---|---|---|---|---|---|---|---|---|---|---|
| 0.02 | 1 | 5 | 5 | 5 | 5 | 5 | 5 | 5 | 5 | 5 | 5 | 5 | 5 | 5 | 5 | 5 | 5 |
| 0.09 | 5 | 5 | 5 | 5 | 5 | 5 | 5 | 5 | 5 | 5 | 5 | 5 | 5 | 5 | 5 | 5 | 5 |
| 0.19 | 10 | 5 | 5 | 5 | 5 | 5 | 5 | 5 | 5 | 5 | 5 | 5 | 5 | 5 | 5 | 5 | 5 |
| 0.95 | 50 | 3 | 3 | 0 | 0 | 0 | 0 | 0 | 0 | 0 | 0 | 0 | 0 | 0 | 0 | 0 | 0 |

Undecanone

| | | | | | | | | | | | | | | | | | |
|---|---|---|---|---|---|---|---|---|---|---|---|---|---|---|---|---|---|
| 0.02 | 1 | 5 | 5 | 5 | 5 | 5 | 5 | 5 | 5 | 5 | 5 | 5 | 5 | 5 | 5 | 5 | 5 |
| 0.09 | 5 | 5 | 5 | 5 | 5 | 5 | 5 | 5 | 5 | 5 | 5 | 5 | 5 | 5 | 5 | 5 | 5 |
| 0.19 | 10 | 5 | 5 | 5 | 5 | 5 | 5 | 5 | 5 | 5 | 5 | 5 | 5 | 5 | 5 | 5 | 5 |
| 0.95 | 50 | 5 | 5 | 5 | 5 | 5 | 5 | 4 | 3 | 2 | 2 | 2 | 2 | 2 | 2 | 2 | 2 |

SME

| | | | | | | | | | | | | | | | | | |
|---|---|---|---|---|---|---|---|---|---|---|---|---|---|---|---|---|---|
| 0.02 | 1 | 5 | 5 | 5 | 5 | 5 | 5 | 5 | 5 | 5 | 5 | 5 | 5 | 5 | 5 | 5 | 5 |
| 0.09 | 5 | 5 | 5 | 5 | 5 | 5 | 5 | 5 | 5 | 5 | 5 | 5 | 5 | 5 | 5 | 5 | 5 |
| 0.19 | 10 | 5 | 5 | 5 | 5 | 5 | 5 | 5 | 5 | 4 | 4 | 4 | 4 | 4 | 4 | 4 | 4 |
| 0.95 | 50 | 5 | 5 | 5 | 4 | 0 | 0 | 0 | 0 | 0 | 0 | 0 | 0 | 0 | 0 | 0 | 0 |

control

| | | | | | | | | | | | | | | | | | |
|---|---|---|---|---|---|---|---|---|---|---|---|---|---|---|---|---|---|
| 0 | 0 | 5 | 5 | 5 | 5 | 5 | 5 | 5 | 5 | 5 | 5 | 5 | 5 | 5 | 5 | 5 | 5 |

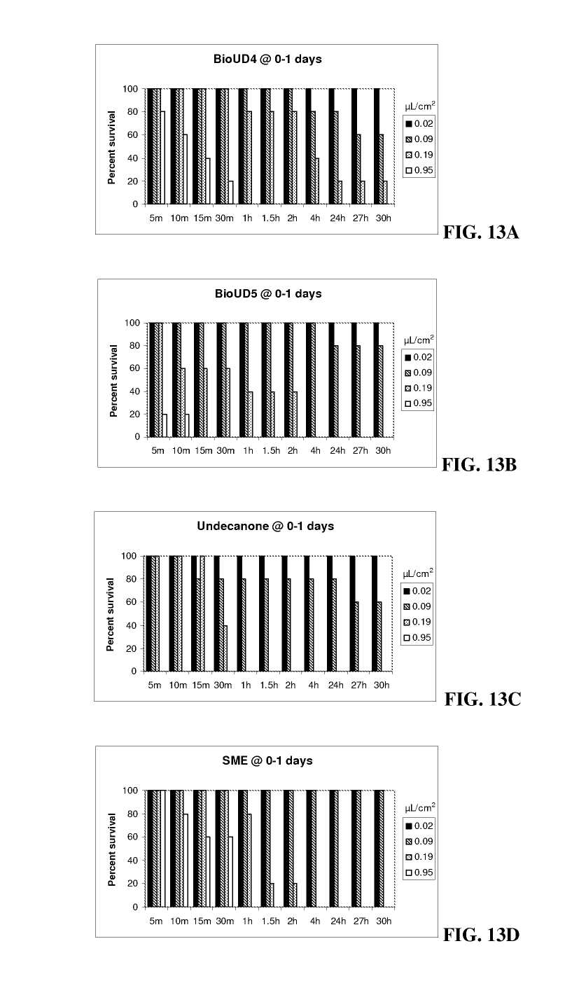

FIG. 13 incorporates the data from Table 19 to show the percent survival of the cockroaches at the differing formulations and the increasing concentrations at the zero to one day mark. The percent survival was calculated by dividing the number of cockroaches alive at that time point by the total number that were placed in the cup, which in all instances was a total of five cockroaches. FIG. 13A shows the percent survival of the cockroaches at zero to one day on the surface area treated with BioUD™4. FIG. 13B shows the percent survival of the cockroaches at zero to one day on the surface area treated with BioUD™5. FIG. 13C shows the percent survival of the cockroaches at zero to one day on the surface area treated with Undecanone. FIG. 13D shows the percent survival of the cockroaches at zero to one day on the surface area treated with soy methyl ester (SME).

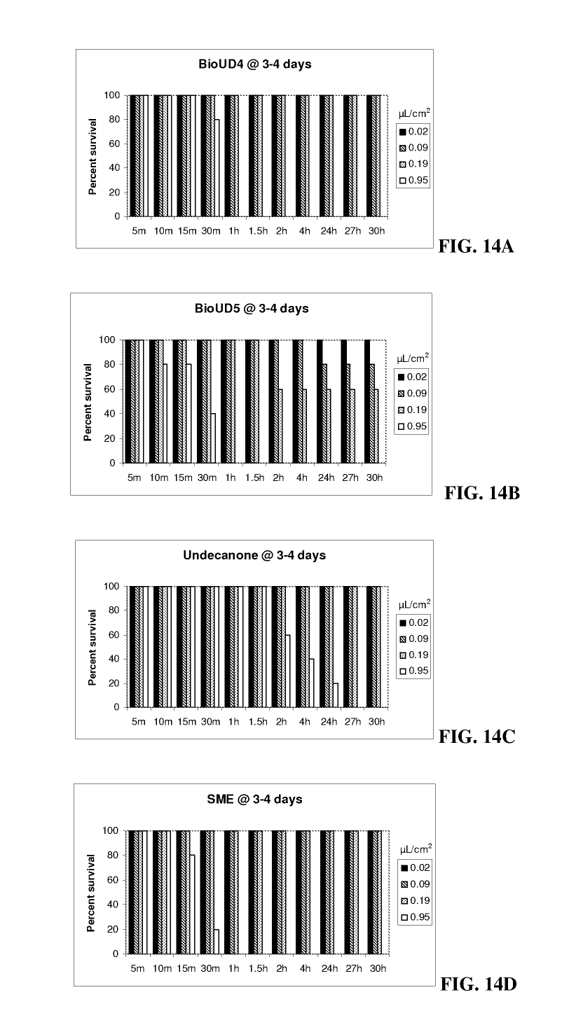

FIG. 14 incorporates the data from Table 20 to show the percent survival of the cockroaches at the differing formulations and the increasing concentrations at the three to four day mark. The percent survival was calculated by dividing the number of cockroaches alive at that time point by the total number that were placed in the cup, which in all instances was five cockroaches total. FIG. 14A shows the percent survival of the cockroaches at day three to four on the surface area treated with BioUD™4. FIG. 14B shows the percent survival of the cockroaches at day three to four on the surface area treated with BioUD™5. FIG. 14C shows the percent survival of the cockroaches at day three to four on the surface area treated with Undecanone. FIG. 14D shows the percent survival of the cockroaches at day three to four on the surface area treated with soy methyl ester (SME).

FIG. 15 incorporates the data from Table 21 to show the percent survival of the cockroaches at the differing formulations and the increasing concentrations at the six to seven day mark. The percent survival was calculated by dividing the number of cockroaches alive at that time point by the total number that were placed in the cup, which in all instances was five cockroaches total. FIG. 15A shows the percent survival of the cockroaches at six to seven days on the surface area treated with BioUD™4. FIG. 15B shows the percent survival of the cockroaches at six to seven days on the surface area treated with BioUD™5. FIG. 15C shows the percent survival of the cockroaches at six to seven days on the surface area treated with Undecanone. FIG. 15D shows the percent survival of the cockroaches at six to seven days on the surface area treated with soy methyl ester (SME).

Direct Application Toxicity Tests

Comparison of Insecticides, Including BioUD™5

Direct Application Toxicity tests were conducted on German cockroaches, Blattella germanica, with several established insecticides purchased from the store and BioUD™5 obtained from Homs, LLC. The insecticidal dose was pipetted onto the back (thorax and abdomen, but also wings in case of adults) of each individual cockroach.

TABLE 22
Comparison of insecticidal compounds (¹d = days, ² n.d. = not determinable).

| | | | | adults: 10 μL | | | | | |
|---|---|---|---|---|---|---|---|---|---|
| | | | | | | | | | Ortho ® |
| | 7-10 day old nymphs: 5 μL | | | | | | | Hot | Home |
| | Raid ® | BioUD ™ 5 | Surefire | Raid ® | BioUD ™ 5 | Surefire | Sevin ® | Shot ® | Defense ® |
| seconds | 15 | 20 | 88 | 47 | 240 | 117 | >3 d¹ | >600 | >1 d |
| until | 109 | 19 | >300 | 25 | 600 | 94 | >3 d | >600 | >1 d |
| death | 90 | 17 | >300 | 53 | 279 | >600 | | | >1 d |
| | 26 | 21 | 92 | 32 | 51 | 95 | | | |
| | 21 | 28 | >300 | 31 | 557 | >600 | | | |
| | 35 | | | | | 167 | | | |
| | 18 | | | | | >600 | | | |
| | 53 | | | | | 75 | | | |
| mean | 45.9 | 21.0 | n.d.² | 37.6 | 345.4 | n.d. | n.d. | n.d. | n.d. |
| stdev | 35.5 | 4.2 | n.d. | 11.8 | 230.1 | n.d. | n.d. | n.d. | n.d. |

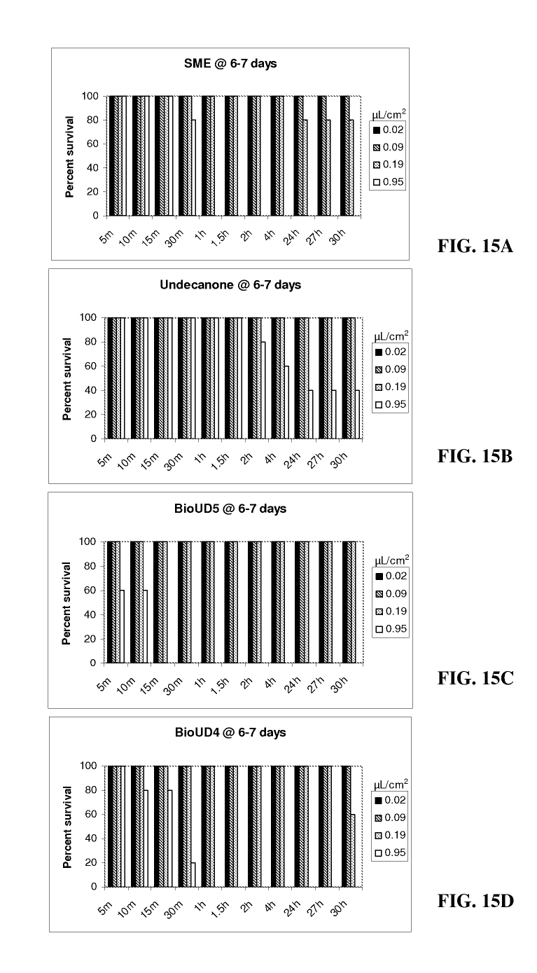

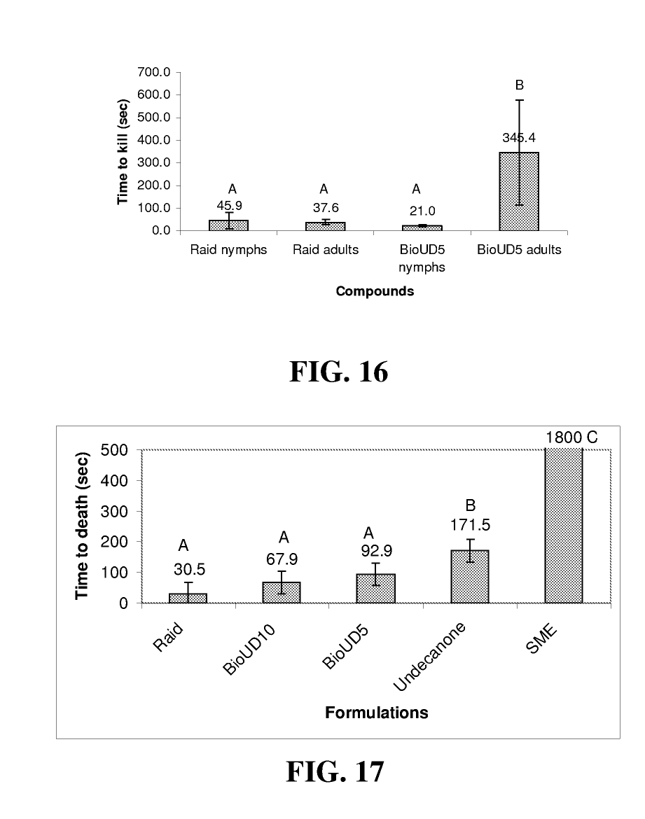

Table 22 clearly shows that only Raid® and BioUD™5 give reliable results for quick cockroach extermination. Sevin did not kill adult cockroaches at all, even after 3 days. FIG. 16 shows the mean and standard deviation for time to kill in four insecticidal treatments using Raid® and BioUD™5 on German cockroaches. Letters depict statistically significant differences (ANOVA) at the 5% level (however, doses are not comparable between adults and nymphs, because different volumes (10 and 5 μL) were used and weights were not taken).

Comparison of Insecticides Including BioUD™10

Ten μL of BioUD™10, pure Undecanone, or Raid® were separately applied to the backs (thorax and wings) of adult German cockroaches, Blattella germanica. Insects were separately placed into FLUON®-treated diet cups (Vol.=30 mL, lower diam.=3 cm, height=4 cm) to prevent escape of treated specimens. Table 23 shows the results.

TABLE 23
Time-to-death for adult male and female B. germanica after treatment with 10 μL of either
BioUD ™ 10, 2-Undecanone, or Raid ®.

| | Sex | Time-to-death | mean | st.dev. | mean | st.dev. |
|---|---|---|---|---|---|---|
| BioUD ™ 10 | F | 30 min | 20 min | 10 min 45 sec | 14 min 23 sec | 12 min |
| | F | 31 min 39 sec | | | | |
| | F | 14 min 35 sec | | | | |
| | F | 7 min 22 sec | | | | |
| | F | 26 min 48 sec | | | | |
| | F | 9 min 39 sec | | | | |
| | M | 1 min 25 sec | 3 min 9 sec | 1 min 42 sec | | |
| | M | 4 min 48 sec | | | | |
| | M | 3 min 15 sec | | | | |
| 2-Undecanone | F | 47 sec | 7 min 56 sec | 9 min 39 sec | 7 min 48 sec | 8 min 45 sec |
| | F | 4 min 38 sec | | | | |
| | F | 20 min 28 sec | | | | |
| | F | 46 sec | | | | |
| | F | 20 min | | | | |
| | F | 57 sec | | | | |
| | M | 13 min 22 sec | 7 min 24 sec | 8 min 26 sec | | |
| | M | 1 min 26 sec | | | | |
| Raid ® | F | 30 min | | | | |
| | F | 30 min | | | | |
| | F | 4 min 40 sec | | | | |
| | F | 3 min | | | | |
| | F | 3 min 47 sec | | | | |
| | F | 42 sec | | | | |
| | F | 3 min 45 sec | | | | |
| | M | 9 min | | | | |
| | M | 1 min 35 sec | | | | |
| | M | 30 min | | | | |

Direct Application Tests on Cockroach Nymphs

The cockroaches used in this test were German cockroaches, Blattella germanica which were of ages ranging from 10 days to 25 days old and were received from Benzon research on Jul. 17, 2007. The test was performed on Jul. 19, 2007 and the volume that was applied to the thorax and abdomen of each cockroach was 5 uL.

The method involved placing each cockroach individually in a 25 mL plastic medicine cup whose sides had been treated with Fluon®AD to prevent the cockroach from escaping. The formulation was then placed on the cockroach and the time until death was measured. Death was determined at the time when the cockroach was on its back with no movement of antennae, palpi, or legs after being touched with probe.

The following formulations were tested: (1) BioUD™8 (Soy Methyl Ester and undecanone) Spray, oil in water emulsion, (2) BioUD™30 Livestock and Textiles, Silicone version, no water, (3) BioUD™8, non-phytotoxic, and, (4) Soy Methyl Ester (SME). Water was used as a control.

The results from this test are summarized in Table 24 below.

TABLE 24

| | | | | | |
|---|---|---|---|---|---|
| | 1 | | 3 | 4 | |
| Cockroach | BioUD ™ 8, | 2 | BioUD ™ 8, | SME, | |
| Number | H₂O | BioUD ™ 30 | nphy | phytotoxic | H₂O (con) |

Time to death (seconds):

| | | | | | |
|---|---|---|---|---|---|
| 1 | 238 | 20 | 5400 | 46 | alive after 16 h |
| 2 | 105 | 20 | 5400 | 59 | alive after 16 h |
| 3 | 325 | 20 | 5400 | 60 | |
| 4 | 1980 | 20 | alive after 16 h | 60 | |
| 5 | 2760 | 20 | alive after 16 h | 377 | |
| 6 | | 27 | | 119 | |
| 7 | | 22 | | 218 | |
| 8 | | 20 | | 372 | |
| 9 | | 16 | | | |
| average (sec) | 1082 | 21 | 3/5 dead after | 164 | alive after 16 h |
| average | 18 min 2 sec | | 90 min | 2 min 44 sec | |

Differences in the above data may be partially due to size differences in the differentially aged cockroaches.

Cloth Treatment Toxicity Test

In this test the toxicity of each of the formulations listed below was tested by treating a 100% white cotton t-shirt with 200 microliters of each product. The shirt was then allowed to dry for two hours before 10 nymphal cockroaches were placed on the cloth for twenty fours hours to determine the toxicity of the cloth with the dried formulations. Each treatment was repeated three times.

The resullts of this experiment and the formulations examined are listed in Table 25 below, demonstrating a high mortality rate after 24 hours, with use of BioUD™30.

TABLE 25

| | | | | Ecologically |
|---|---|---|---|---|
| | Rep | Alive | Dead | Dead |
| Untreated | 1 | 10 | 0 | 0 |
| Untreated | 2 | 10 | 0 | 0 |
| Untreated | 3 | 10 | 0 | 0 |
| BioUD ™ 8 | 1 | 9 | 1 | 0 |
| BioUD ™ 8 | 2 | 10 | 0 | 0 |
| BioUD ™ 8 | 3 | 10 | 0 | 0 |
| BioUD ™ 30 | 1 | 7 | 3 | 0 |
| BioUD ™ 30 | 2 | 0 | 9 | 1 |
| BioUD ™ 30 | 3 | 0 | 6 | 4 |

### EXAMPLE 20

Termite Direct Application Test

In this test, in addition to water as a negative control, a positive control, in the form of the commercially available pesticide Raid® in also included. The method in this test simply involved pippetting 1 uL of the formulation onto the back or thorax of the Eastern subterranean termite, Reticulitermes flavipes, and recording the time to death. This test was performed on Mar. 13, 2007. The formulations used in the test were: (a) Raid®, a commercially available pesticide, (b) Undecanone, (c) BioUD™10, (d) BioUD™5, (e) Soy Methyl Ester (SME), and (f) water as a negative control.

The results of this test are summarized at Table 26, below.

TABLE 26

| | Time-to-death | | | |
|---|---|---|---|---|
| formulation | (sec) | mean | stderr | |
| Raid ® | 15 | 30.5 | 37 | A |
| Raid ® | 27 | | | |
| Raid ® | 28 | | | |
| Raid ® | 34 | | | |
| Raid ® | 38 | | | |
| Undecanone | 157 | 171.5 | 37 | B |
| Undecanone | 389 | | | |
| Undecanone | 68 | | | |
| Undecanone | 174 | | | |
| Undecanone | 146 | | | |
| BioUD ™ 10 | 68 | 67.9 | 37 | A |
| BioUD ™ 10 | 78 | | | |
| BioUD ™ 10 | 72 | | | |
| BioUD ™ 10 | 49 | | | |
| BioUD ™ 10 | 69 | | | |
| BioUD ™ 5 | 65 | 92.9 | 37 | A |
| BioUD ™ 5 | 58 | | | |
| BioUD ™ 5 | 59 | | | |
| BioUD ™ 5 | 85 | | | |
| BioUD ™ 5 | 119 | | | |
| SME | 1800 | 1800 | 40.5 | C |
| SME | 1800 | | | |
| SME | 1800 | | | |
| H₂O | alive after 3 h | | | |
| H₂O | alive after 3 h | | | |
| H₂O | alive after 3 h | | | |
| H₂O | alive after 3 h | | | |

FIG. 17 incorporates the data from Table 26 to show the average time to death in seconds of the termite following application of the various formulations and also to display the standard deviation of the repetitions of the experiment.

### EXAMPLE 21

Evaluation of Spider-Mite Mortality Via Slide Dip Assay

The slide dip assay is an accepted method for evaluation of the lethal effect of an insecticide. See J. R. Busvine, A Critical Review of the Techniques for Testing Insecticides, Commonwealth Agricultural Bureau, 1971, pp 345. In a slide dip assay, the insect to be tested is secured to a microscope slide via double sided tape, usually in a sufficient number for statistical analysis and the slide is then dipped into the insecticide at varying concentrations. The number of insects which survive and which are killed is recorded. The test included 10 spider mites (Tetranychus Urticae) per replicate with 5 replicates.

In this test, the lethality of various dilutions of BioUD™ 4% was analyzed via slide dip assay. The concentrations range from 1:100 to 1:400 with a water control as well as a water and lecithin control. The slides were dipped in the various dilutions for five seconds and then allowed to air dry before being analyzed at three hours and at six hours under the dissecting microscope to ascertain the number of mites which survived. For each dilution and for the controls, there were five repetitions performed. The results are summarized below in Table 27.

TABLE 27
Evaluation of BioUD ™ 4% on spider mite mortality

| | | Two spotted spider mites | | | |
|---|---|---|---|---|---|
| Treatment | Rep | # dead (3 hr) | # dead (6 hr) | % dead (3 hr) | % dead (6 hr) |
| Water | 1 | 1 | 1 | 10 | 10 |
| Water | 2 | 0 | 0 | 0 | 0 |
| Water | 3 | 0 | 0 | 0 | 0 |
| Water | 4 | 0 | 0 | 0 | 0 |
| Water | 5 | 1 | 1 | 10 | 10 |
| Control (water + lecithin) | 1 | 0 | 1 | 0 | 10 |
| Control (water + lecithin) | 2 | 1 | 1 | 10 | 10 |
| Control (water + lecithin) | 3 | 1 | 2 | 10 | 20 |
| Control (water + lecithin) | 4 | 3 | 4 | 30 | 40 |
| Control (water + lecithin) | 5 | 2 | 2 | 20 | 20 |
| Dil. 1:400 | 1 | 0 | 1 | 0 | 10 |
| Dil. 1:400 | 2 | 1 | 1 | 10 | 10 |
| Dil. 1:400 | 3 | 1 | 1 | 10 | 10 |
| Dil. 1:400 | 4 | 2 | 2 | 20 | 20 |
| Dil. 1:400 | 5 | 1 | 2 | 10 | 20 |
| Dil. 1:200 | 1 | 1 | 2 | 10 | 20 |
| Dil. 1:200 | 2 | 2 | 2 | 20 | 20 |
| Dil. 1:200 | 3 | 1 | 1 | 10 | 10 |
| Dil. 1:200 | 4 | 1 | 2 | 10 | 20 |
| Dil. 1:200 | 5 | 2 | 2 | 20 | 20 |
| Dil. 1:100 | 1 | 0 | 1 | 0 | 10 |
| Dil. 1:100 | 2 | 2 | 5 | 20 | 50 |
| Dil. 1:100 | 3 | 1 | 1 | 10 | 10 |
| Dil. 1:100 | 4 | 2 | 3 | 20 | 30 |
| Dil. 1:100 | 5 | 2 | 2 | 20 | 20 |

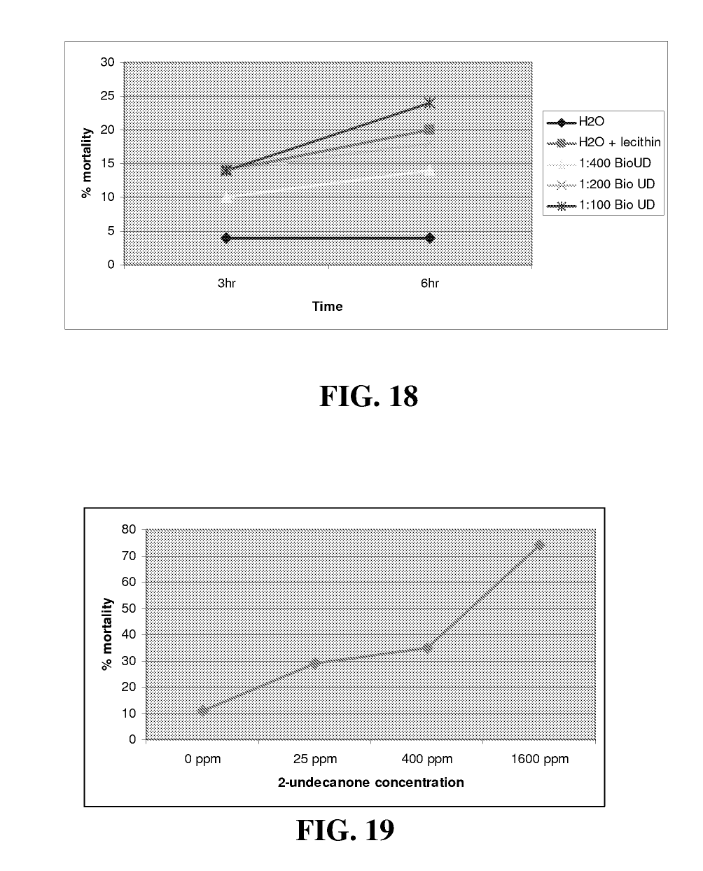

FIG. 18 incorporates the data from Table 27 to show the rise in mortality of the spider mites over the six hour period from the first dip of the slide to the six hour mark. All of the various formulations of the pesticide including the two controls are represented in FIG. 18.

### EXAMPLE 22

Evaluation of Lethal Effect of BioUD™4% With Silicone on Tobacco Aphids.

This test was performed via slide dip assay (see supra Busvine). Adult tobacco aphids, Myzus persicae, from a colony reared under greenhouse conditions on tobacco plants were used in this assay. Twenty tobacco aphids were placed dorsal side down over double sided tape on a microscope slide. The slides were dipped for five seconds in different concentrations of 2-undecanone (BioUD™) and then were allowed to dry for thirty minutes under laboratory conditions. The treatments were 0 ppm (deionized water), 25 ppm, 100 ppm and 400 ppm of 2-undecanone. Afterward, slides were placed inside a plastic container in a growth chamber at 27° C. and 95% relative humidity. After 24 hours the slides were observed under a dissecting scope to determine the mortality of tobacco aphids. At 24 hours, the percentage mortality of the tobacco aphids was 11, 29, 35 and 74% for 0, 25, 400, and 1600 ppm respectfully. The results from this experiment are summarized in FIG. 19.

FIG. 19 shows the percentage mortality of the adult tobacco aphid exposed to different 2-undecanone concentrations using BioUD™ 4% with silicone.

Evaluation of Lethal Effect of Other Formulations of BioUD™ on Tobacco Aphids.

An evaluation of lethal median concentrations (LC50) of other formulations of BioUD™ on tobacco aphids (Myzus persicae) was performed by employing an identical methodology as that followed in the above tobacco aphid experiment.

A slide dip assay (see supra Busvine) was used to estimate the lethal effect of two formulations of BioUD™, silicone and non-silicone. For each formulation, there were three different active ingredient concentrations (2-undecanone), BioUD™ 4%, BioUD™ 8% and BioUD™30%.

Adult apterous tobacco aphids from a colony reared under greenhouse conditions on tobacco plants were used in this assay. Twenty five tobacco aphids were placed dorsal side down over double sided tape on a microscope slide. Each treatment had five replicates. The slides were dipped for 5 sec. on different concentrations of BioUD™ and then were allowed to dry for one hour under laboratory conditions. Afterward, slides were placed inside a plastic container in a growth chamber at 27-28° C. and 65-95% relative humidity.

The treatments were BioUD™ 4, 8 and 30%, silicone and non-silicone formulation. BioUD™ silicone formulation was tested at different concentration solutions with the following dilution factors: 1:25, 1:100, 1:400 and 1:1600, and including a water control. BioUD™ non-silicone formulation was tested with the following dilution factors: 1:400, 1:1600, 1:6400 and 1:25600, and including a water control. After 24 hrs, slides were observed under a dissecting scope to determine the mortality of tobacco aphids.

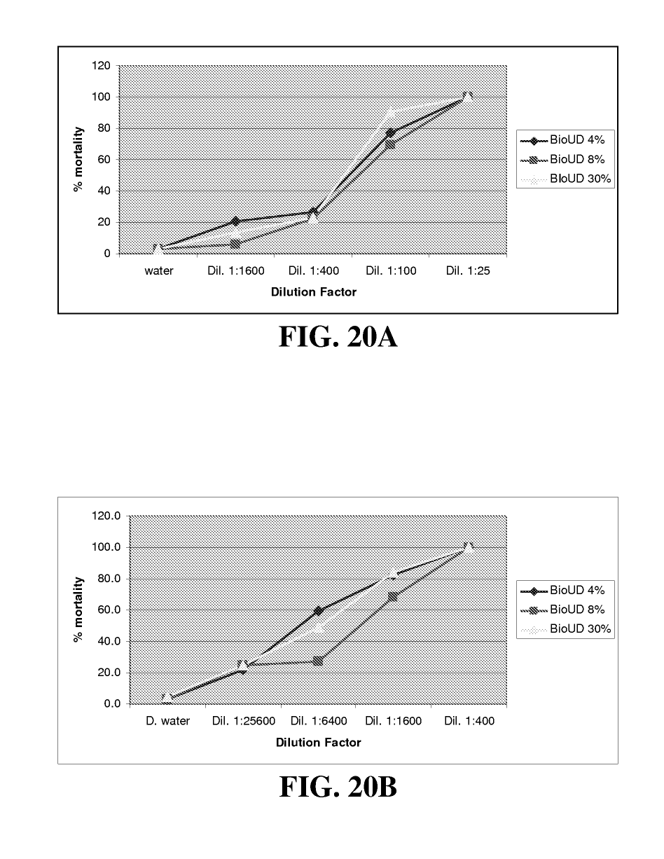

Extrapolating from those results obtained with BioUD™4%, FIG. 20 shows an estimation of the lethality of BioUD™8% and BioUD™30%.

After 24 hrs, the percentage mortality of adult tobacco aphids treated with BioUD™ 4, 8 and 30%, silicone formulation, were similar at the different dilutions used (FIG. 20A). Similar results were obtained using the non-silicone formulation (FIG. 20B). However, there is a difference in mortality between formulations, where non-silicone formulations causes mortality at lower concentrations than the silicone formulation.

### EXAMPLE 23

Treatment of Livestock Test to Evaluate Control of Flying Insects by Various Formulations.

The objective of this test was to evaluate the efficacy of the formulations in repelling flying insects from landing on and disturbing livestock. Ten animals were utilized for each treatment or control, with 120 cc/animal applied for each treatment. The experiment was performed by diluting the formulation to the appropriate concentration and spraying the formulation onto the livestock directly. One group had Ivermectin applied as a standard for comparison. Each group of animals was separated in the pasture by fencing. Counts were made immediately before treatments and then 1 day after treatment and 1 week after treatment. Every 2 weeks there was a retreatment and counts were repeated just prior to retreatment with same count cycle recurring through 2 week periods.

The flying insect evaluated was the Horn fly (Haematobia irritans). After application, the number of flies landing on the animals was recorded with the results summarized in Table 28 below.

One day after the initial treatment the fly numbers were very low (July 6), one week later repellency was holding up as expected (July 11) and two weeks after treatment the fly population recovered. The animals were treated again on July 19 (except ivermectin). July 20 repellency is evident but one week later the fly numbers had increased dramatically. Two weeks after treatment the fly densities had recovered and were growing. The cattle were treated on August 1, including the Ivermectin group. One day after treatment all the cattle looked pretty good relative to the control. During the course of the experiment there was no rain, just heat.

TABLE 28

| Average | 6-Jul | 11-Jul | 18-Jul | 20-Jul | 25-Jul | 31-Jul | 2-Aug | 8-Aug |
|---|---|---|---|---|---|---|---|---|
| UD30SilicNoH2O | 0.6 | 15.3 | 41.0 | 10.8 | 153.0 | 141.0 | 53.1 | 297.5 |
| CONTROL | 39.4 | 55.0 | 33.1 | 87.5 | 154.4 | 120.6 | 438.9 | 216.7 |
| BIOUD ™ 8- | 0.9 | 3.4 | 32.0 | 5.0 | 95.5 | 134.4 | 29.0 | 169.5 |
| OIL&H2O | | | | | | | | |
| IVERMECTIN | 2.4 | 2.7 | 41.4 | 54.5 | 82.7 | 185.9 | 4.8 | 62.0 |
| total flies | 368 | 905 | 2061 | 1531 | 7335 | 9049 | 5387 | 13400 |

### EXAMPLE 24

### Phytotoxicity

In this example the photoxicity of various dilutions of BioUD™ (Soy Methyl ester and undecanone) 4% were examined. Dilutions ranged from 1:400 down to 1:25 with a control and there were five repetitions carried out for each concentration. The results of the phytotoxicity assay are summarized in Table 29 below, with evaluations of phytotoxicity based on height of plants and browning of leaves. The plants utilized were bean plants.

TABLE 29
Preliminary evaluation of BioUD ™ 4%: phytotoxicity

| | | DAY 0 | | | | DAY 14 | |
|---|---|---|---|---|---|---|---|
| | | (May 03, 2007) | | | DAY 7 | (May 17, 2007) | |
| | | Length | Damage | Damage | (May 10, 2007) | | Fresh |
| Treatment | Rep | (cm) | (24 hr) | (48 hr) | Length (cm) | Length (cm) | weight |
| Control | 1 | 14.1 | yes | yes | 22.6 | 39.4 | 19.4 |
| Control | 2 | 10.3 | no | no | 19.8 | 31.1 | 11.11 |
| Control | 3 | 15.3 | no | no | 25.1 | 37.9 | 11.21 |
| Control | 4 | 16.7 | yes | yes | 27.1 | 35.9 | 13.24 |
| Control | 5 | 12.5 | no | no | 26.3 | 56.6 | 23.61 |
| Dil. 1:400 | 1 | 13.1 | no | no | 22.8 | 39.7 | 18.4 |
| Dil. 1:400 | 2 | 12.6 | no | no | 23.9 | 43.3 | 16.28 |
| Dil. 1:400 | 3 | 11.1 | no | no | 22.8 | 60.2 | 20.16 |
| Dil. 1:400 | 4 | 13.7 | no | no | 21.9 | 33.3 | 15.77 |
| Dil. 1:400 | 5 | 14.9 | no | no | 27.9 | 52.7 | 25.1 |
| Dil. 1:200 | 1 | 11.5 | no | no | 23.8 | 44.2 | 19.76 |
| Dil. 1:200 | 2 | 13.6 | no | no | 23.6 | 38.4 | 16.4 |
| Dil. 1:200 | 3 | 12.8 | no | no | 26.1 | 59.5 | 24.06 |
| Dil. 1:200 | 4 | 14.1 | no | no | 26.3 | 72.4 | 25.05 |
| Dil. 1:200 | 5 | 14.6 | no | yes | 25.4 | 40.4 | 17.45 |
| Dil. 1:100 | 1 | 13.2 | no | yes | 19.4 | 30.9 | 10.43 |
| Dil. 1:100 | 2 | 13.9 | yes | yes | 22.4 | 48.8 | 15.92 |
| Dil. 1:100 | 3 | 15.4 | yes | yes | 24.2 | 37.4 | 12.4 |
| Dil. 1:100 | 4 | 14.9 | yes | yes | 24.4 | 43.9 | 13.64 |
| Dil. 1:100 | 5 | 9.4 | yes | yes | 20.6 | 43 | 20.65 |
| Dil. 1:50 | 1 | 13.7 | yes | yes | 22.6 | 49.2 | 14.12 |
| Dil. 1:50 | 2 | 8.3 | yes | yes | 13.8 | 21.9 | 7.96 |
| Dil. 1:50 | 3 | 17.8 | yes | yes | 25.8 | 54.1 | 16.69 |
| Dil. 1:50 | 4 | 8.9 | yes | yes | 20.3 | 41.4 | 15.11 |
| Dil. 1:50 | 5 | 14.0 | yes | yes | 24.4 | 65.4 | 19.41 |
| Dil. 1:25 | 1 | 11.1 | yes | yes | 21.8 | 28.2 | 13.95 |
| Dil. 1:25 | 2 | 15.3 | yes | yes | 23.9 | 45.9 | 14.82 |
| Dil. 1:25 | 3 | 10.0 | yes | yes | 15.1 | 35.4 | 9.39 |
| Dil. 1:25 | 4 | 12.6 | yes | yes | 22 | 36.5 | 12.9 |
| Dil. 1:25 | 5 | 13.1 | yes | yes | 21.7 | 43 | 10.97 |

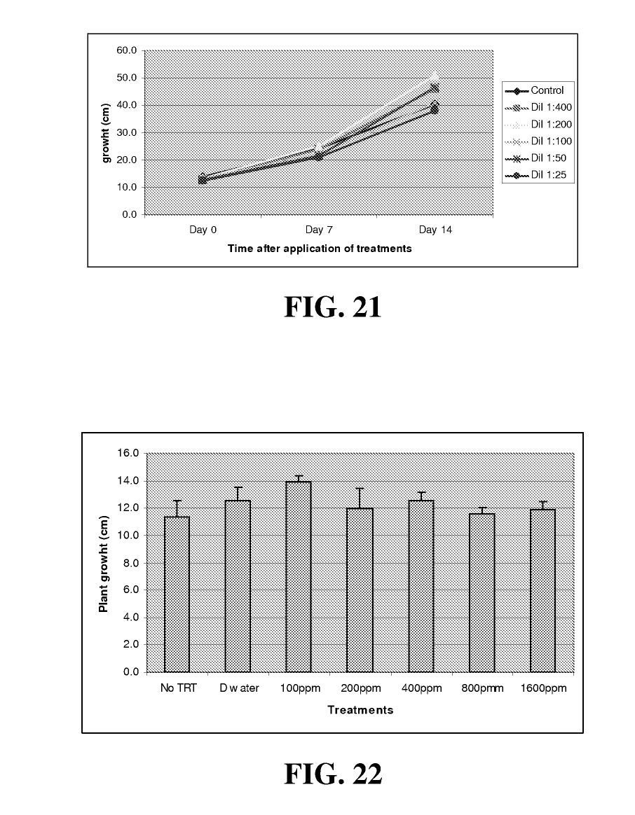

FIG. 21 incorporates the data from Table 29 and shows the phototoxicity of the BioUD™4% over the course of the two weeks of measurements. FIG. 21 demonstrates that with the application of a greater concentration of the BioUD™4%, a reduction in growth may occur.

Evaluation of BioUD™4% (Silicone) Phytotoxicity

One-week old bean plants (Phaseolus vulgaris) were used in this trial. The seeds were previously planted into 4-inch plastic pots with Metro Mix 200 growing media on Jun. 6, 2007 and placed under greenhouse conditions (Method Rd. Greenhouses, NCSU). The treatments were applied using a manual sprayer until runoff. The treatments were: 1) no treatment, 2) deionized water, 3) 100 ppm, 4) 200 ppm, 5) 400 ppm, 6) 800 ppm and 7) 1600 ppm of 2-undecanone (BioUD 4%), formulated with silicone. Each treatment was replicated five times.

After 24 and 48 hrs, plants were monitored to observe if the treatments cause any visible damage. Height measure was taken the day of the treatment application (Jun. 13, 2007) and after one week (Jun. 20, 2007), to determine the effect of 2-undecanone in plant growth in cm. Also, one week after treatment application the plants were harvested and taken into the laboratory (Deastyne Entomology Building, NCSU) to measure the fresh weight in grams. Data was analyzed with an analysis of variance (ANOVA) in the program Excel, Microsoft®.

After 24 and 48 hrs no damage (burned leaf areas) was observed in any of the treatments.

TABLE 30

| | | DAY 0 (Jun. 13, 2007) | | | DAY 7 (Jun. 20, 2007) | | |
|---|---|---|---|---|---|---|---|
| Treatment | Rep | Height (cm) | Damage (24 hr) | Damage (48 hr) | Height (cm) | Fresh weight | Height Difference |
| No TRT | 1 | 15.5 | no | no | 27.6 | 8.11 | 12.1 |
| No TRT | 2 | 13 | no | no | 20.1 | 4.55 | 7.1 |
| No TRT | 3 | 10.1 | no | no | 23.7 | 7.5 | 13.6 |
| No TRT | 4 | 12.5 | no | no | 25.9 | 9.88 | 13.4 |
| No TRT | 5 | 12.2 | no | no | 22.8 | 6.97 | 10.6 |
| D water | 1 | 12.4 | no | no | 22.0 | 7.86 | 9.6 |
| D water | 2 | 9.6 | no | no | 23.7 | 8.85 | 14.1 |
| D water | 3 | 11.1 | no | no | 24.9 | 7.53 | 13.8 |
| D water | 4 | 10.1 | no | no | 24.6 | 9.56 | 14.5 |
| D water | 5 | 12.6 | no | no | 23.2 | 6.56 | 10.6 |
| Dil. 1:400 | 1 | 10.8 | no | no | 23.1 | 6.04 | 12.3 |
| Dil. 1:400 | 2 | 16.1 | no | no | 29.8 | 8.99 | 13.7 |
| Dil. 1:400 | 3 | 15.0 | no | no | 30.6 | 10.29 | 15.6 |
| Dil. 1:400 | 4 | 11.8 | no | no | 25.7 | 10.11 | 13.9 |
| Dil. 1:400 | 5 | 9.9 | no | no | 23.7 | 8.2 | 13.8 |
| Dil. 1:200 | 1 | 12.4 | no | no | 26.9 | 8.37 | 14.5 |
| Dil. 1:200 | 2 | 9.9 | no | no | 16.8 | 3.7 | 6.9 |
| Dil. 1:200 | 3 | 10.2 | no | no | 22.7 | 5.51 | 12.5 |
| Dil. 1:200 | 4 | 9.8 | no | no | 24.7 | 8.86 | 14.9 |
| Dil. 1:200 | 5 | 9.0 | no | no | 20.1 | 6.39 | 11.1 |
| Dil. 1:100 | 1 | 14.6 | no | no | 27.8 | 10.42 | 13.2 |
| Dil. 1:100 | 2 | 9.4 | no | no | 23.0 | 7.09 | 13.6 |
| Dil. 1:100 | 3 | 9.3 | no | no | 20.5 | 4.27 | 11.2 |
| Dil. 1:100 | 4 | 10.6 | no | no | 24.2 | 9.19 | 13.6 |
| Dil. 1:100 | 5 | 11.2 | no | no | 22.3 | 6.67 | 11.1 |
| Dil. 1:50 | 1 | 9.4 | no | no | 21.8 | 7.29 | 12.4 |
| Dil. 1:50 | 2 | 11.3 | no | no | 21.2 | 4.26 | 9.9 |
| Dil. 1:50 | 3 | 16.1 | no | no | 28.5 | 8.71 | 12.4 |
| Dil. 1:50 | 4 | 11.8 | no | no | 23.6 | 9.74 | 11.8 |
| Dil. 1:50 | 5 | 14.5 | no | no | 25.8 | 10.22 | 11.3 |
| Dil. 1:25 | 1 | 11.8 | no | no | 23.6 | 8.55 | 11.8 |
| Dil. 1:25 | 2 | 9.9 | no | no | 19.8 | 4.97 | 9.9 |
| Dil. 1:25 | 3 | 11.9 | no | no | 23.3 | 7.92 | 11.4 |
| Dil. 1:25 | 4 | 10.1 | no | no | 22.7 | 6.93 | 12.6 |
| Dil. 1:25 | 5 | 12.5 | no | no | 26.1 | 11.58 | 13.6 |

TABLE 31

| | | | | | STD |
|---|---|---|---|---|---|
| MEANS | Day 0 | Day 7 | Difference | STD dev | error |
| No TRT | 12.66 | 24.0 | 11.4 | 2.667021 | 1.192728 |
| D water | 11.16 | 23.7 | 12.5 | 2.251 | 1.006678 |
| 100 ppm | 12.7 | 26.6 | 13.9 | 1.171751 | 0.524023 |
| 200 ppm | 10.3 | 22.2 | 12.0 | 3.229861 | 1.444438 |
| 400 ppm | 11.0 | 23.6 | 12.5 | 1.279844 | 0.572364 |
| 800 pmm | 12.6 | 24.2 | 11.6 | 1.051913 | 0.47043 |
| 1600 ppm | 11.2 | 23.1 | 11.9 | 1.381304 | 0.617738 |

TABLE 32
Weight evaluations
SUMMARY

| Groups | Count | Sum | Average | Variance | STD dev | STD error |
|---|---|---|---|---|---|---|
| No TRT | 5 | 37.01 | 7.402 | 3.74297 | 1.934675683 | 0.865213269 |
| D water | 5 | 40.36 | 8.072 | 1.36107 | 1.166649047 | 0.521741315 |
| Dil. 1:400 | 5 | 43.63 | 8.726 | 2.98063 | 1.726450115 | 0.772091963 |
| Dil. 1:200 | 5 | 32.83 | 6.566 | 4.46923 | 2.114055345 | 0.945434292 |
| Dil. 1:100 | 5 | 37.64 | 7.528 | 5.66712 | 2.38057136 | 1.064623877 |
| Dil. 1:50 | 5 | 40.22 | 8.044 | 5.73553 | 2.394896657 | 1.071030345 |
| Dil. 1:25 | 5 | 39.95 | 7.99 | 5.86265 | 2.421290978 | 1.082834244 |

TABLE 33
Weight evaluations

| Source of | | | | | | |
|---|---|---|---|---|---|---|
| Variation | SS | df | MS | F | P-value | F crit |
| Between | 13.85835 | 6 | 2.309725714 | 0.542203681 | 0.771583877 | 2.445259395 |
| Groups | | | | | | |
| Within Groups | 119.2768 | 28 | 4.259885714 | | | |
| Total | 133.1352 | 34 | | | | |

TABLE 34
Height evaluations
SUMMARY

| Groups | Count | Sum | Average | Variance |
|---|---|---|---|---|
| No TRT | 5 | 56.8 | 11.36 | 7.113 |
| D water | 5 | 62.6 | 12.52 | 5.067 |
| Dil. 1:400 | 5 | 69.3 | 13.86 | 1.373 |
| Dil. 1:200 | 5 | 59.9 | 11.98 | 10.432 |
| Dil. 1:100 | 5 | 62.7 | 12.54 | 1.638 |
| Dil. 1:50 | 5 | 57.76 | 11.552 | 1.10652 |
| Dil. 1:25 | 5 | 59.3 | 11.86 | 1.908 |

TABLE 35
Height evaluations

| Source of | | | | | | |
|---|---|---|---|---|---|---|
| Variation | SS | df | MS | F | P-value | F crit |
| Between | 21.26267 | 6 | 3.543779 | 0.866222 | 0.531619 | 2.445259 |
| Groups | | | | | | |
| Within Groups | 114.5501 | 28 | 4.091074 | | | |
| Total | 135.8128 | 34 | | | | |

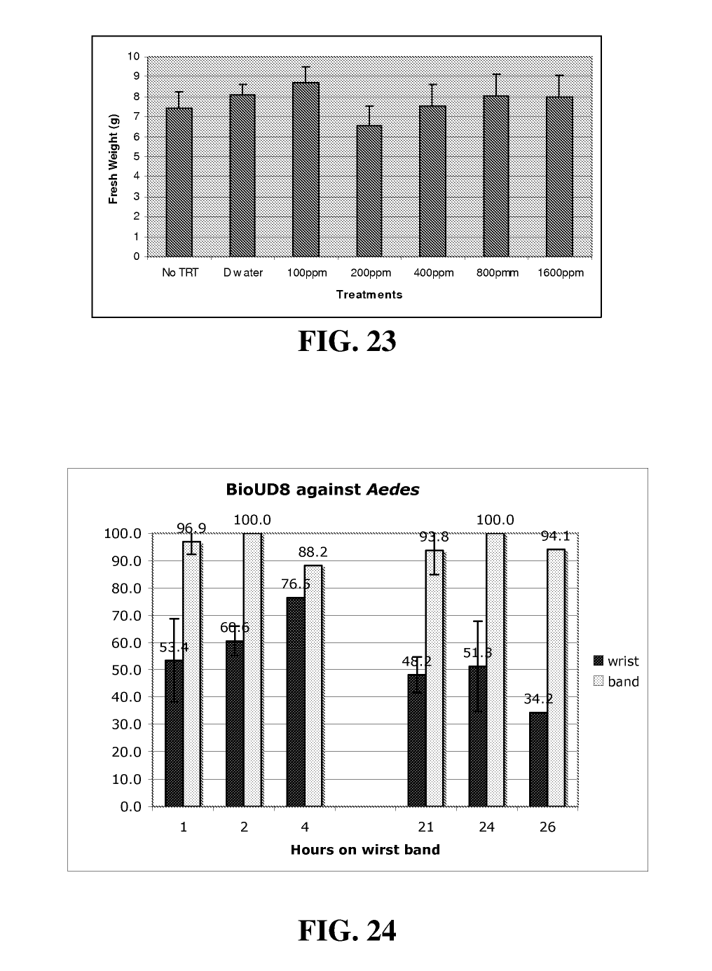

There was no significant effect of BioUD 4% (2-undecanone) evaluated concentrations on the growth (in cm) of bean plants (F=0.8662, P=0.5316) (FIG. 22). Moreover, there was no significant effect (F=0.5422, P=0.7716) on the fresh weight (in g) of two-week old bean plants treated with various concentrations of BioUD 4% (2-undecanone) (FIG. 23).

### EXAMPLE 25

### Ant Studies

Studies were performed in order to determine the efficacy of various treatments, as compared to control studies, on nests of moisture ants and carpenter ants.

The study was conducted on a grass lawn bordering a large mixed deciduous/coniferous woodlot (e.g. maples, poplars, birch, tamarack, white cedar, and white pine are predominant species) with secondary growth under the canopy in a rural area four km south of the southern city limit of Guelph, Ontario. Adjacent to the study area was a cattail marsh (>four hectares) approximately 30 meters from the center of the study area.

Prior to the start of the test, ant nests were located at the study site. Each nest was marked with a numbered stake and ants were collected from each nest. Ants were frozen and subsequently identified. Tests were conducted on 5 nests of each type of ant.

Observations were made at 36 (am), 24 (pm) and 12 (am) hours pre-treatment, at time of treatment (pm) and at 12(am), 24 (pm), 36 (am), 48 (pm), 60 (am), 72 (3 days; pm), 156 (6½ days; am) and 168 (7 days; pm) hours post-treatment.

An observation consisted of a 5 minute count per nest at each time of the day. The number of ants entering and leaving the nest was counted or estimated and at the end of the 5 minute count, activity was rated on a scale of 0-5. The rating scale used was as follows:
0 ants=0
1-5 ants=1
6-20 ants=2
21-50 ants=3
51-75 ants=4
>76 ants=5

Actual counts of ants were made, in addition to ratings, beginning on day of treatment.

Treatments were made by spraying the nests directly. Aerosol cans were shaken thoroughly, then turned upside-down and the straw applicator was inserted into the largest nest opening. The spray was discharged for 10 seconds.

Results of the treatments are as set forth below in Tables 36-47. In these tables, the following abbreviations/designations are also utilized:

M=Moisture ant; C=Carpenter ant

First number of “nest”=Rep; Last number of “nest”=Treatment (Treatment 1=Control;

Treatment 2=BioBlock® Pest Control; Treatment 3=BioUD™8% oil in water)

TABLE 36
Observations at −36 hours prior to treatment

| Moisture ants | | | | Carpenter ants | | | |
|---|---|---|---|---|---|---|---|
| | | | Treatment | | | | Treatment |
| | | Actual # | (Avg Rating/Avg # | | | Actual # | (Avg Rating/Avg |
| Nest | Rating | of Ants | Ants) | Nest | Rating | of Ants | # Ants) |
| M101 | 2 | nd | Control (2.2/nd)) | C101 | 3 | nd | Control (2.6/nd)) |
| M201 | 2 | nd | | C201 | 2 | nd | |
| M301 | 3 | nd | | C301 | 2 | nd | |
| M401 | 2 | nd | | C401 | 3 | nd | |
| M501 | 2 | nd | | C501 | 3 | nd | |
| M102 | 3 | nd | BioBlock ®(2.2/nd) | C102 | 1 | nd | BioBlock ®(1.6/nd) |
| M202 | 2 | nd | | C202 | 3 | nd | |
| M302 | 2 | nd | | C302 | 2 | nd | |
| M402 | 2 | nd | | C402 | 1 | nd | |
| M502 | 2 | nd | | C502 | 1 | nd | |
| M103 | 1 | nd | BioUD ™ 8 (2/nd) | C103 | 1 | nd | BioUD ™ 8 (2/nd) |
| M203 | 2 | nd | | C203 | 3 | nd | |
| M303 | 2 | nd | | C303 | 1 | nd | |
| M403 | 2 | nd | | C403 | 2 | nd | |
| M503 | 3 | nd | | C503 | 3 | nd | |

TABLE 37
Observations at −24 hours prior to treatment

| Moisture ants | | | | Carpenter ants | | | |
|---|---|---|---|---|---|---|---|
| | | | Treatment | | | | Treatment |
| | | Actual # | (Avg Rating/Avg | | | Actual # | (Avg Rating/Avg |
| Nest | Rating | of Ants | # Ants) | Nest | Rating | of Ants | # Ants) |
| M101 | 3 | nd | Control (2.4/nd) | C101 | 2 | nd | Control (1.8/nd) |
| M201 | 2 | nd | | C201 | 3 | nd | |
| M301 | 3 | nd | | C301 | 0 | nd | |
| M401 | 2 | nd | | C401 | 1 | nd | |
| M501 | 2 | nd | | C501 | 3 | nd | |
| M102 | 2 | nd | BioBlock ®(2/nd) | C102 | 1 | nd | BioBlock ®(1.2/nd) |
| M202 | 1 | nd | | C202 | 2 | nd | |
| M302 | 2 | nd | | C302 | 2 | nd | |
| M402 | 2 | nd | | C402 | 1 | nd | |
| M502 | 3 | nd | | C502 | 0 | nd | |
| M103 | 3 | nd | BioUD ™ 8 | C103 | 1 | nd | BioUD ™ 8 |
| M203 | 2 | nd | (2.2/nd) | C203 | 1 | nd | (1.2/nd) |
| M303 | 2 | nd | | C303 | 0 | nd | |
| M403 | 2 | nd | | C403 | 3 | nd | |
| M503 | 2 | nd | | C503 | 1 | nd | |

TABLE 38
Observations at −12 hours prior to treatment

| Moisture ants | | | | Carpenter ants | | | |
|---|---|---|---|---|---|---|---|
| | | | Treatment | | | | Treatment |
| | | Actual # | (Avg Rating/Avg | | | Actual # | (Avg Rating/Avg |
| Nest | Rating | of Ants | # Ants) | Nest | Rating | of Ants | # Ants) |
| M101 | 2 | nd | Control (1.6/nd) | C101 | 2 | nd | Control (2.4/nd)) |
| M201 | 1 | nd | | C201 | 3 | nd | |
| M301 | 3 | nd | | C301 | 1 | nd | |
| M401 | 1 | nd | | C401 | 3 | nd | |
| M501 | 1 | nd | | C501 | 3 | nd | |
| M102 | 1 | nd | BioBlock ®(1.2/nd) | C102 | 1 | nd | BioBlock ®(1.8/nd) |
| M202 | 1 | nd | | C202 | 2 | nd | |
| M302 | 1 | nd | | C302 | 2 | nd | |
| M402 | 2 | nd | | C402 | 1 | nd | |
| M502 | 1 | nd | | C502 | 3 | nd | |
| M103 | 2 | nd | BioUD ™ 8 | C103 | 2 | nd | BioUD ™ 8 |
| M203 | 1 | nd | (1.6/nd) | C203 | 2 | nd | (2.2/nd) |
| M303 | 1 | nd | | C303 | 3 | nd | |
| M403 | 2 | nd | | C403 | 3 | nd | |
| M503 | 2 | nd | | C503 | 1 | nd | |

TABLE 39
Observations at 0 hours - Treatment

| Moisture ants | | | | Carpenter ants | | | |
|---|---|---|---|---|---|---|---|
| | | | Treatment | | | | Treatment |
| | | Actual # | (Avg Rating/Avg # | | | Actual # | (Avg Rating/Avg # |
| Nest | Rating | of Ants | Ants) | Nest | Rating | of Ants | Ants) |
| M101 | 3 | nd | Control (2.4/nd)) | C101 | 2 | nd | Control (2.2/nd) |
| M201 | 2 | nd | | C201 | 3 | nd | |
| M301 | 3 | nd | | C301 | 1 | nd | |
| M401 | 2 | nd | | C401 | 2 | nd | |
| M501 | 2 | nd | | C501 | 3 | nd | |
| M102 | 2 | nd | BioBlock ®(2.2/nd) | C102 | 3 | nd | BioBlock ®(2/nd) |
| M202 | 2 | nd | | C202 | 3 | nd | |
| M302 | 2 | nd | | C302 | 1 | nd | |
| M402 | 2 | nd | | C402 | 1 | nd | |
| M502 | 3 | nd | | C502 | 2 | nd | |
| M103 | 3 | nd | BioUD ™ 8 | C103 | 1 | nd | BioUD ™ 8 (2/nd) |
| M203 | 2 | nd | (2.6/nd) | C203 | 3 | nd | |
| M303 | 3 | nd | | C303 | 2 | nd | |
| M403 | 2 | nd | | C403 | 3 | nd | |
| M503 | 3 | nd | | C503 | 1 | nd | |

TABLE 40
Observations at +12 hours post-treatment

| Moisture ants | | | | Carpenter ants | | | |
|---|---|---|---|---|---|---|---|
| | | | Treatment | | | | Treatment |
| | | Actual # | (Avg Rating/Avg # | | | Actual # | (Avg Rating/Avg # |
| Nest | Rating | of Ants | Ants) | Nest | Rating | of Ants | Ants) |
| M101 | 3 | 28 | Control (2.2/14.6) | C101 | 2 | 7 | Control (2.8/25)) |
| M201 | 2 | 10 | | C201 | 3 | 31 | |
| M301 | 2 | 15 | | C301 | 2 | 11 | |
| M401 | 2 | 16 | | C401 | 3 | 21 | |
| M501 | 1 | 4 | | C501 | 4 | 55 | |
| M102 | 1 | 1 | BioBlock ®(0.4/0.8) | C102 | 0 | 0 | BioBlock ®(0.2/0.2) |
| M202 | 0 | 0 | | C202 | 0 | 0 | |
| M302 | 0 | 0 | | C302 | 0 | 0 | |
| M402 | 0 | 1 | | C402 | 0 | 0 | |
| M502 | 1 | 2 | | C502 | 1 | 1 | |
| M103 | 0 | 0 | BioUD ™ 8 | C103 | 0 | 0 | BioUD ™ 8 |
| M203 | 0 | 0 | (0.2/0.4) | C203 | 0 | 0 | (0.4/0.8) |
| M303 | 0 | 0 | | C303 | 1 | 2 | |
| M403 | 1 | 2 | | C403 | 1 | 2 | |
| | | | | C503 | 0 | 0 | |

TABLE 41
Observations at +24 hours post-treatment

| Moisture ants | | | | Carpenter ants | | | |
|---|---|---|---|---|---|---|---|
| | | | Treatment | | | | Treatment |
| | | Actual # | (Avg Rating/Avg # | | | Actual # | (Avg Rating/Avg # |
| Nest | Rating | of Ants | Ants) | Nest | Rating | of Ants | Ants) |
| M101 | 3 | 28 | Control (2.6/19.2) | C101 | 2 | 13 | Control (2/13.6) |
| M201 | 3 | 21 | | C201 | 2 | 16 | |
| M301 | 2 | 13 | | C301 | 1 | 1 | |
| M401 | 3 | 22 | | C401 | 2 | 15 | |
| M501 | 2 | 12 | | C501 | 3 | 23 | |
| M102 | 0 | 0 | BioBlock ®(0.4/1.2) | C102 | 0 | 0 | BioBlock ®(0.2/0.2) |
| M202 | 1 | 1 | | C202 | 0 | 0 | |
| M302 | 0 | 0 | | C302 | 1 | 1 | |
| M402 | 0 | 0 | | C402 | 0 | 0 | |
| M502 | 1 | 5 | | C502 | 0 | 0 | |
| M103 | 0 | 0 | BioUD ™ 8 | C103 | 0 | 0 | BioUD ™ 8 |
| M203 | 1 | 3 | (0.8/2.2) | C203 | 0 | 0 | (0.2/0.6) |
| M303 | 1 | 2 | | C303 | 0 | 0 | |
| M403 | 1 | 4 | | C403 | 1 | 3 | |
| M503 | 1 | 2 | | C503 | 0 | 0 | |

TABLE 42
Observations at +36 hours post-treatment

| Moisture ants | | | | Carpenter ants | | | |
|---|---|---|---|---|---|---|---|
| | | | Treatment | | | | Treatment |
| | | Actual # | (Avg Rating/Avg # | | | Actual # | (Avg Rating/Avg # |
| Nest | Rating | of Ants | Ants) | Nest | Rating | of Ants | Ants) |
| M101 | 3 | 44 | Control (2.6/26.6) | C101 | 2 | 8 | Control (2/14.8) |
| M201 | 2 | 17 | | C201 | 2 | 16 | |
| M301 | 3 | 21 | | C301 | 1 | 4 | |
| M401 | 3 | 34 | | C401 | 2 | 11 | |
| M501 | 2 | 17 | | C501 | 3 | 35 | |
| M102 | 1 | 1 | BioBlock ®(1/4) | C102 | 0 | 0 | BioBlock ®(0.6/1) |
| M202 | 1 | 1 | | C202 | 1 | 1 | |
| M302 | 0 | 0 | | C302 | 1 | 3 | |
| M402 | 1 | 3 | | C402 | 0 | 0 | |
| M502 | 2 | 15 | | C502 | 1 | 1 | |
| M103 | 0 | 0 | BioUD ™ 8 | C103 | 0 | 0 | BioUD ™ 8 |
| M203 | 1 | 2 | (1.2/6.2) | C203 | 0 | 0 | (0.4/1.4) |
| M303 | 1 | 2 | | C303 | 0 | 0 | |
| M403 | 2 | 19 | | C403 | 2 | 7 | |
| M503 | 2 | 8 | | C503 | 0 | 0 | |

TABLE 43
Observations at +48 hours post-treatment

| Moisture ants | | | | Carpenter ants | | | |
|---|---|---|---|---|---|---|---|
| | | | Treatment | | | | Treatment |
| | | Actual # | (Avg Rating/Avg # | | | Actual # | (Avg Rating/Avg # |
| Nest | Rating | of Ants | Ants) | Nest | Rating | of Ants | Ants) |
| M101 | 2 | 18 | Control (1.75/11.5) | C101 | 2 | 14 | Control (2.2/14.6) |
| M201 | dropped due to | | | C201 | 2 | 17 | |
| | nest flooded in rain | | | | | | |
| M301 | 2 | 6 | | C301 | 2 | 7 | |
| M401 | 2 | 13 | | C401 | 2 | 7 | |
| M501 | 1 | 9 | | C501 | 3 | 28 | |
| M102 | 0 | 0 | BioBlock ®(0.4/1.2) | C102 | 0 | 0 | BioBlock ®(0.4/0.6) |
| M202 | 1 | 4 | | C202 | 1 | 2 | |
| M302 | 0 | 0 | | C302 | 1 | 1 | |
| M402 | 1 | 2 | | C402 | 0 | 0 | |
| M502 | 0 | 0 | | C502 | 0 | 0 | |
| M103 | 1 | 2 | BioUD ™ 8 | C103 | 0 | 0 | BioUD ™ 8 (0/0) |
| M203 | 0 | 0 | (0.4/0.8) | C203 | 0 | 0 | |
| M303 | 0 | 0 | | C303 | 0 | 0 | |
| M403 | 0 | 0 | | C403 | 0 | 0 | |
| M503 | 1 | 2 | | C503 | 0 | 0 | |

TABLE 44
Observations at +60 hours post-treatment

| Moisture ants | | | | Carpenter ants | | | |
|---|---|---|---|---|---|---|---|
| | | | Treatment | | | | Treatment |
| | | Actual # | (Avg Rating/Avg # | | | Actual # | (Avg Rating/Avg # |
| Nest | Rating | of Ants | Ants) | Nest | Rating | of Ants | Ants) |
| M101 | 2 | 11 | Control (2/10.5) | C101 | 2 | 12 | Control (2.2/17.8) |
| M201 | dropped due to | | | C201 | 3 | 25 | |
| | nest flooded in rain | | | | | | |
| M301 | 2 | 16 | | C301 | 2 | 6 | |
| M401 | 2 | 7 | | C401 | 1 | 4 | |
| M501 | 2 | 8 | | C501 | 3 | 42 | |
| M102 | 0 | 0 | BioBlock ®(0.6/1.6) | C102 | 0 | 0 | BioBlock ®(0.4/1.2) |
| M202 | 0 | 0 | | C202 | 1 | 5 | |
| M302 | 1 | 1 | | C302 | 1 | 1 | |
| M402 | 0 | 0 | | C402 | 0 | 0 | |
| M502 | 2 | 7 | | C502 | 0 | 0 | |
| M103 | 1 | 1 | BioUD ™ 8 | C103 | 0 | 0 | BioUD ™ 8 |
| M203 | 2 | 6 | (1.2/3.6) | C203 | 1 | 1 | (0.8/1.6) |
| M303 | 0 | 0 | | C303 | 1 | 1 | |
| M403 | 1 | 5 | | C403 | 2 | 6 | |
| M503 | 2 | 6 | | C503 | 0 | 0 | |

TABLE 45
Observations at +72 hours post-treatment

| Moisture ants | | | | Carpenter ants | | | |
|---|---|---|---|---|---|---|---|
| | | | Treatment | | | | Treatment |
| | | Actual # | (Avg Rating/Avg # | | | Actual # | (Avg Rating/Avg # |
| Nest | Rating | of Ants | Ants) | Nest | Rating | of Ants | Ants) |
| M101 | 4 | 52 | Control (2.4/21) | C101 | 2 | 9 | Control (2/13.2) |
| M201 | 2 | 8 | | C201 | 3 | 22 | |
| M301 | 2 | 17 | | C301 | 1 | 1 | |
| M401 | 2 | 8 | | C401 | 1 | 3 | |
| M501 | 2 | 20 | | C501 | 3 | 31 | |
| M102 | 0 | 0 | BioBlock ®(0.8/2.2) | C102 | 0 | 0 | BioBlock ®(0.2/0.2) |
| M202 | 1 | 1 | | C202 | 1 | 1 | |
| M302 | 0 | 0 | | C302 | 0 | 0 | |
| M402 | 1 | 1 | | C402 | 0 | 0 | |
| M502 | 2 | 9 | | C502 | 0 | 0 | |
| M103 | 1 | 1 | BioUD ™ 8 (1.4/5) | C103 | 0 | 0 | BioUD ™ 8 |
| M203 | 1 | 3 | | C203 | 1 | 1 | (0.4/0.6) |
| M303 | 2 | 8 | | C303 | 0 | 0 | |
| M403 | 2 | 12 | | C403 | 1 | 2 | |
| M503 | 1 | 1 | | C503 | 0 | 0 | |

TABLE 46
Observations at +156 hours post-treatment

| | | | |
|---|---|---|---|
| | | | Treatment |
| | | Actual # | (Avg Rating/Avg # |
| Nest | Rating | of Ants | Ants) |

Moisture ants

| | | | |
|---|---|---|---|
| M101 | 2 | 19 | Control (2/13.8) |
| M201 | 2 | 16 | |
| M301 | 1 | 2 | |
| M401 | 3 | 23 | |
| M501 | 2 | 9 | |
| M102 | 0 | 0 | BioBlock ®(0.4/0.6) |
| M202 | 0 | 0 | |
| M302 | 1 | 1 | |
| M402 | 1 | 2 | |
| M502 | 0 | 0 | |
| M103 | 1 | 3 | BioUD ™ 8 |
| M203 | 0 | 0 | (0.8/2.6) |
| M303 | 1 | 4 | |
| M403 | 1 | 5 | |
| M503 | 1 | 1 | |

Carpenter ants

| | | | |
|---|---|---|---|
| C101 | 2 | 15 | Control (2.4/19.4) |
| C201 | 2 | 11 | |
| C301 | 2 | 6 | |
| C401 | 2 | 8 | |
| C501 | 4 | 57 | |
| C102 | 0 | 0 | BioBlock ®(0.2/0.4) |
| C202 | 0 | 0 | |
| C302 | 1 | 2 | |
| C402 | 0 | 0 | |
| C502 | 0 | 0 | |
| C103 | 0 | 0 | BioUD ™ 8 |
| C203 | 0 | 0 | (0.2/0.2) |
| C303 | 0 | 0 | |
| C403 | 1 | 1 | |
| C503 | 0 | 0 | |

TABLE 47
Observations at +168 hours post-treatment

| | | | |
|---|---|---|---|
| | | | Treatment |
| | | Actual # | (Avg Rating/Avg # |
| Nest | Rating | of Ants | Ants) |

Moisture ants

| | | | |
|---|---|---|---|
| M101 | 3 | 31 | Control (2.2/17.2) |
| M201 | 1 | 4 | |
| M301 | 3 | 21 | |
| M401 | 2 | 16 | |
| M501 | 2 | 14 | |
| M102 | 0 | 0 | BioBlock ®(0.6/0.8) |
| M202 | 0 | 0 | |
| M302 | 1 | 1 | |
| M402 | 1 | 2 | |
| M502 | 1 | 1 | |
| M103 | 0 | 0 | BioUD ™ 8 (0.4/1) |
| M203 | 0 | 2 | |
| M303 | 0 | 0 | |
| M403 | 1 | 2 | |
| M503 | 1 | 1 | |

Carpenter ants

| | | | |
|---|---|---|---|
| C101 | 1 | 4 | Control (2.2/14.4) |
| C201 | 3 | 23 | |
| C301 | 2 | 6 | |
| C401 | 2 | 6 | |
| C501 | 3 | 33 | |
| C102 | 1 | 1 | BioBlock ®(0.4/0.4) |
| C202 | 0 | 0 | |
| C302 | 1 | 1 | |
| C402 | 0 | 0 | |
| C502 | 0 | 0 | |
| C103 | 0 | 0 | BioUD ™ 8 (0/0) |
| C203 | 0 | 0 | |
| C303 | 0 | 0 | |
| C403 | 0 | 0 | |
| C503 | 0 | 0 | |

### EXAMPLE 26

Tests were performed using various pests/insects, with varying formulations. Tests and results are summarized in Table 48 below:

TABLE 48

| | TREATMENT | |
|---|---|---|
| PEST/INSECT | FORMULATION | Test Method/Observation |
| Fire Ants (Red | BioUD ™ 8 oil in water | Ants entering area, Sprayed area including direct |
| Imported species | (Phytotoxic) | contact to ants. Ants that were sprayed dispersed |
| Solenopsis invicta) | | immediately and within 5 minutes died in the area. |
| | | No further ants traveled through the area for 30 days. |
| | | After 30 days, new travel path for ants entering area. |
| | | Repeated spray and the same results observed |
| | | previously. Repeated a third time with the same |
| | | results observed. |
| Fire Ants (Red | BioUD ™ 8 oil in water | Ant mound observed where the source of the ants |
| Imported species | (Phytotoxic) | from above. The ant mound was drenched with |
| Solenopsis invicta) | | product and no further ant activity was seen (no ants |
| | | observed for 1 year from location nor any other |
| | | mounds formed in the immediate area). |
| Common | Bio Block ® Pest Control | Two adjacent kitchen countertops infested with Ants. |
| Household Ants | (non-phytotoxic: | One countertop was sprayed with treatment and 100% |
| | Soy + Fractionated) | ants died immediately. No further ants were observed |
| | | entering the treated countertop area for 30 days. The |
| | | second countertop continued to be infested with Ants. |
| | | After 30 days, the infested countertop was sprayed |
| | | with 100% ant mortality and the other previously |
| | | treated countertop was cleaned with a cleaning |
| | | solution. Ants re-entered the clean countertop and |
| | | infested the countertop. No ants were observed |
| | | entering the treated countertop for 30 days. |
| Spider - Species: | BioUD ™ 8 oil in water | Sprayed product directly on the spider on the floor of |
| Fishing | (phytotoxic) | an indoor room and the spider immediately crawled 2 |
| | | feet and then stopped moving. Spider was probed and |
| | | did not move. No activity was observed for 4 hours |
| | | and the spider was stored in a Petri-dish. Repeated |
| | | with two other spiders with similar results observed. |
| Spider - Species: | Bio Block ® Pest | Sprayed product directly on wolf spider outside in the |
| Wolf | Concentrate | grass and the spider moved slightly and was dead |
| | (phytotoxic) | within 1 minute. The spider was stored in a Petri- |
| | | dish. Repeated with two other spiders with similar |
| | | results observed. |
| Spider - Species: | Bio Block ® Pest Control | Sprayed product directly on spider in web outside on a |
| Orb | (non-phytotoxic) | shrub and the spider moved quickly off the web and |
| | | fell off the shrub within 5 minutes and was dead. The |
| | | spider was stored in a Petri-dish. |
| | | Repeated with two other spiders and similar results |
| | | were observed. |
| Tick - Species: | BioUD ™ 8 oil in water | Product was sprayed on tick on a surface and the tick |
| Lone Star | (phytotoxic) | moved away from material for 5 minutes and then |
| | | died. Tick was observed for 4 hours with no activity |
| | | and then stored in a Petri-dish. |
| | | Repeated experiment with two other ticks with similar |
| | | results. Ticks die within 5 minutes. |
| Japanese Beetles | Soy Methyl Ester | Product was sprayed on Beetle eating flowering crepe |
| | (100%) | myrtle. Beetle immediately fell to the ground and |
| | | died. There was no burrowing in the ground and the |
| | | beetle was observed for 4 hours with no activity and |
| | | then stored in a Petri-dish. |
| June Bugs | Soy Methyl Ester | Product was sprayed on Beetle when landing on the |
| | (100%) | ground. Beetle immediately died. There was no |
| | | burrowing in the ground and the beetle was observed |
| | | for 4 hours with no activity and then stored in a Petri- |
| | | dish. |
| Japanese Beetles | Soy Methyl Ester (40%) + Rue | Product was sprayed on Beetle eating flowering crepe |
| | Oil (30%) + Silicone | myrtle. Beetle immediately fell to the ground and |
| | Oil (30%) | died. There was no burrowing in the ground and the |
| | | beetle was observed for 4 hours with no activity and |
| | | then stored in a Petri-dish. |
| June Bugs | Soy Methyl Ester (40%) + Rue | Product was sprayed on Beetle when landing on the |
| | Oil (30%) + Silicone | ground. Beetle immediately died. There was no |
| | Oil (30%) | burrowing in the ground and the beetle was observed |
| | Mixed by weight | for 4 hours with no activity and then stored in a Petri- |
| | | dish. |
| Mosquito - | Bio Block ® Pest Control | Product was sprayed in a cage with mosquitoes and |
| Species (Aedes | (non-phytotoxic) | the mosquitoes immediately fell to the floor of the |
| Egypti) | | cage with 100% mortality. No activity was observed |
| | | for 4 hours. |
| Mosquito - | BioUD ™ 8 Silicone | Product was sprayed in a cage with mosquitoes and |
| Species (Aedes | (non-phytotoxic) | the mosquitoes immediately fell to the floor of the |
| Egypti) | | cage with 100% mortality. No activity was observed |
| | | for 4 hours. |
| Wasp - Species: | BioUD ™ 8 oil in water | Sprayed product directly on a wasp nest with 5 active |
| yellowjackets | (phytotoxic) | wasps on underside of house awning, the wasps |
| (Vespula sp.), | | immediately fell to the ground and slowly moved in a |
| | | small area. All wasps were dead within 20 seconds |
| | | (no movement). No activity was observed for 4 hours |
| | | and the wasp was stored in a Petri-dish. Repeated |
| | | with another wasp nest with 3 active wasps with |
| | | similar results observed. |
| Mud dauber wasp | Bio Block ® Pest | Sprayed product directly on a wasp crawling on an |
| species | concentrate | internal screened portion of a house-porch, the wasp |
| Sceliphron | (phytotoxic) | crawled 3 feet on the screening within 1 minute and |
| caementarium | | then stopped moving. The wasp was knocked off the |
| | | screening and no movement was observed. No |
| | | activity was observed for 4 hours and the wasp was |
| | | stored in a Petri-dish. Repeated with two other wasps |
| | | with similar results observed. |
| Xylocopa (large | Bio Block ® Wood | Sprayed product directly on area where carpenter bee |
| carpenter bees) | Insecticide/Repellant | was digging hole in 2 × 4 piece of wood at underneath |
| | (phytotoxic) | of a house awning. The bee immediately left the |
| | | hole. The hole was observed for one month with no |
| | | bee activity. |
| Lizards | Bio Block ® Wood | Sprayed wood deck area infested with lizards. Lizards |
| | Insecticide/Repellent | immediately left area and did not return for 30 days. |
| | | Sprayed the product again with the same observations. |
| Snakes | Bio Block ® Wood | Sprayed concrete area around pool and cement |
| | Insecticide/Repellent | retaining wall where snakes were making home in the |
| | | rocks. No snakes were seen in area for 30 days. Re- |
| | | applied every 30 days and no snakes were observed in |
| | | this area. |
| Frogs | Bio Block ® Wood | Sprayed mulch area around pool and wood area |
| | Insecticide/Repellent | around pond where frogs were commonly seen in the |
| | | evenings. No frogs were seen in area in the evenings |
| | | for 30 days. Re-applied every 30 days and no frogs |
| | | observed in this area. |
| Rodents (mice) | BioUD ™ 8 Oil in water | Sprayed perimeter of room where mice were |
| | Phytotoxic | problematic and found in traps every other day. No |
| | | signs of mice were observed and none found in the |
| | | traps for 30 days. Re-applied every 30 days with no |
| | | further mice problems. |
| Common Housefly | BioUD ™ 30 silicone | A window area of an indoor garage was infested with |
| | Phytotoxic | flies. Sprayed BioUD30 on the flies and they dropped |
| | | immediately to the ground. They moved around for |
| | | 10 seconds and died. Flies coming in contact with the |
| | | treated area of the window over the next 4 hours |
| | | would fall to the ground after 15 to 30 seconds on the |
| | | treated area. They would move on the floor slowly |
| | | and die within 1 to 5 minutes. |
| Sarcoptic parasitic | Bio Block ® Pest Control | Australian Shepherd 4 years old had a mange problem |
| mites (Sarcoptes | (non-phytotoxic) | for at least 1 year that was diagnosed as Scabies. |
| Scabiei) on dog | | Product was applied (sprayed liberally) underneath |
| causing extreme | | neck area after bathing each week. The Australian |
| mange and scabies | | Shepherd dog began growing hair in the treated areas |
| condition on | | within 2 weeks. Treated entire animal after 2 weeks |
| animal with total | | and all hair was growing on dog at 4 weeks. No |
| hair loss for over 1 | | treatment was given for the next two weeks and the |
| year. | | animal started losing hair again. The entire animal |
| | | was treated each week after bathing for 2 years with |
| | | no effects of hair loss and no mites were found on |
| | | animal. |
| Person exhibiting | Eco-Shield ™ | Product was applied to entire facial area of subject |
| Rosacea effects on | (non-phytotoxic) for | including areas where Rosacea was evident. Within |
| face and head for | facial areas but with | 15 minutes of applying the Eco-Shield treatment, |
| more than 10 years | Soybean Methyl Ester | subject felt bites on head outside of the treated area. |
| with the notion | in place of Soybean oil. | The head was then treated with a shampoo version of |
| that Rosacea is | ALSO: | the Bio Block Pest Concentrate (added Pest |
| caused by a | Bio Block ® Concentrate | Concentrate to a shampoo formula). |
| bacteria carried by | added to shampoo for | The two treatments as indicated above were repeated |
| Demodex Mites. | hair and scalp treatment | each day for 3 days. There was no further facial area |
| | on top of head. | redness and blemishes observed after 3 days of |
| | | treatments. The treatments were then applied once per |
| | | week. After 1 month, there was no evidence of |
| | | Rosacea. |

### EXAMPLE 27

### Arm in Cage Mosouito Repellency Tests

Fifty host-seeking mosquitoes were provided in a cage.

Test subjects were provided with a BioUD™8-treated (7 mL) snap bracelet, which is a tin bracelet with cloth around it. The BioUD™8 binds to the cloth. Hands were gloved and a BioUD™8 treated wrist band was placed 5 cm above glove line. Attempted bites were counted 5 cm above (line drawn on arm) and below wrist band; also, landings on wrist band were counted. Test subject was counting mosquitoes on wrist band, while a second person was counting mosquitoes on arm.

The right arm was tested first (with band, non-treated) to establish a base line. Percent bite attempts were calculated using the counts from the treated band on the left arm. Percent repellency was calculated as 100 minus percent bite attempts.

The tests were carried out for one minute of every hour, whenever possible.

Experiment was performed twice. The results are set forth in FIG. 24.

While the invention has been described herein in reference to specific aspects, features and illustrative embodiments of the invention, it will be appreciated that the utility of the invention is not thus limited, but rather extends to and encompasses numerous other variations, modifications and alternative embodiments, as will suggest themselves to those of ordinary skill in the field of the present invention, based on the disclosure herein. Correspondingly, the invention as hereinafter claimed is intended to be broadly construed and interpreted, as including all such variations, modifications and alternative embodiments, within its spirit and scope.

What is claimed is:

1. A pest-combating composition including at least one transesterified or methanolyzed oleochemical having pest control character.

2. The pest-combating composition of claim 1, comprising a pest-combating component selected from the group consisting of fatty acid alkyl esters, fatty acid methyl esters, soy methyl ester, and C₁₆-C₁₈ saturated and C₁₈ unsaturated methyl esters.

3. A pest-repellant composition of claim 1, consisting essentially of soy methyl ester, wherein the soy methyl ester is present in the composition in an amount of about 50-100% by weight.

4. Use of a pest repellant composition of claim 1 in a method of combating Japanese beetles.

5. The pest-combating composition of claim 1, wherein the pest-combating composition has pest control character selected from pest repellency and pesticidal activity.

6. The pest-combating composition of claim 1, further comprising undecanone.

7. The pest-combating composition of claim 1, comprising a sunscreen formulation, a spray composition, a lotion composition, or a sunblock composition.

8. An article or location, to which has been applied a pest-combating composition according to claim 1.

9. A packaged pest control composition, comprising a container holding a pest-combating composition according to claim 1, further comprising undecanone.

10. A method of combating pests, at a locus containing or susceptible to the presence of same, said method comprising applying to at least a portion of said locus a pest combating composition including soy methyl ester and undecanone.

11. The method of claim 10, wherein said pests comprise a pest selected from any of aphids, ants, bed bugs, bees, beetles, centipedes, caterpillars, chiggers, cockroaches, crickets, cutworms, earwigs, fleas, flies, fire ants, gnats, grasshoppers, hookworms, japanese beetles, june bugs, lice, locust, maggots, mealworms, mealybugs, millipedes, mites, mosquitoes, moths, pillbugs, scorpions, silverfish, spiders, stinkbugs, termites, thrips, ticks, wasps, and white flies.

12. A pest-repellant composition consisting essentially of any one or more of the following pest control active agents: soy methyl ester, modified fatty acids, coconut oil, rue oil, soybean oil, and vegetable oil.

13. The pest repellant composition of claim 12, wherein the coconut oil is fractionated coconut oil.

14. The pest-repellant composition of claim 12, further comprising any of the pest control active agents undecanone and unmodified fatty acids.

15. The pest-repellant composition of claim 12, further comprising silicone.

16. A pest-repellant composition comprising two or more pest control active agents, wherein at least one pest control active agent is selected from the group consisting of:
a) modified or unmodified fatty acids, coconut oil, soy methyl ester, soybean oil, and vegetable oil
and at least one pest control active agent is selected from the group consisting of:
b) undecanone and rue oil.

17. A pest repellant composition of claim 16, comprising at least three pest control active agents, wherein at least two pest control active agents are selected from group a) and a least one pest control active agent is selected from group b).

18. A pesticidal composition comprising any of the following pest control active agents: modified or unmodified fatty acids, coconut oil, soy methyl ester, soybean oil, vegetable oil, and rue oil, and wherein the composition has pest control character.

19. The pesticidal composition of claim 18, wherein the coconut oil is fractionated coconut oil.

20. The pesticidal composition of claim 18, comprising at least two pest control active agents.

21. The pesticidal composition of claim 18, further comprising undecanone.

22. The pesticidal composition of claim 21, comprising at least three pest control active agents.
